(19) United States
(12) Patent Application Publication
(10) Pub. No.: US 2026/0020018 A1
(43) Pub. Date: Jan. 15, 2026

(54) METHOD FOR TRANSMITTING UPLINK CHANNEL IN WIRELESS COMMUNICATION SYSTEM AND APPARATUS THEREFOR

(71) Applicant: WILUS INSTITUTE OF STANDARDS AND TECHNOLOGY INC., Gyeonggi-do (KR)

(72) Inventors: Geunyoung SEOK, Gyeonggi-do (KR); Minseok NOH, Gyeonggi-do (KR); Youngjoon YOON, Gyeonggi-do (KR); Juhyung SON, Gyeonggi-do (KR); Jinsam KWAK, Gyeonggi-do (KR)

(21) Appl. No.: 19/295,506

(22) Filed: Aug. 8, 2025

Related U.S. Application Data
(63) Continuation of application No. PCT/KR2024/000137, filed on Jan. 3, 2024.

(30) Foreign Application Priority Data
Feb. 10, 2023 (KR) 10-2023-0017952
Feb. 15, 2023 (KR) 10-2023-0019841
Apr. 6, 2023 (KR) 10-2023-0045367
Jul. 7, 2023 (KR) 10-2023-0088359
Jul. 10, 2023 (KR) 10-2023-0089411
Jul. 20, 2023 (KR) 10-2023-0094615
Aug. 7, 2023 (KR) 10-2023-0103062
Aug. 7, 2023 (KR) 10-2023-0103201
Aug. 10, 2023 (KR) 10-2023-0104971

(51) Int. Cl. H04W 72/1268; H04L 5/14; H04W 52/14

(52) U.S. Cl. CPC H04W 72/1268; H04L 5/14; H04W 52/14

(57) ABSTRACT

The present invention relates to a wireless communication system, in which a terminal comprises a transceiver and a processor that controls the transceiver, wherein the processor may: receive first information indicating whether a first slot includes a subband for uplink transmission; receive second information indicating whether a second slot includes the subband for uplink transmission; and perform repetition transmission of a physical uplink shared channel (PUSCH) on the first slot and the second slot, wherein the first slot includes the subband for uplink transmission, and the second slot does not include the subband for uplink transmission.

### TECHNICAL FIELD

The disclosure relates to a wireless communication system, and relates to a method for transmitting an uplink channel and an apparatus therefor.

### BACKGROUND ART

After commercialization of 4th generation (4G) communication system, in order to meet the increasing demand for wireless data traffic, efforts are being made to develop new 5th generation (5G) communication systems. The 5G communication system is called as a beyond 4G network communication system, a post LTE system, or a new radio (NR) system. In order to achieve a high data transfer rate, 5G communication systems include systems operated using the millimeter wave (mmWave) band of 6 GHz or more, and include a communication system operated using a frequency band of 6 GHz or less in terms of ensuring coverage so that implementations in base stations and terminals are under consideration.

A 3rd generation partnership project (3GPP) NR system enhances spectral efficiency of a network and enables a communication provider to provide more data and voice services over a given bandwidth. Accordingly, the 3GPP NR system is designed to meet the demands for high-speed data and media transmission in addition to supports for large volumes of voice. The advantages of the NR system are to have a higher throughput and a lower latency in an identical platform, support for frequency division duplex (FDD) and time division duplex (TDD), and a low operation cost with an enhanced end-user environment and a simple architecture. For more efficient data processing, dynamic TDD of the NR system may use a method for varying the number of orthogonal frequency division multiplexing (OFDM) symbols that may be used in an uplink and downlink according to data traffic directions of cell users. For example, when the downlink traffic of the cell is larger than the uplink traffic, the base station may allocate a plurality of downlink OFDM symbols to a slot (or subframe). Information about the slot configuration should be transmitted to the terminals.

In order to alleviate the path loss of radio waves and increase the transmission distance of radio waves in the mmWave band, in 5G communication systems, beamforming, massive multiple input/output (massive MIMO), full dimensional MIMO (FD-MIMO), array antenna, analog beam-forming, hybrid beamforming that combines analog beamforming and digital beamforming, and large scale antenna technologies are discussed. In addition, for network improvement of the system, in the 5G communication system, technology developments related to evolved small cells, advanced small cells, cloud radio access network (cloud RAN), ultra-dense network, device to device communication (D2D), vehicle to everything communication (V2X), wireless backhaul, non-terrestrial network communication (NTN), moving network, cooperative communication, coordinated multi-points (CoMP), interference cancellation, and the like are being made. In addition, in the 5G system, hybrid FSK and QAM modulation (FQAM) and sliding window superposition coding (SWSC), which are advanced coding modulation (ACM) schemes, and filter bank multi-carrier (FBMC), non-orthogonal multiple access (NOMA), and sparse code multiple access (SCMA), which are advanced connectivity technologies, are being developed.

Meanwhile, in a human-centric connection network where humans generate and consume information, the Internet has evolved into the Internet of Things (IoT) network, which exchanges information among distributed components such as objects. Internet of Everything (IoE) technology, which combines IoT technology with big data processing technology through connection with cloud servers, is also emerging. In order to implement IoT, technology elements such as sensing technology, wired/wireless communication and network infrastructure, service interface technology, and security technology are required, so that in recent years, technologies such as sensor network, machine to machine (M2M), and machine type communication (MTC) have been studied for connection between objects. In the IoT environment, an intelligent internet technology (IT) service that collects and analyzes data generated from connected objects to create new value in human life can be provided. Through the fusion and mixture of existing information technology (IT) and various industries, IoT can be applied to fields such as smart home, smart building, smart city, smart car or connected car, smart grid, healthcare, smart home appliance, and advanced medical service.

Accordingly, various attempts have been made to apply the 5G communication system to the IoT network. For example, technologies such as a sensor network, a machine to machine (M2M), and a machine type communication (MTC) are implemented by techniques such as beamforming, MIMO, and array antennas. The application of the cloud RAN as the big data processing technology described above is an example of the fusion of 5G technology and IoT technology. Generally, a mobile communication system has been developed to provide voice service while ensuring the user's activity.

However, the mobile communication system is gradually expanding not only the voice but also the data service, and now it has developed to the extent of providing high-speed data service. However, in a mobile communication system in which services are currently being provided, a more advanced mobile communication system is required due to a shortage phenomenon of resources and a high-speed service demand of users.

### DISCLOSURE OF INVENTION

### Technical Problem

The disclosure is to provide a method for transmitting an uplink channel and an apparatus therefor in a wireless communication system.

### Solution to Problem

The present disclosure provides a method for transmitting an uplink channel in a wireless communication system and an apparatus therefor.

In the present disclosure, a terminal in a wireless communication system may include a transceiver, and a processor configured to control the transceiver, wherein the processor is configured to: receive first information indicating whether a first slot includes a subband for uplink transmission; receive second information indicating whether a second slot includes the subband for uplink transmission; and perform repetition transmission of a physical uplink shared channel (PUSCH) on the first slot and the second slot, the first slot includes the subband for uplink transmission, and the second slot does not include the subband for uplink transmission.

In the present disclosure, a method performed by a terminal in a wireless communication system may include: receiving first information indicating whether a first slot includes a subband for uplink transmission; receiving second information indicating whether a second slot includes the subband for uplink transmission; and performing repetition transmission of a physical uplink shared channel (PUSCH) on the first slot and the second slot, wherein the first slot includes the subband for uplink transmission, and the second slot does not include the subband for uplink transmission.

In the present disclosure, a base station in a wireless communication system may include a transceiver and a processor configured to control the transceiver, wherein the processor is configured to: transmit first information indicating whether a first slot includes a subband for uplink transmission; transmit second information indicating whether a second slot includes the subband for uplink transmission; and receive repetition transmission of a physical uplink shared channel (PUSCH) on the first slot and the second slot, the first slot includes the subband for uplink transmission, and the second slot does not include the subband for uplink transmission.

In the present disclosure, a method performed by a base station in a wireless communication system may include: transmitting first information indicating whether a first slot includes a subband for uplink transmission; transmitting second information indicating whether a second slot includes the subband for uplink transmission; and receiving repetition transmission of a physical uplink shared channel (PUSCH) on the first slot and the second slot, wherein the first slot includes the subband for uplink transmission, and the second slot does not include the subband for uplink transmission.

When first transmission power for the repetition transmission of the PUSCH transmitted on the first slot and second transmission power for the repetition transmission of the PUSCH transmitted on the second slot are differently configured from the base station, the repetition transmission of the PUSCH transmitted on the first slot and the repetition transmission of the PUSCH transmitted on the second slot may be transmitted using common transmission power, and the common transmission power may be one of the first transmission power and the second transmission power.

The first transmission power may be less than the second transmission power.

The common transmission power may be the first transmission power.

The repetition transmission of the PUSCH transmitted on the first slot may include a first demodulation reference signal (DMRS), the repetition transmission of the PUSCH transmitted on the second slot may include a second DMRS, and the first DMRS and the second DMRS may be transmitted to be bundled and decoded.

The first DMRS and the second DMRS may be transmitted while phase continuity is maintained therebetween.

### Advantageous Effects of Invention

The purpose of the present disclosure is to provide a method for transmitting an uplink channel in a wireless communication system, and an apparatus therefor.

Advantageous effects which can be archived in the present disclosure are not limited to the above-described advantageous effects, and other unmentioned advantageous effects can be apparently understood by those skilled in the art to which the present disclosure belongs.

### BRIEF DESCRIPTION OF DRAWINGS

FIG. 1 illustrates an example of a wireless frame structure used in a wireless communication system.

FIG. 2 illustrates an example of a downlink (DL)/uplink (UL) slot structure in a wireless communication system.

FIG. 3 is a diagram for explaining a physical channel used in a 3GPP system and a typical signal transmission method using the physical channel.

FIG. 4a and FIG. 4b illustrate an SS/PBCH block for initial cell access in a 3GPP NR system.

FIG. 5a and FIG. 5b illustrate a procedure for transmitting control information and a control channel in a 3GPP NR system.

FIG. 6 illustrates a control resource set (CORESET) in which a physical downlink control channel (PDCCH) may be transmitted in a 3GPP NR system.

FIG. 7 illustrates a method for configuring a PDCCH search space in a 3GPP NR system.

FIG. 8 is a conceptual diagram illustrating carrier aggregation.

FIG. 9 is a diagram for explaining signal carrier communication and multiple carrier communication.

FIG. 10 is a diagram showing an example in which a cross carrier scheduling technique is applied.

FIG. 11 is a block diagram showing the configurations of a UE and a base station according to an embodiment of the present disclosure.

FIG. 12 illustrates a method of scheduling a physical uplink shared channel in a time domain according to an embodiment of the present disclosure.

FIG. 13 illustrates a method of scheduling a physical uplink shared channel in a frequency domain according to an embodiment of the present disclosure.

FIG. 14 illustrates repetition transmission of a physical uplink shared channel according to an embodiment of the present disclosure.

FIG. 15 illustrates a method of scheduling a physical uplink control channel according to an embodiment of the present disclosure.

FIG. 16 illustrates repetition transmission of a physical uplink control channel according to an embodiment of the present disclosure.

FIG. 17 illustrates cross link interference (CLI) between neighboring cells according to an embodiment of the present disclosure.

FIG. 18 illustrates a PUSCH transmission method according to an embodiment of the present disclosure.

FIG. 19 illustrates an SRS transmission method according to an embodiment of the present disclosure.

FIG. 20 illustrates a method of transmitting PUCCH format 1 according to an embodiment of the present disclosure.

FIG. 21 illustrates an uplink transmission method of a UE for mitigation of inter-gNB CLI.

FIG. 22 illustrates configuration information for CSI reporting according to an embodiment of the present disclosure.

FIG. 23 illustrates configuration information for CLI reporting according to an embodiment of the present disclosure.

FIG. 24 illustrates a PUSCH scheduling method in which a transport block size is determined with reference to multiple slots according to an embodiment of the present disclosure.

FIG. 25 illustrates a method of scheduling a PUSCH for which a transport block size is determined with reference to a single slot according to an embodiment of the present disclosure.

FIGS. 26 to 28 illustrate a method of determining an actual time domain window (TDW) of a UE in a slot operating as a subband according to an embodiment of the present disclosure.

FIG. 29 illustrates a method of configuring or indicating uplink power of a UE to mitigate CLI between subbands according to an embodiment of the present disclosure.

FIG. 30 illustrates inter-gNB CLI and inter-UE CLI according to an embodiment of the present disclosure.

FIG. 31 illustrates a method of configuring or indicating uplink power of a UE to mitigate inter-gNB CLI and inter-UE CLI according to an embodiment of the present disclosure.

FIGS. 32 and 33 illustrate a method of determining an actual TDW of a UE when operating as a subband according to an embodiment of the present disclosure.

FIGS. 34 and 35 illustrate a problem according to determining an actual TDW by a UE when CLI occurs according to an embodiment of the present disclosure.

FIGS. 36 and 37 illustrate a method of determining an actual TDW and uplink transmission power by a UE according to an embodiment of the present disclosure.

FIGS. 38 to 44 illustrate a method for performing frequency hopping in a resource configured or indicated as a subband according to an embodiment of the present disclosure.

FIGS. 45 to 49 illustrate an uplink cancellation indication according to an embodiment of the present disclosure.

FIGS. 50 to 55 illustrate timing adjustment according to an embodiment of the present disclosure.

FIG. 56 is a flowchart illustrating a method for performing repetition transmission of a PUSCH according to an embodiment of the present disclosure.

### MODE FOR CARRYING OUT THE INVENTION

Terms used in the specification adopt general terms which are currently widely used as possible by considering functions in the present disclosure, but the terms may be changed depending on an intention of those skilled in the art, customs, and emergence of new technology. Further, in a specific case, there is a term arbitrarily selected by an applicant and in this case, a meaning thereof will be described in a corresponding description part of the present disclosure. Accordingly, it intends to be revealed that a term used in the specification should be analyzed based on not just a name of the term but a substantial meaning of the term and contents throughout the specification.

Throughout this specification and the claims that follow, when it is described that an element is “connected” to another element, the element may be “directly connected” to the other element or “electrically connected” to the other element through a third element. Further, unless explicitly described to the contrary, the word “comprise” will be understood to imply the inclusion of stated elements but not the exclusion of any other elements unless otherwise stated. Moreover, limitations such as “more than or equal to” or “less than or equal to” based on a specific threshold may be appropriately substituted with “more than” or “less than”, respectively, in some exemplary embodiments.

The following technology may be used in various wireless access systems, such as code division multiple access (CDMA), frequency division multiple access (FDMA), time division multiple access (TDMA), orthogonal frequency division multiple access (OFDMA), single carrier-FDMA (SC-FDMA), and the like. The CDMA may be implemented by a wireless technology such as universal terrestrial radio access (UTRA) or CDMA2000. The TDMA may be implemented by a wireless technology such as global system for mobile communications (GSM)/general packet radio service (GPRS)/enhanced data rates for GSM evolution (EDGE). The OFDMA may be implemented by a wireless technology such as IEEE 802.11(Wi-Fi), IEEE 802.16(WiMAX), IEEE 802-20, evolved UTRA (E-UTRA), and the like. The UTRA is a part of a universal mobile telecommunication system (UMTS). 3rd generation partnership project (3GPP) long term evolution (LTE) is a part of an evolved UMTS (E-UMTS) using evolved-UMTS terrestrial radio access (E-UTRA) and LTE-advanced (A) is an evolved version of the 3GPP LTE. 3GPP new radio (NR) is a system designed separately from LTE/LTE-A, and is a system for supporting enhanced mobile broadband (eMBB), ultra-reliable and low latency communication (URLLC), and massive machine type communication (mMTC) services, which are requirements of IMT-2020. For the clear description, 3GPP NR is mainly described, but the technical idea of the present disclosure is not limited thereto.

Unless otherwise specified in this specification, a base station may refer to a next generation node B (gNB) as defined in 3GPP NR. Furthermore, unless otherwise specified, a terminal may refer to a user equipment (UE). Hereinafter, in order to facilitate understanding of the description, each content is separately divided into embodiments and described, but each of the embodiments may be used in combination with each other. In the present disclosure, the configuration of the UE may indicate configuration by the base station. Specifically, the base station may transmit a channel or signal to the UE to configure an operation of the UE or a parameter value used in a wireless communication system.

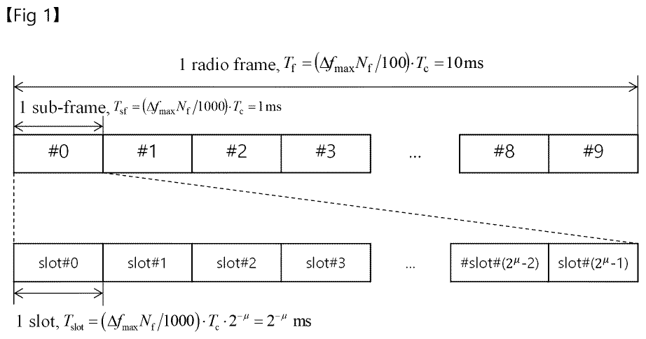

FIG. 1 illustrates an example of a wireless frame structure used in a wireless communication system.

Referring to FIG. 1, the wireless frame (or radio frame) used in the 3GPP NR system may have a length of 10 ms (Δfₘₐₓ/100)*T_{c}). In addition, the wireless frame includes 10 subframes (SFs) having equal sizes. Herein, Δfₘₐₓ=480*103 Hz, N_{f}=4096, T_{c}=1/(Δf_{ref}*N_{f,ref}), Δf_{ref}=15*103 Hz, and N_{f,ref}=2048. Numbers from 0 to 9 may be respectively allocated to 10 subframes within one subframe. Each subframe has a length of 1 ms and may include one or more slots according to a subcarrier spacing. More specifically, in the 3GPP NR system, the subcarrier spacing that may be used is 15*2^{μ} kHz, and p can have a value of μ=0, 1, 2, 3, 4 as subcarrier spacing configuration. That is, 15 kHz, 30 kHz, 60 kHz, 120 kHz and 240 kHz may be used for subcarrier spacing. One subframe having a length of 1 ms may include 2^{μ} slots. In this case, the length of each slot is 2^{-μ} ms. Numbers from 0 to 2^{μ}−1 may be respectively allocated to 2^{μ} slots within one wireless frame. In addition, numbers from 0 to 10*2^{μ}−1 may be respectively allocated to slots within one subframe. The time resource may be distinguished by at least one of a wireless frame number (also referred to as a wireless frame index), a subframe number (also referred to as a subframe number), and a slot number (or a slot index).

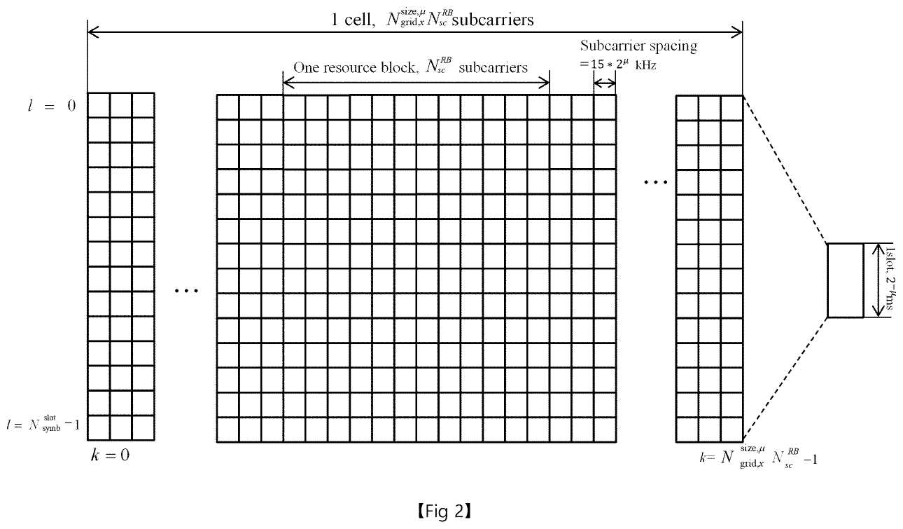

FIG. 2 illustrates an example of a downlink (DL)/uplink (UL) slot structure in a wireless communication system. In particular, FIG. 2 shows the structure of the resource grid of the 3GPP NR system.

There is one resource grid per antenna port. Referring to FIG. 2, a slot includes a plurality of orthogonal frequency division multiplexing (OFDM) symbols in a time domain and includes a plurality of resource blocks (RBs) in a frequency domain. An OFDM symbol also means one symbol section. Unless otherwise specified, OFDM symbols may be referred to simply as symbols. One RB includes 12 consecutive subcarriers in the frequency domain. Referring to FIG. 2, a signal transmitted from each slot may be represented by a resource grid including N^{size,μ}_{grid,x}*N^{RB}_{sc} subcarriers, and N^{slot}_{symb} OFDM symbols. Here, x=DL when the signal is a DL signal, and x=UL when the signal is an UL signal. N^{size,μ}_{grid,x} represents the number of resource blocks (RBs) according to the subcarrier spacing constituent μ (x is DL or UL), and N^{slot}_{symb} represents the number of OFDM symbols in a slot. N^{RB}. is the number of subcarriers constituting one RB and N^{RB}_{sc}=12. An OFDM symbol may be referred to as a cyclic shift OFDM (CP-OFDM) symbol or a discrete Fourier transform spread OFDM (DFT-s-OFDM) symbol according to a multiple access scheme.

The number of OFDM symbols included in one slot may vary according to the length of a cyclic prefix (CP). For example, in the case of a normal CP, one slot includes 14 OFDM symbols, but in the case of an extended CP, one slot may include 12 OFDM symbols. In a specific embodiment, the extended CP can only be used at 60 kHz subcarrier spacing. In FIG. 2, for convenience of description, one slot is configured with 14 OFDM symbols by way of example, but embodiments of the present disclosure may be applied in a similar manner to a slot having a different number of OFDM symbols. Referring to FIG. 2, each OFDM symbol includes N^{size,μ}_{grid,x}*N^{RB}_{sc} subcarriers in the frequency domain. The type of subcarrier may be divided into a data subcarrier for data transmission, a reference signal subcarrier for transmission of a reference signal, and a guard band. The carrier frequency is also referred to as the center frequency (fc).

One RB may be defined by N^{RB}_{sc} (e. g., 12) consecutive subcarriers in the frequency domain. For reference, a resource configured with one OFDM symbol and one subcarrier may be referred to as a resource element (RE) or a tone. Therefore, one RB can be configured with N^{slot}_{symb}*N^{RB}_{sc} resource elements. Each resource element in the resource grid can be uniquely defined by a pair of indexes (k, l) in one slot. k may be an index assigned from 0 to N^{size,μ}_{grid,x}*N^{RB}_{sc}−1 in the frequency domain, and l may be an index assigned from 0 to N^{slot}_{symb}−1 in the time domain.

In order for the UE to receive a signal from the base station or to transmit a signal to the base station, the time/frequency of the UE may be synchronized with the time/frequency of the base station. This is because when the base station and the UE are synchronized, the UE can determine the time and frequency parameters necessary for demodulating the DL signal and transmitting the UL signal at the correct time.

Each symbol of a radio frame used in a time division duplex (TDD) or an unpaired spectrum may be configured with at least one of a DL symbol, an UL symbol, and a flexible symbol. A radio frame used as a DL carrier in a frequency division duplex (FDD) or a paired spectrum may be configured with a DL symbol or a flexible symbol, and a radio frame used as a UL carrier may be configured with a UL symbol or a flexible symbol. In the DL symbol, DL transmission is possible, but UL transmission is impossible. In the UL symbol, UL transmission is possible, but DL transmission is impossible. The flexible symbol may be determined to be used as a DL or an UL according to a signal.

Information on the type of each symbol, i.e., information representing any one of DL symbols, UL symbols, and flexible symbols, may be configured with a cell-specific or common radio resource control (RRC) signal. In addition, information on the type of each symbol may additionally be configured with a UE-specific or dedicated RRC signal. The base station informs, by using cell-specific RRC signals, i) the period of cell-specific slot configuration, ii) the number of slots with only DL symbols from the beginning of the period of cell-specific slot configuration, iii) the number of DL symbols from the first symbol of the slot immediately following the slot with only DL symbols, iv) the number of slots with only UL symbols from the end of the period of cell specific slot configuration, and v) the number of UL symbols from the last symbol of the slot immediately before the slot with only the UL symbol. Here, symbols not configured with any one of a UL symbol and a DL symbol are flexible symbols.

When the information on the symbol type is configured with the UE-specific RRC signal, the base station may signal whether the flexible symbol is a DL symbol or an UL symbol in the cell-specific RRC signal. In this case, the UE-specific RRC signal can not change a DL symbol or a UL symbol configured with the cell-specific RRC signal into another symbol type. The UE-specific RRC signal may signal the number of DL symbols among the N^{slot}_{symb} symbols of the corresponding slot for each slot, and the number of UL symbols among the N^{slot}_{symb} symbols of the corresponding slot. In this case, the DL symbol of the slot may be continuously configured with the first symbol to the i-th symbol of the slot. In addition, the UL symbol of the slot may be continuously configured with the j-th symbol to the last symbol of the slot (where i<j). In the slot, symbols not configured with any one of a UL symbol and a DL symbol are flexible symbols.

FIG. 3 is a diagram for explaining a physical channel used in a 3GPP system (e.g., NR) and a typical signal transmission method using the physical channel.

If the power of the UE is turned on or the UE camps on a new cell, the UE performs an initial cell search (S101). Specifically, the UE may synchronize with the BS in the initial cell search. For this, the UE may receive a primary synchronization signal (PSS) and a secondary synchronization signal (SSS) from the base station to synchronize with the base station, and obtain information such as a cell ID. Thereafter, the UE can receive the physical broadcast channel from the base station and obtain the broadcast information in the cell.

Upon completion of the initial cell search, the UE receives a physical downlink shared channel (PDSCH) according to the physical downlink control channel (PDCCH) and information in the PDCCH, so that the UE can obtain more specific system information than the system information obtained through the initial cell search (S102). Here, the system information received by the UE is cell-common system information for the UE to properly operate at the physical layer in Radio Resource Control (RRC), and is referred to as remaining system information (RSMI) or system information block (SIB) 1.

When the UE initially accesses the base station or does not have radio resources for signal transmission (when the UE is in RRC_IDLE mode), the UE may perform a random access procedure on the base station (operations S103 to S106). First, the UE may transmit a preamble through a physical random access channel (PRACH) (S103), and receive a response message for the preamble from the base station through the PDCCH and the corresponding PDSCH (S104). When a valid random access response is received by the UE, the UE transmits data including the identifier of the UE and the like to the base station through a physical uplink shared channel (PUSCH) indicated by the UL grant transmitted through the PDCCH from the base station (S105). Next, the UE waits for reception of the PDCCH as an indication of the base station for collision resolution. If the UE successfully receives the PDCCH through the identifier of the UE (S106), the random access process is terminated. During the random access process, the UE may obtain UE-specific system information necessary for the UE to properly operate at the physical layer in the RRC layer. When the UE obtains UE-specific system information from the RRC layer, the UE enters the RRC_CONNECTED mode.

The RRC layer is used for message generation and management for control between a UE and a radio access network (RAN). More specifically, in the RRC layer, the base station and the UE may perform broadcasting of cell system information, delivery management of paging messages, mobility management and handover, measurement report and control thereof, UE capability management, and storage management including existing management necessary for all UEs in the cell. In general, since the update of the signal (hereinafter, referred to as RRC signal) transmitted from the RRC layer is longer than the transmission/reception period (i.e., transmission time interval, TTI) in the physical layer, the RRC signal may be maintained unchanged for a long period.

After the above-described procedure, the UE receives PDCCH/PDSCH (S107) and transmits a physical uplink shared channel (PUSCH)/physical uplink control channel (PUCCH) (S108) as a general UL/DL signal transmission procedure. In particular, the UE may receive downlink control information (DCI) through the PDCCH. The DCI may include control information such as resource allocation information for the UE. Also, the format of the DCI may vary depending on the intended use. The uplink control information (UCI) that the UE transmits to the base station through UL includes a DL/UL ACK/NACK signal, a channel quality indicator (CQI), a precoding matrix index (PMI), a rank indicator (RI), and the like. Here, the CQI, PMI, and RI may be included in channel state information (CSI). In the 3GPP NR system, the UE may transmit control information such as HARQ-ACK and CSI described above through the PUSCH and/or PUCCH.

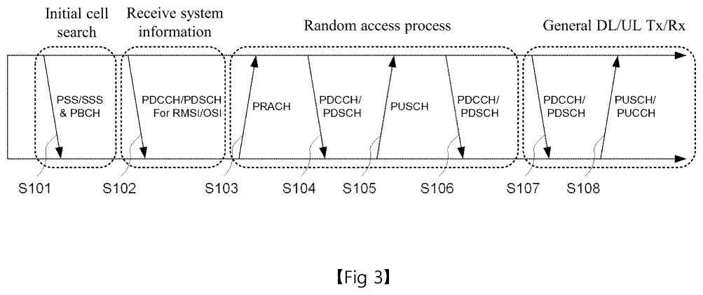

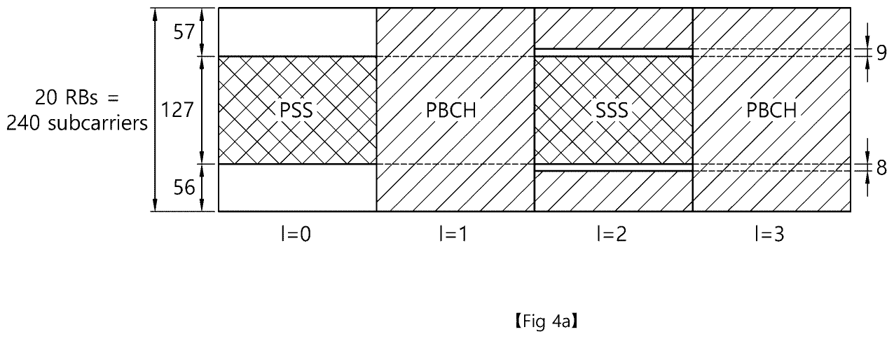

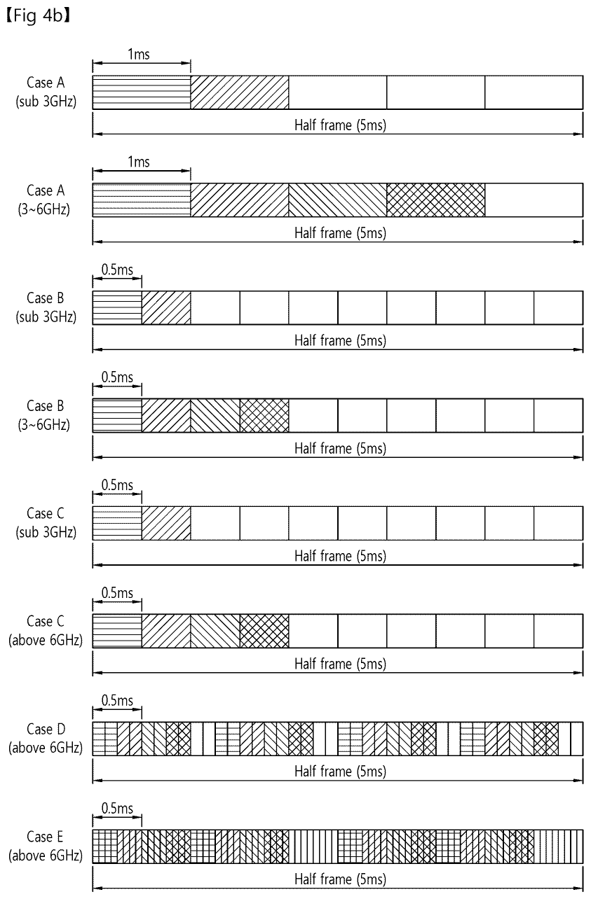

FIGS. 4a and 4b illustrate an SS/PBCH block for initial cell access in a 3GPP NR system.

When the power is turned on or wanting to access a new cell, the UE may obtain time and frequency synchronization with the cell and perform an initial cell search procedure. The UE may detect a physical cell identity NcellID of the cell during a cell search procedure. For this, the UE may receive a synchronization signal, for example, a primary synchronization signal (PSS) and a secondary synchronization signal (SSS), from a base station, and synchronize with the base station. In this case, the UE can obtain information such as a cell identity (ID).

Referring to FIG. 4a, a synchronization signal (SS) will be described in more detail. The synchronization signal can be classified into PSS and SSS. The PSS may be used to obtain time domain synchronization and/or frequency domain synchronization, such as OFDM symbol synchronization and slot synchronization. The SSS can be used to obtain frame synchronization and cell group ID. Referring to FIG. 4a and Table 1, the SS/PBCH block can be configured with consecutive 20 RBs (=240 subcarriers) in the frequency axis, and can be configured with consecutive 4 OFDM symbols in the time axis. In this case, in the SS/PBCH block, the PSS is transmitted in the first OFDM symbol and the SSS is transmitted in the third OFDM symbol through the 56th to 182th subcarriers. Here, the lowest subcarrier index of the SS/PBCH block is numbered from 0. In the first OFDM symbol in which the PSS is transmitted, the base station does not transmit a signal through the remaining subcarriers, i.e., 0th to 55th and 183th to 239th subcarriers. In addition, in the third OFDM symbol in which the SSS is transmitted, the base station does not transmit a signal through 48th to 55th and 183th to 191th subcarriers. The base station transmits a physical broadcast channel (PBCH) through the remaining RE except for the above signal in the SS/PBCH block.

TABLE 1

| | OFDM symbol | |
|---|---|---|
| | number/relative to | Subcarrier number k |
| Channel | the start of an | relative to the start |
| or signal | SS/PBCH block | of an SS/PBCH block |
| PSS | 0 | 56, 57, . . . , 182 |
| SSS | 2 | 56, 57, . . . , 182 |
| Set to 0 | 0 | 0, 1, . . . , 55, 183, |
| | | 184, . . . , 239 |
| | 2 | 48, 49, . . . , 55, 183, |
| | | 184, . . . , 191 |
| PBCH | 1, 3 | 0, 1, . . . , 239 |
| | 2 | 0, 1, . . . , 47, 192, |
| | | 193, . . . , 239 |
| DM-RS for | 1, 3 | 0 + v, 4 + v, |
| PBCH | | 8 + v, . . . , 236 + v |
| | 2 | 0 + v, 4 + v, |
| | | 8 + v, . . . , 44 + v |
| | | 192 + v, 196 + v, . . . , |
| | | 236 + v |

The SS allows a total of 1008 unique physical layer cell IDs to be grouped into 336 physical-layer cell-identifier groups, each group including three unique identifiers, through a combination of three PSSs and SSSs, specifically, such that each physical layer cell ID is to be only a part of one physical-layer cell-identifier group. Therefore, the physical layer cell ID N^{cell}_{ID}=3N⁽¹⁾_{ID}+N⁽²⁾_{ID} can be uniquely defined by the index N⁽¹⁾_{ID} ranging from 0 to 335 indicating a physical-layer cell-identifier group and the index N⁽²⁾_{ID} ranging from 0 to 2 indicating a physical-layer identifier in the physical-layer cell-identifier group. The UE may detect the PSS and identify one of the three unique physical-layer identifiers. In addition, the UE can detect the SSS and identify one of the 336 physical layer cell IDs associated with the physical-layer identifier. In this case, the sequence d_{PSS}(n) of the PSS is as follows.

$${d}_{PSS} ( n ) = 1 - 2 x ( m )$$

$$m = ( n + 43 {N}_{ID}^{( 2 )} ) mod 127$$

$$0 \leq n < 127$$

Here, x(i+7)=(x(i+4)+x(i))mod 2 and is given as,

$$[ x ( 6 ) x ( 5 ) x ( 4 ) x ( 3 ) x ( 2 ) x ( 1 ) x ( 0 ) ] = [ \begin{matrix}1 & 1 & 1 & 0 & 1 & 1 & 0\end{matrix} ]$$

Further, the sequence d_{SSS}(n) of the SSS is as follows.

$${d}_{SSS} ( n ) = [ 1 - 2 {x}_{0} ( ( n + {m}_{0} ) mod 127 ) ] [ 1 - 2 {x}_{1} ( ( n + {m}_{1} ) mod 127 ) ]$$

$${m}_{0} = 15 ⌊ \frac{{N}_{ID}^{( 1 )}}{112} ⌋ + 5 {N}_{ID}^{( 2 )}$$

$${m}_{1} = {N}_{ID}^{( 1 )} mod 112$$

$$0 \leq n < 127$$

Here,

$${x}_{0} ( i + 7 ) = ( {x}_{0} ( i + 4 ) + {x}_{0} ( i ) ) mod 2$$

$${x}_{1} ( i + 7 ) = ( {x}_{1} ( i + 1 ) + {x}_{1} ( i ) ) mod 2$$

and is given as,

$$[ {x}_{0} ( 6 ) {x}_{0} ( 5 ) {x}_{0} ( 4 ) {x}_{0} ( 3 ) {x}_{0} ( 2 ) {x}_{0} ( 1 ) {x}_{0} ( 0 ) ] = [ \begin{matrix}0 & 0 & 0 & 0 & 0 & 0 & 1\end{matrix} ]$$

$$[ {x}_{1} ( 6 ) {x}_{1} ( 5 ) {x}_{1} ( 4 ) {x}_{1} ( 3 ) {x}_{1} ( 2 ) {x}_{1} ( 1 ) {x}_{1} ( 0 ) ] = [ \begin{matrix}0 & 0 & 0 & 0 & 0 & 0 & 1\end{matrix} ]$$

A radio frame with a 10 ms length may be divided into two half frames with a 5 ms length. Referring to FIG. 4b, a description will be made of a slot in which SS/PBCH blocks are transmitted in each half frame. A slot in which the SS/PBCH block is transmitted may be any one of the cases A, B, C, D, and E. In the case A, the subcarrier spacing is 15 kHz and the starting time point of the SS/PBCH block is the ({2, 8}+14*n)-th symbol. In this case, n=0 or 1 at a carrier frequency of 3 GHz or less. In addition, it may be n=0, 1, 2, 3 at carrier frequencies above 3 GHz and below 6 GHz. In the case B, the subcarrier spacing is 30 kHz and the starting time point of the SS/PBCH block is {4, 8, 16, 20}+28*n. In this case, n=0 at a carrier frequency of 3 GHz or less. In addition, it may be n=0, 1 at carrier frequencies above 3 GHz and below 6 GHz. In the case C, the subcarrier spacing is 30 kHz and the starting time point of the SS/PBCH block is the ({2, 8}+14*n)-th symbol. In this case, n=0 or 1 at a carrier frequency of 3 GHz or less. In addition, it may be n=0, 1, 2, 3 at carrier frequencies above 3 GHz and below 6 GHz. In the case D, the subcarrier spacing is 120 kHz and the starting time point of the SS/PBCH block is the ({4, 8, 16, 20}+28*n)-th symbol. In this case, at a carrier frequency of 6 GHz or more, n=0, 1, 2, 3, 5, 6, 7, 8, 10, 11, 12, 13, 15, 16, 17, 18. In the case E, the subcarrier spacing is 240 kHz and the starting time point of the SS/PBCH block is the ({8, 12, 16, 20, 32, 36, 40, 44}+56*n)-th symbol. In this case, at a carrier frequency of 6 GHz or more, n=0, 1, 2, 3, 5, 6, 7, 8.

FIGS. 5a and 5b illustrate a procedure for transmitting control information and a control channel in a 3GPP NR system. Referring to FIG. 5a, the base station may add a cyclic redundancy check (CRC) masked (e.g., an XOR operation) with a radio network temporary identifier (RNTI) to control information (e.g., downlink control information (DCI)) (S202). The base station may scramble the CRC with an RNTI value determined according to the purpose/target of each control information. The common RNTI used by one or more UEs can include at least one of a system information RNTI (SI-RNTI), a paging RNTI (P-RNTI), a random access RNTI (RA-RNTI), and a transmit power control RNTI (TPC-RNTI). In addition, the UE-specific RNTI may include at least one of a cell temporary RNTI (C-RNTI), and the CS-RNTI. Thereafter, the base station may perform rate-matching (S206) according to the amount of resource(s) used for PDCCH transmission after performing channel encoding (e.g., polar coding) (S204). Thereafter, the base station may multiplex the DCI(s) based on the control channel element (CCE) based PDCCH structure (S208). In addition, the base station may apply an additional process (S210) such as scrambling, modulation (e.g., QPSK), interleaving, and the like to the multiplexed DCI(s), and then map the DCI(s) to the resource to be transmitted. The CCE is a basic resource unit for the PDCCH, and one CCE may include a plurality (e.g., six) of resource element groups (REGs). One REG may be configured with a plurality (e.g., 12) of REs. The number of CCEs used for one PDCCH may be defined as an aggregation level. In the 3GPP NR system, an aggregation level of 1, 2, 4, 8, or 16 may be used. FIG. 5b is a diagram related to a CCE aggregation level and the multiplexing of a PDCCH and illustrates the type of a CCE aggregation level used for one PDCCH and CCE(s) transmitted in the control area according thereto.

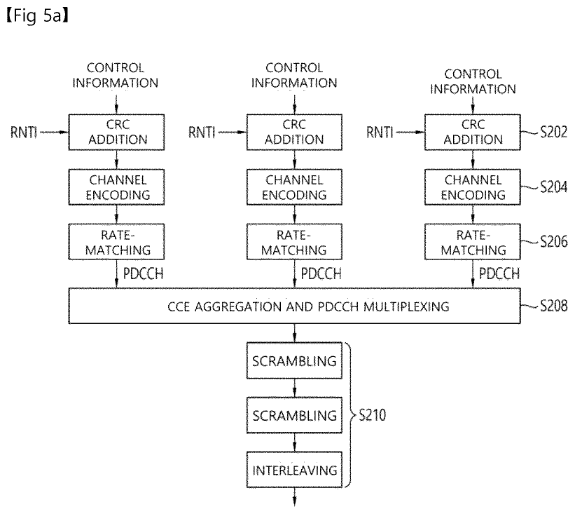

FIG. 6 illustrates a control resource set (CORESET) in which a physical downlink control channel (PDCCH) may be transmitted in a 3GPP NR system.

The CORESET is a time-frequency resource in which PDCCH, that is, a control signal for the UE, is transmitted. In addition, a search space to be described later may be mapped to one CORESET. Therefore, the UE may monitor the time-frequency domain designated as CORESET instead of monitoring all frequency bands for PDCCH reception, and decode the PDCCH mapped to CORESET. The base station may configure one or more CORESETs for each cell to the UE. The CORESET may be configured with up to three consecutive symbols on the time axis. In addition, the CORESET may be configured in units of six consecutive PRBs on the frequency axis. In the embodiment of FIG. 6, CORESET #1 is configured with consecutive PRBs, and CORESET #2 and CORESET #3 are configured with discontinuous PRBs. The CORESET can be located in any symbol in the slot. For example, in the embodiment of FIG. 5, CORESET #1 starts at the first symbol of the slot, CORESET #2 starts at the fifth symbol of the slot, and CORESET #9 starts at the ninth symbol of the slot.

FIG. 7 illustrates a method for setting a PDCCH search space in a 3GPP NR system.

In order to transmit the PDCCH to the UE, each CORESET may have at least one search space. In the embodiment of the present disclosure, the search space is a set of all time-frequency resources (hereinafter, PDCCH candidates) through which the PDCCH of the UE is capable of being transmitted. The search space may include a common search space that the UE of the 3GPP NR is required to commonly search and a Terminal-specific or a UE-specific search space that a specific UE is required to search. In the common search space, UE may monitor the PDCCH that is set so that all UEs in the cell belonging to the same base station commonly search. In addition, the UE-specific search space may be set for each UE so that UEs monitor the PDCCH allocated to each UE at different search space position according to the UE. In the case of the UE-specific search space, the search space between the UEs may be partially overlapped and allocated due to the limited control area in which the PDCCH may be allocated. Monitoring the PDCCH includes blind decoding for PDCCH candidates in the search space. When the blind decoding is successful, it may be expressed that the PDCCH is (successfully) detected/received and when the blind decoding fails, it may be expressed that the PDCCH is not detected/not received, or is not successfully detected/received.

For convenience of explanation, a PDCCH scrambled with a group common (GC) RNTI previously known to UEs so as to transmit DL control information to the one or more UEs is referred to as a group common (GC) PDCCH or a common PDCCH. In addition, a PDCCH scrambled with a specific-terminal RNTI that a specific UE already knows so as to transmit UL scheduling information or DL scheduling information to the specific UE is referred to as a specific-UE PDCCH. The common PDCCH may be included in a common search space, and the UE-specific PDCCH may be included in a common search space or a UE-specific PDCCH.

The base station may signal each UE or UE group through a PDCCH about information (i.e., DL Grant) related to resource allocation of a paging channel (PCH) and a downlink-shared channel (DL-SCH) that are a transmission channel or information (i.e., UL grant) related to resource allocation of a uplink-shared channel (UL-SCH) and a hybrid automatic repeat request (HARQ). The base station may transmit the PCH transport block and the DL-SCH transport block through the PDSCH. The base station may transmit data excluding specific control information or specific service data through the PDSCH. In addition, the UE may receive data excluding specific control information or specific service data through the PDSCH.

The base station may include, in the PDCCH, information on to which UE (one or a plurality of UEs) PDSCH data is transmitted and how the PDSCH data is to be received and decoded by the corresponding UE, and transmit the PDCCH. For example, it is assumed that the DCI transmitted on a specific PDCCH is CRC masked with an RNTI of “A”, and the DCI indicates that PDSCH is allocated to a radio resource (e.g., frequency location) of “B” and indicates transmission format information (e.g., transport block size, modulation scheme, coding information, etc.) of “C”. The UE monitors the PDCCH using the RNTI information that the UE has. In this case, if there is a UE which performs blind decoding the PDCCH using the “A” RNTI, the UE receives the PDCCH, and receives the PDSCH indicated by “B” and “C” through the received PDCCH information.

Table 2 shows an embodiment of a physical uplink control channel (PUCCH) used in a wireless communication system.

TABLE 2

| | Length in OFDM | |
|---|---|---|
| PUCCH format | symbols | Number of bits |
| 0 | 1-2 | ≤2 |
| 1 | 4-14 | ≤2 |
| 2 | 1-2 | >2 |
| 3 | 4-14 | >2 |
| 4 | 4-14 | >2 |

PUCCH may be used to transmit the following UL control information (UCI).
Scheduling Request (SR): Information used for requesting a UL UL-SCH resource.
HARQ-ACK: A Response to PDCCH (indicating DL SPS release) and/or a response to DL transport block (TB) on PDSCH. HARQ-ACK indicates whether information transmitted on the PDCCH or PDSCH is received. The HARQ-ACK response includes positive ACK (simply ACK), negative ACK (hereinafter NACK), Discontinuous Transmission (DTX), or NACK/DTX. Here, the term HARQ-ACK is used mixed with HARQ-ACK/NACK and ACK/NACK. In general, ACK may be represented by bit value 1 and NACK may be represented by bit value 0.
Channel State Information (CSI): Feedback information on the DL channel. The UE generates it based on the CSI-Reference Signal (RS) transmitted by the base station. Multiple Input Multiple Output (MIMO)-related feedback information includes a Rank Indicator (RI) and a Precoding Matrix Indicator (PMI). CSI can be divided into CSI part 1 and CSI part 2 according to the information indicated by CSI.

In the 3GPP NR system, five PUCCH formats may be used to support various service scenarios, various channel environments, and frame structures.

PUCCH format 0 is a format capable of transmitting 1-bit or 2-bit HARQ-ACK information or SR. PUCCH format 0 can be transmitted through one or two OFDM symbols on the time axis and one PRB on the frequency axis. When PUCCH format 0 is transmitted in two OFDM symbols, the same sequence to the two symbols may be transmitted through different RBs. In this case, the sequence may be a cyclic shift (CS) sequence from the base sequence used for PUCCH format 0. Through this, the UE can obtain a frequency diversity gain. Specifically, the UE may determine a cyclic shift (CS) value m_{cs} according to the M_{bit} bit UCI (M_{bit}=1 or 2). In addition, a sequence in which a base sequence of length 12 is cyclically shifted based on a predetermined CS value m_{cs} may be mapped to 1 OFDM symbol and 12 REs of 1 RB and transmitted. When the number of cyclic shifts available to the UE is 12 and M_{bit}=1, 1 bit UCI 0 and 1 may be mapped to two cyclic shifted sequences having a difference of 6 cyclic shift values, respectively. In addition, when M_{bit}=2, 2 bits UCI 00, 01, 11, and 10 may be mapped to four cyclic shifted sequences in which the difference in cyclic shift values is 3, respectively.

PUCCH format 1 may deliver 1-bit or 2-bit HARQ-ACK information or SR. PUCCH format 1 may be transmitted through consecutive OFDM symbols on the time axis and one PRB on the frequency axis. Here, the number of OFDM symbols occupied by PUCCH format 1 may be one of 4 to 14. More specifically, UCI, which is M_{bit}=1, may be BPSK-modulated. The UE may modulate UCI, which is M_{bit}=2, with quadrature phase shift keying (QPSK). A signal is obtained by multiplying a modulated complex valued symbol d(0) by a sequence of length 12. In this case, the sequence may be a base sequence used for PUCCH format 0. The UE spreads the even-numbered OFDM symbols to which PUCCH format 1 is allocated through the time axis orthogonal cover code (OCC) to transmit the obtained signal. PUCCH format 1 determines the maximum number of different UEs multiplexed in the one RB according to the length of the OCC to be used. A demodulation reference signal (DMRS) may be spread with OCC and mapped to the odd-numbered OFDM symbols of PUCCH format 1.

PUCCH format 2 may deliver UCI exceeding 2 bits. PUCCH format 2 may be transmitted through one or two OFDM symbols on the time axis and one or a plurality of RBs on the frequency axis. When PUCCH format 2 is transmitted in two OFDM symbols, the sequences which are transmitted in different RBs through the two OFDM symbols may be same each other. Here, the sequence may be a plurality of modulated complex valued symbols d(0), . . . , d(M_{symbol}−1). Here, M_{symbol} may be M_{bit}/2. Through this, the UE may obtain a frequency diversity gain. More specifically, M_{bit} bit UCI (M_{bit}>2) is bit-level scrambled, QPSK modulated, and mapped to RB(s) of one or two OFDM symbol(s). Here, the number of RBs may be one of 1 to 16.

PUCCH format 3 or PUCCH format 4 may deliver UCI exceeding 2 bits. PUCCH format 3 or PUCCH format 4 may be transmitted through consecutive OFDM symbols on the time axis and one PRB on the frequency axis. The number of OFDM symbols occupied by PUCCH format 3 or PUCCH format 4 may be one of 4 to 14. Specifically, the UE modulates M_{bit} bits UCI (M_{bit}>2) with π/2-Binary Phase Shift Keying (BPSK) or QPSK to generate a complex valued symbol d(0) to d(M_{symb}=M_{bit}−1). Here, when using π/2-BPSK, M_{symb}=M_{bit}, and when using QPSK, M_{symb}=M_{bit}/2. The UE may not apply block-unit spreading to the PUCCH format 3. However, the UE may apply block-unit spreading to one RB (i.e., 12 subcarriers) using PreDFT-OCC of a length of 12 such that PUCCH format 4 may have two or four multiplexing capacities. The UE performs transmit precoding (or DFT-precoding) on the spread signal and maps it to each RE to transmit the spread signal.

In this case, the number of RBs occupied by PUCCH format 2, PUCCH format 3, or PUCCH format 4 may be determined according to the length and maximum code rate of the UCI transmitted by the UE. When the UE uses PUCCH format 2, the UE may transmit HARQ-ACK information and CSI information together through the PUCCH. When the number of RBs that the UE may transmit is greater than the maximum number of RBs that PUCCH format 2, or PUCCH format 3, or PUCCH format 4 may use, the UE may transmit only the remaining UCI information without transmitting some UCI information according to the priority of the UCI information.

PUCCH format 1, PUCCH format 3, or PUCCH format 4 may be configured through the RRC signal to indicate frequency hopping in a slot. When frequency hopping is configured, the index of the RB to be frequency hopped may be configured with an RRC signal. When PUCCH format 1, PUCCH format 3, or PUCCH format 4 is transmitted through N OFDM symbols on the time axis, the first hop may have floor (N/2) OFDM symbols and the second hop may have ceiling(N/2) OFDM symbols.

PUCCH format 1, PUCCH format 3, or PUCCH format 4 may be configured to be repeatedly transmitted in a plurality of slots. In this case, the number K of slots in which the PUCCH is repeatedly transmitted may be configured by the RRC signal. The repeatedly transmitted PUCCHs must start at an OFDM symbol of the constant position in each slot, and have the constant length. When one OFDM symbol among OFDM symbols of a slot in which a UE should transmit a PUCCH is indicated as a DL symbol by an RRC signal, the UE may not transmit the PUCCH in a corresponding slot and delay the transmission of the PUCCH to the next slot to transmit the PUCCH.

Meanwhile, in the 3GPP NR system, the UE may perform transmission/reception using a bandwidth less than or equal to the bandwidth of the carrier (or cell). To this end, the UE may be configured with a bandwidth part (BWP) consisting of a continuous bandwidth of a portion of the bandwidth of the carrier. A UE operating according to TDD or operating in an unpaired spectrum may receive up to four DL/UL BWP pairs for one carrier (or cell). In addition, the UE may activate one DL/UL BWP pair. A UE operating according to FDD or operating in a paired spectrum may receive up to 4 DL BWPs on a downlink carrier (or cell) and up to 4 UL BWPs on an uplink carrier (or cell). The UE may activate one DL BWP and UL BWP for each carrier (or cell). The UE may not receive or transmit in time-frequency resources other than the activated BWP. The activated BWP may be referred to as an active BWP.

The base station may indicate an activated BWP among the BWPs configured by the UE through downlink control information (DCI). The BWP indicated through DCI is activated, and other configured BWP(s) are deactivated. In a carrier (or cell) operating in TDD, the base station may include a bandwidth part indicator (BPI) indicating the BWP activated in the DCI scheduling the PDSCH or PUSCH to change the DL/UL BWP pair of the UE. The UE may receive a DCI scheduling a PDSCH or a PUSCH and may identify a DL/UL BWP pair activated based on the BPI. In the case of a downlink carrier (or cell) operating in FDD, the base station may include a BPI indicating the activated BWP in the DCI scheduling the PDSCH to change the DL BWP of the UE. In the case of an uplink carrier (or cell) operating in FDD, the base station may include a BPI indicating the activated BWP in the DCI scheduling the PUSCH to change the UL BWP of the UE.

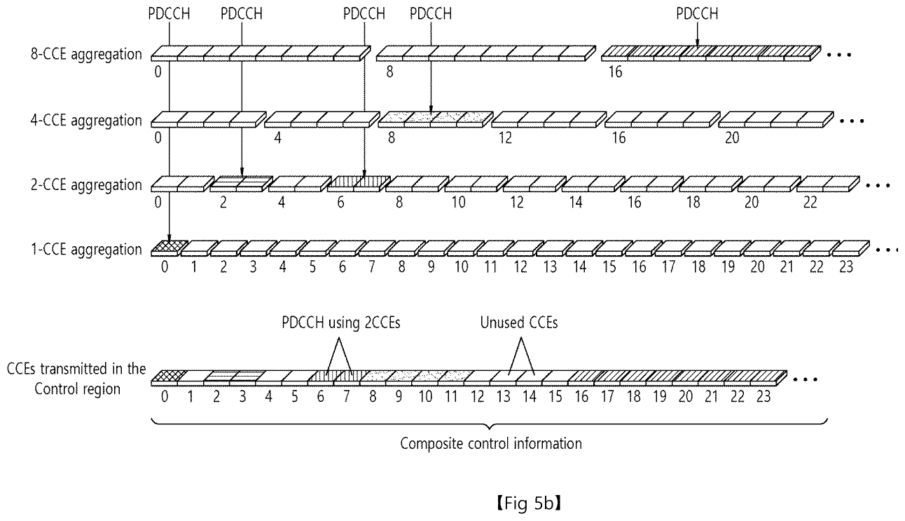

FIG. 8 is a conceptual diagram illustrating carrier aggregation.

The carrier aggregation is a method in which the UE uses a plurality of frequency blocks or cells (in the logical sense) configured with UL resources (or component carriers) and/or DL resources (or component carriers) as one large logical frequency band in order for a wireless communication system to use a wider frequency band. One component carrier may also be referred to as a term called a Primary cell (PCell) or a Secondary cell (SCell), or a Primary SCell (PScell). However, hereinafter, for convenience of description, the term “component carrier” is used.

Referring to FIG. 8, as an example of a 3GPP NR system, the entire system band may include up to 16 component carriers, and each component carrier may have a bandwidth of up to 400 MHz. The component carrier may include one or more physically consecutive subcarriers. Although it is shown in FIG. 8 that each of the component carriers has the same bandwidth, this is merely an example, and each component carrier may have a different bandwidth. Also, although each component carrier is shown as being adjacent to each other in the frequency axis, the drawings are shown in a logical concept, and each component carrier may be physically adjacent to one another, or may be spaced apart.

Different center frequencies may be used for each component carrier. Also, one common center frequency may be used in physically adjacent component carriers. Assuming that all the component carriers are physically adjacent in the embodiment of FIG. 8, center frequency A may be used in all the component carriers. Further, assuming that the respective component carriers are not physically adjacent to each other, center frequency A and the center frequency B can be used in each of the component carriers.

When the total system band is extended by carrier aggregation, the frequency band used for communication with each UE can be defined in units of a component carrier. UE A may use 100 MHz, which is the total system band, and performs communication using all five component carriers. UEs B₁˜B₅ can use only a 20 MHz bandwidth and perform communication using one component carrier. UEs C₁ and C₂ may use a 40 MHz bandwidth and perform communication using two component carriers, respectively. The two component carriers may be logically/physically adjacent or non-adjacent. UE C₁ represents the case of using two non-adjacent component carriers, and UE C₂ represents the case of using two adjacent component carriers.

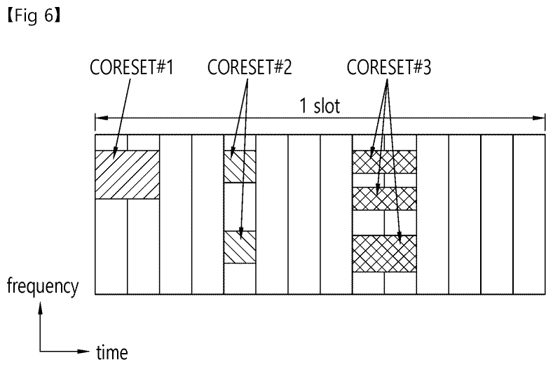

FIG. 9 is a drawing for explaining signal carrier communication and multiple carrier communication. Particularly, FIG. 9(a) shows a single carrier subframe structure and FIG. 9(b) shows a multi-carrier subframe structure.

Referring to FIG. 9(a), in an FDD mode, a general wireless communication system may perform data transmission or reception through one DL band and one UL band corresponding thereto. In another specific embodiment, in a TDD mode, the wireless communication system may divide a radio frame into a UL time unit and a DL time unit in a time domain, and perform data transmission or reception through a UL/DL time unit. Referring to FIG. 9(b), three 20 MHz component carriers (CCs) can be aggregated into each of UL and DL, so that a bandwidth of 60 MHz can be supported. Each CC may be adjacent or non-adjacent to one another in the frequency domain. FIG. 9(b) shows a case where the bandwidth of the UL CC and the bandwidth of the DL CC are the same and symmetric, but the bandwidth of each CC can be determined independently. In addition, asymmetric carrier aggregation with different number of UL CCs and DL CCs is possible. A DL/UL CC allocated/configured to a specific UE through RRC may be called as a serving DL/UL CC of the specific UE.

The base station may perform communication with the UE by activating some or all of the serving CCs of the UE or deactivating some CCs. The base station can change the CC to be activated/deactivated, and change the number of CCs to be activated/deactivated. If the base station allocates a CC available for the UE as to be cell-specific or UE-specific, at least one of the allocated CCs can be deactivated, unless the CC allocation for the UE is completely reconfigured or the UE is handed over. One CC that is not deactivated by the UE is called as a Primary CC (PCC) or a primary cell (PCell), and a CC that the base station can freely activate/deactivate is called as a Secondary CC (SCC) or a secondary cell (SCell).

Meanwhile, 3GPP NR uses the concept of a cell to manage radio resources. A cell is defined as a combination of DL resources and UL resources, that is, a combination of DL CC and UL CC. A cell may be configured with DL resources alone, or a combination of DL resources and UL resources. When the carrier aggregation is supported, the linkage between the carrier frequency of the DL resource (or DL CC) and the carrier frequency of the UL resource (or UL CC) may be indicated by system information. The carrier frequency refers to the center frequency of each cell or CC. A cell corresponding to the PCC is referred to as a PCell, and a cell corresponding to the SCC is referred to as an SCell. The carrier corresponding to the PCell in the DL is the DL PCC, and the carrier corresponding to the PCell in the UL is the UL PCC. Similarly, the carrier corresponding to the SCell in the DL is the DL SCC and the carrier corresponding to the SCell in the UL is the UL SCC. According to UE capability, the serving cell(s) may be configured with one PCell and zero or more SCells. In the case of UEs that are in the RRC_CONNECTED state but not configured for carrier aggregation or that do not support carrier aggregation, there is only one serving cell configured only with PCell.

As mentioned above, the term “cell” used in carrier aggregation is distinguished from the term “cell” which refers to a certain geographical area in which a communication service is provided by one base station or one antenna group. That is, one component carrier may also be referred to as a scheduling cell, a scheduled cell, a primary cell (PCell), a secondary cell (SCell), or a primary SCell (PScell). However, in order to distinguish between a cell referring to a certain geographical area and a cell of carrier aggregation, in the present disclosure, a cell of a carrier aggregation is referred to as a CC, and a cell of a geographical area is referred to as a cell.

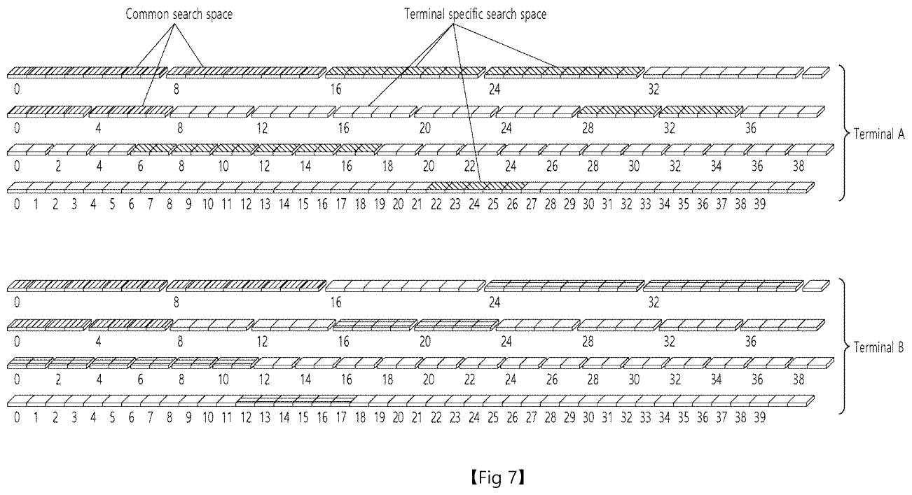

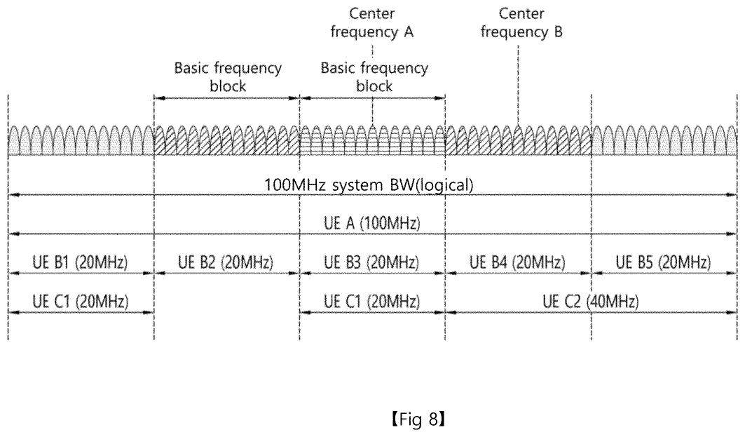

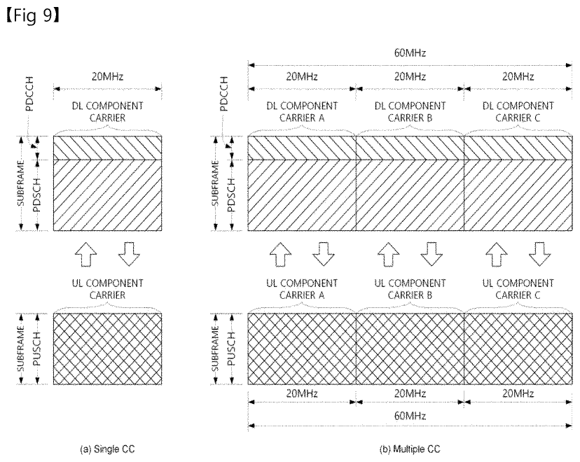

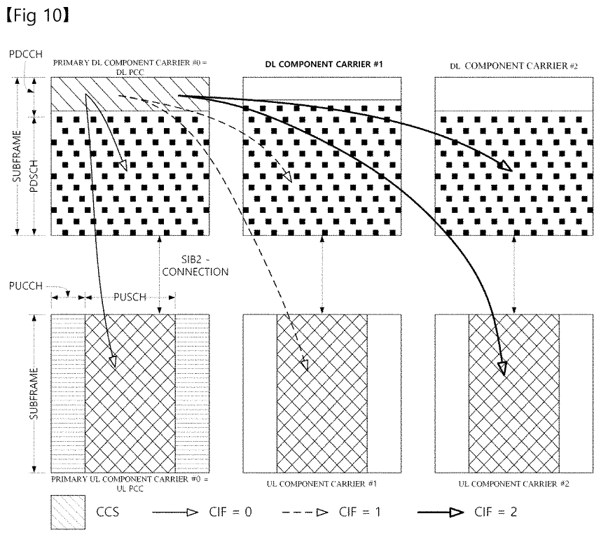

FIG. 10 is a diagram showing an example in which a cross carrier scheduling technique is applied. When cross carrier scheduling is set, the control channel transmitted through the first CC may schedule a data channel transmitted through the first CC or the second CC using a carrier indicator field (CIF). The CIF is included in the DCI. In other words, a scheduling cell is set, and the DL grant/UL grant transmitted in the PDCCH area of the scheduling cell schedules the PDSCH/PUSCH of the scheduled cell. That is, a search area for the plurality of component carriers exists in the PDCCH area of the scheduling cell. A PCell may be basically a scheduling cell, and a specific SCell may be designated as a scheduling cell by an upper layer.

In the embodiment of FIG. 10, it is assumed that three DL CCs are merged. Here, it is assumed that DL component carrier #0 is DL PCC (or PCell), and DL component carrier #1 and DL component carrier #2 are DL SCCs (or SCell). In addition, it is assumed that the DL PCC is set to the PDCCH monitoring CC. When cross-carrier scheduling is not configured by UE-specific (or UE-group-specific or cell-specific) higher layer signaling, a CIF is disabled, and each DL CC can transmit only a PDCCH for scheduling its PDSCH without the CIF according to an NR PDCCH rule (non-cross-carrier scheduling, self-carrier scheduling). Meanwhile, if cross-carrier scheduling is configured by UE-specific (or UE-group-specific or cell-specific) higher layer signaling, a CIF is enabled, and a specific CC (e.g., DL PCC) may transmit not only the PDCCH for scheduling the PDSCH of the DL CC A using the CIF but also the PDCCH for scheduling the PDSCH of another CC (cross-carrier scheduling). On the other hand, a PDCCH is not transmitted in another DL CC. Accordingly, the UE monitors the PDCCH not including the CIF to receive a self-carrier scheduled PDSCH depending on whether the cross-carrier scheduling is configured for the UE, or monitors the PDCCH including the CIF to receive the cross-carrier scheduled PDSCH.

On the other hand, FIGS. 9 and 10 illustrate the subframe structure of the 3GPP LTE-A system, and the same or similar configuration may be applied to the 3GPP NR system. However, in the 3GPP NR system, the subframes of FIGS. 9 and 10 may be replaced with slots.

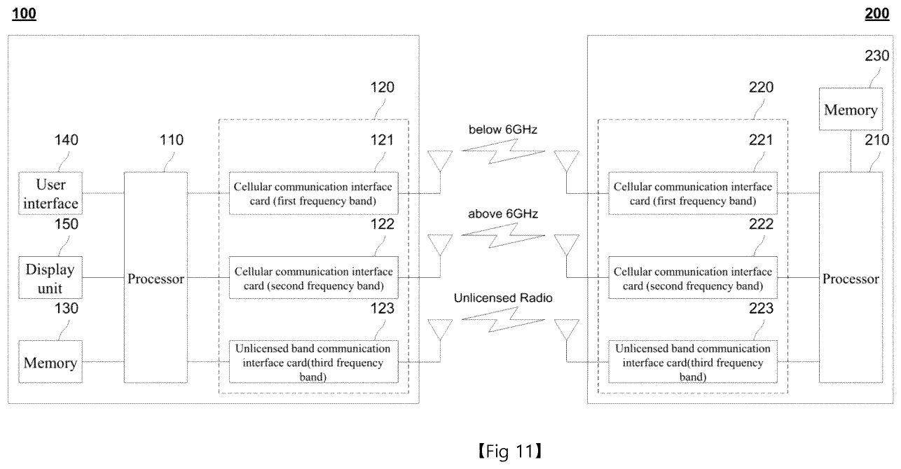

FIG. 11 is a block diagram showing the configurations of a UE and a base station according to an embodiment of the present disclosure.

In an embodiment of the present disclosure, the UE may be implemented with various types of wireless communication devices or computing devices that are guaranteed to be portable and mobile. The UE may be referred to as a User Equipment (UE), a Station (STA), a Mobile Subscriber (MS), or the like. In addition, in an embodiment of the present disclosure, the base station controls and manages a cell (e.g., a macro cell, a femto cell, a pico cell, etc.) corresponding to a service area, and performs functions of a signal transmission, a channel designation, a channel monitoring, a self diagnosis, a relay, or the like. The base station may be referred to as next Generation NodeB (gNB) or Access Point (AP).

As shown in the drawing, a UE 100 according to an embodiment of the present disclosure may include a processor 110, a communication module 120, a memory 130, a user interface 140, and a display unit 150.

First, the processor 110 may execute various instructions or programs and process data within the UE 100. In addition, the processor 110 may control the entire operation including each unit of the UE 100, and may control the transmission/reception of data between the units. Here, the processor 110 may be configured to perform an operation according to the embodiments described in the present disclosure. For example, the processor 110 may receive slot configuration information, determine a slot configuration based on the slot configuration information, and perform communication according to the determined slot configuration.

Next, the communication module 120 may be an integrated module that performs wireless communication using a wireless communication network and a wireless LAN access using a wireless LAN. For this, the communication module 120 may include a plurality of network interface cards (NICs) such as cellular communication interface cards 121 and 122 and an unlicensed band communication interface card 123 in an internal or external form. In the drawing, the communication module 120 is shown as an integral integration module, but unlike the drawing, each network interface card can be independently arranged according to a circuit configuration or usage.

The cellular communication interface card 121 may transmit or receive a radio signal with at least one of the base station 200, an external device, and a server by using a mobile communication network and provide a cellular communication service in a first frequency band based on the instructions from the processor 110. According to an embodiment, the cellular communication interface card 121 may include at least one NIC module using a frequency band of less than 6 GHz. At least one NIC module of the cellular communication interface card 121 may independently perform cellular communication with at least one of the base station 200, an external device, and a server in accordance with cellular communication standards or protocols in the frequency bands below 6 GHz supported by the corresponding NIC module.

The cellular communication interface card 122 may transmit or receive a radio signal with at least one of the base station 200, an external device, and a server by using a mobile communication network and provide a cellular communication service in a second frequency band based on the instructions from the processor 110. According to an embodiment, the cellular communication interface card 122 may include at least one NIC module using a frequency band of more than 6 GHz. At least one NIC module of the cellular communication interface card 122 may independently perform cellular communication with at least one of the base station 200, an external device, and a server in accordance with cellular communication standards or protocols in the frequency bands of 6 GHz or more supported by the corresponding NIC module.

The unlicensed band communication interface card 123 transmits or receives a radio signal with at least one of the base station 200, an external device, and a server by using a third frequency band which is an unlicensed band, and provides an unlicensed band communication service based on the instructions from the processor 110. The unlicensed band communication interface card 123 may include at least one NIC module using an unlicensed band. For example, the unlicensed band may be a band of 2.4 GHz, 5 GHz, 6 GHz, 7 GHz, or above 52.6 GHz. At least one NIC module of the unlicensed band communication interface card 123 may independently or dependently perform wireless communication with at least one of the base station 200, an external device, and a server according to the unlicensed band communication standard or protocol of the frequency band supported by the corresponding NIC module.

The memory 130 stores a control program used in the UE 100 and various kinds of data therefor. Such a control program may include a prescribed program required for performing wireless communication with at least one among the base station 200, an external device, and a server.

Next, the user interface 140 includes various kinds of input/output means provided in the UE 100. In other words, the user interface 140 may receive a user input using various input means, and the processor 110 may control the UE 100 based on the received user input. In addition, the user interface 140 may perform an output based on instructions from the processor 110 using various kinds of output means.

Next, the display unit 150 outputs various images on a display screen. The display unit 150 may output various display objects such as content executed by the processor 110 or a user interface based on control instructions from the processor 110.

In addition, the base station 200 according to an embodiment of the present disclosure may include a processor 210, a communication module 220, and a memory 230.

First, the processor 210 may execute various instructions or programs, and process internal data of the base station 200. In addition, the processor 210 may control the entire operations of units in the base station 200, and control data transmission and reception between the units. Here, the processor 210 may be configured to perform operations according to embodiments described in the present disclosure. For example, the processor 210 may signal slot configuration and perform communication according to the signaled slot configuration.

Next, the communication module 220 may be an integrated module that performs wireless communication using a wireless communication network and a wireless LAN access using a wireless LAN. For this, the communication module 220 may include a plurality of network interface cards such as cellular communication interface cards 221 and 222 and an unlicensed band communication interface card 223 in an internal or external form. In the drawing, the communication module 220 is shown as an integral integration module, but unlike the drawing, each network interface card can be independently arranged according to a circuit configuration or usage.

The cellular communication interface card 221 may transmit or receive a radio signal with at least one of the UE 100, an external device, and a server by using a mobile communication network and provide a cellular communication service in the first frequency band based on the instructions from the processor 210. According to an embodiment, the cellular communication interface card 221 may include at least one NIC module using a frequency band of less than 6 GHz. The at least one NIC module of the cellular communication interface card 221 may independently perform cellular communication with at least one of the UE 100, an external device, and a server in accordance with the cellular communication standards or protocols in the frequency bands less than 6 GHz supported by the corresponding NIC module.

The cellular communication interface card 222 may transmit or receive a radio signal with at least one of the UE 100, an external device, and a server by using a mobile communication network and provide a cellular communication service in the second frequency band based on the instructions from the processor 210. According to an embodiment, the cellular communication interface card 222 may include at least one NIC module using a frequency band of 6 GHz or more. The at least one NIC module of the cellular communication interface card 222 may independently perform cellular communication with at least one of the base station 100, an external device, and a server in accordance with the cellular communication standards or protocols in the frequency bands 6 GHz or more supported by the corresponding NIC module.

The unlicensed band communication interface card 223 transmits or receives a radio signal with at least one of the base station 100, an external device, and a server by using the third frequency band which is an unlicensed band, and provides an unlicensed band communication service based on the instructions from the processor 210. The unlicensed band communication interface card 223 may include at least one NIC module using an unlicensed band. For example, the unlicensed band may be a band of 2.4 GHz, 5 GHz, 6 GHz, 7 GHz, or above 52.6 GHz. At least one NIC module of the unlicensed band communication interface card 223 may independently or dependently perform wireless communication with at least one of the UE 100, an external device, and a server according to the unlicensed band communication standards or protocols of the frequency band supported by the corresponding NIC module.

FIG. 11 is a block diagram illustrating the UE 100 and the base station 200 according to an embodiment of the present disclosure, and blocks separately shown are logically divided elements of a device. Accordingly, the aforementioned elements of the device may be mounted in a single chip or a plurality of chips according to the design of the device. In addition, a part of the configuration of the UE 100, for example, a user interface 140, a display unit 150 and the like may be selectively provided in the UE 100. In addition, the user interface 140, the display unit 150 and the like may be additionally provided in the base station 200, if necessary.

A slot format may be configured for the UE by the base station in a TDD or unpaired spectrum system. The slot format may refer to the type of symbols in the slot. The symbol type may be at least one of a downlink symbol (DL symbol), an uplink symbol (UL symbol), or a flexible symbol. A symbol type of a slot in a radio frame may be configured for the UE by the base station. The flexible symbol may refer to a symbol that is not configured as a downlink symbol or an uplink symbol.

The UE may receive information about the type of each symbol in the slot from the base station through a cell-specific or cell-common radio resource control (RRC) signal. Alternatively, the UE may semi-statically receive information about the type of each symbol in the slot via SIB1. Furthermore, the UE may semi-statically receive information about the type of each symbol in the slot from the base station through a UE-specific UE-dedicated RRC signal. The base station may configure/set the type of each symbol in the slot for the UE by using the information about the type of each symbol in the slot.

When the UE receives the information about the type of each symbol in the slot from the base station through a cell-specific RRC signal, the information about the type of each symbol may include at least one among the period of a cell-specific slot, the number of slots including only downlink symbols starting from a cell-specific slot at which the period begins, the number of downlink symbols starting from the first symbol of a slot immediately following the last slot including only downlink symbols, the number of slots including only uplink symbols starting from the last cell-specific slot of the period, and the number of uplink symbols immediately preceding the last of slots including only uplink symbols. Furthermore, when the UE receives the information about the type of each symbol in the slot from the base station through a cell-specific RRC signal, the information about the type of each symbol may include up to two slot patterns. In this case, each of the two patterns may be applied consecutively to symbols in the time domain. The downlink symbol, the uplink symbol, and the flexible symbol configured based on the cell-specific RRC signal or SIB1 may be referred to as a cell-specific downlink symbol, a cell-specific uplink symbol, and a cell-specific flexible symbol, respectively.

When the UE receives information about the type of each symbol in the slot from the base station through a UE-specific RRC signal, the cell-specific flexible symbol may be configured as a downlink symbol or an uplink symbol. In this case, the information about the type of each symbol may include at least one among an index for a slot in a period, the number of downlink symbols starting from the first symbol in a slot indicated by the index, and the number of uplink symbols starting from the last symbol in the slot indicated by the index. In addition, for the UE, all of the symbols in the slot are configured as downlink symbols, or all of the symbols in the slot are configured as uplink symbols. The downlink symbol, the uplink symbol, and the flexible symbol configured based on the UE-specific RRC signal may be referred to as a UE-specific downlink symbol, a UE-specific uplink symbol, and a UE-specific flexible symbol, respectively.

The base station may transmit information about the slot format to the UE via a slot format indicator (SFI) in DCI format 2_0 contained in a group common (GC)-PDCCH. The GC-PDCCH may be CRC-scrambled with SFI-RNTI for UEs receiving the information about the slot format. Hereinafter, an SFI transmitted via a GC-PDCCH may be described as a dynamic SFI.

The UE may receive a dynamic SFI through GC-PDCCH to receive indication of whether symbols in a slot are cell-specific flexible symbols or UE-specific flexible symbols, downlink symbols, uplink symbols, or flexible symbols. In other words, only a flexible symbol semi-statically configured for the UE may be indicated as one of a downlink symbol, an uplink symbol, and a flexible symbol via a dynamic SFI. The UE may not expect that a semi-statically configured downlink symbol or uplink symbol will be indicated as a different type of symbol by the dynamic SFI. The UE may perform blind decoding at each monitoring period configured by the base station to receive a GC-PDCCH transmitting DCI format 2_0 including the dynamic SFI. When the UE successfully receives the GC-PDCCH by performing the blind decoding, the UE may apply information about a slot format indicated by the dynamic SFI, starting from a slot in which the GC-PDCCH has been received.

A combination of slot formats that can be indicated through a dynamic SFI may be configured for the UE by the base station. The slot format combination may be for each of 1 to 256 slots, and a slot format combination for one of the 1 to 256 slots may be configured for the UE through a dynamic SFI. The dynamic SFI may include an index indicating a slot to which the slot format combination is applied. Table 3 shows a slot format combination for each slot (see 3GPP TS38.213).

TABLE 3

| For- | Symbol number in a slot | | | | | | | | | | | | | |
|---|---|---|---|---|---|---|---|---|---|---|---|---|---|---|
| mat | 0 | 1 | 2 | 3 | 4 | 5 | 6 | 7 | 8 | 9 | 10 | 11 | 12 | 13 |
| 0 | D | D | D | D | D | D | D | D | D | D | D | D | D | D |
| 1 | U | U | U | U | U | U | U | U | U | U | U | U | U | U |
| 2 | F | F | F | F | F | F | F | F | F | F | F | F | F | F |
| 3 | D | D | D | D | D | D | D | D | D | D | D | D | D | F |
| 4 | D | D | D | D | D | D | D | D | D | D | D | D | F | F |
| 5 | D | D | D | D | D | D | D | D | D | D | D | F | F | F |
| 6 | D | D | D | D | D | D | D | D | D | D | F | F | F | F |
| 7 | D | D | D | D | D | D | D | D | D | F | F | F | F | F |
| 8 | F | F | F | F | F | F | F | F | F | F | F | F | F | U |
| 9 | F | F | F | F | F | F | F | F | F | F | F | F | U | U |
| 10 | F | U | U | U | U | U | U | U | U | U | U | U | U | U |
| 11 | F | F | U | U | U | U | U | U | U | U | U | U | U | U |
| 12 | F | F | F | U | U | U | U | U | U | U | U | U | U | U |
| 13 | F | F | F | F | U | U | U | U | U | U | U | U | U | U |
| 14 | F | F | F | F | F | U | U | U | U | U | U | U | U | U |
| 15 | F | F | F | F | F | F | U | U | U | U | U | U | U | U |
| 16 | D | F | F | F | F | F | F | F | F | F | F | F | F | F |
| 17 | D | D | F | F | F | F | F | F | F | F | F | F | F | F |
| 18 | D | D | D | F | F | F | F | F | F | F | F | F | F | F |
| 19 | D | F | F | F | F | F | F | F | F | F | F | F | F | U |
| 20 | D | D | F | F | F | F | F | F | F | F | F | F | F | U |
| 21 | D | D | D | F | F | F | F | F | F | F | F | F | F | U |
| 22 | D | F | F | F | F | F | F | F | F | F | F | F | U | U |
| 23 | D | D | F | F | F | F | F | F | F | F | F | F | U | U |
| 24 | D | D | D | F | F | F | F | F | F | F | F | F | U | U |
| 25 | D | F | F | F | F | F | F | F | F | F | F | U | U | U |
| 26 | D | D | F | F | F | F | F | F | F | F | F | U | U | U |
| 27 | D | D | D | F | F | F | F | F | F | F | F | U | U | U |
| 28 | D | D | D | D | D | D | D | D | D | D | D | D | F | U |
| 29 | D | D | D | D | D | D | D | D | D | D | D | F | F | U |
| 30 | D | D | D | D | D | D | D | D | D | D | F | F | F | U |
| 31 | D | D | D | D | D | D | D | D | D | D | D | F | U | U |
| 32 | D | D | D | D | D | D | D | D | D | D | F | F | U | U |
| 33 | D | D | D | D | D | D | D | D | D | F | F | F | U | U |
| 34 | D | F | U | U | U | U | U | U | U | U | U | U | U | U |
| 35 | D | D | F | U | U | U | U | U | U | U | U | U | U | U |
| 36 | D | D | D | F | U | U | U | U | U | U | U | U | U | U |
| 37 | D | F | F | U | U | U | U | U | U | U | U | U | U | U |
| 38 | D | D | F | F | U | U | U | U | U | U | U | U | U | U |
| 39 | D | D | D | F | F | U | U | U | U | U | U | U | U | U |
| 40 | D | F | F | F | U | U | U | U | U | U | U | U | U | U |
| 41 | D | D | F | F | F | U | U | U | U | U | U | U | U | U |
| 42 | D | D | D | F | F | U | U | U | U | U | U | U | U | U |
| 43 | D | D | D | D | D | D | D | D | D | F | F | F | F | U |
| 44 | D | D | D | D | D | D | F | F | F | F | F | F | U | U |
| 45 | D | D | D | D | D | D | F | F | U | U | U | U | U | U |
| 46 | D | D | D | D | D | F | U | D | D | D | D | D | F | U |
| 47 | D | D | F | U | U | U | U | D | D | F | U | U | U | U |
| 48 | D | F | U | U | U | U | U | D | F | U | U | U | U | U |
| 49 | D | D | D | D | F | F | U | D | D | D | D | F | F | U |
| 50 | D | D | F | F | U | U | U | D | D | F | F | U | U | U |
| 51 | D | F | F | U | U | U | U | D | F | F | U | U | U | U |
| 52 | D | F | F | F | F | F | U | D | F | F | F | F | F | U |
| 53 | D | D | F | F | F | F | U | D | D | F | F | F | F | U |
| 54 | F | F | F | F | F | F | F | D | D | D | D | D | D | D |
| 55 | D | D | F | F | F | U | U | U | D | D | D | D | D | D |

| | |
|---|---|
| 56- | Reserved |
| 254 | |
| 255 | UE determines the slot format for the slot based on tdd-UL-DL- |
| | ConfigurationCommon, or tdd-UL-DL-ConfigurationDedicated |
| | and, if any, on detected DCI formats |

In Table 3, D denotes a downlink symbol, U denotes an uplink symbol, and F denotes a flexible symbol. As shown in Table 3, DL/UL switching may be allowed up to two times within a slot.

In the TDD or unpaired spectrum, when the UE receives configuration or indication of a slot format, allocating limited time domain resources as uplink resources may cause uplink coverage reduction, latency increase, and capacity reduction. To this end, a specific time domain resource in a cell may be used for both downlink reception and uplink transmission. Even though the base station uses the specific time domain resource for both downlink reception and uplink transmission, the UE may perform one of the downlink reception and the uplink transmission in the same time domain resource by supporting only a half-duplex communication scheme.

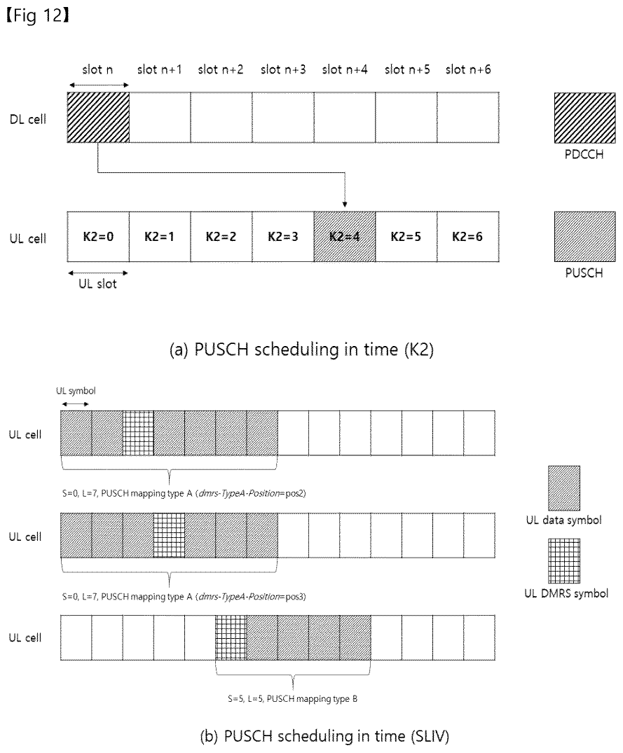

FIG. 12 illustrates a method of scheduling a physical uplink shared channel in a time domain according to an embodiment of the present disclosure.

A UE may transmit uplink data to a base station through a PUSCH. The base station may schedule (perform PUSCH scheduling), for the UE, to transmit uplink data through the PUSCH. i) In a dynamic grant (DG) method, the base station may perform PUSCH scheduling via DCI included in a PDCCH. Alternatively, ii) in a configured grant (CG) method, the UE may transmit uplink data to the base station through a PUSCH according to a resource and a transmission method preconfigured for the UE by the base station.

In this case, the DCI included in the PDCCH may include PUSCH scheduling information. For example, the DCI may include information on a time domain (time-domain resource assignment (TDRA)) and information on a frequency domain (frequency-domain resource assignment (FDRA)). The UE may receive DCI transmitted in a control resource set and a search space, and may perform operations (e.g., uplink data transmission through the PUSCH) indicated via the DCI. In this case, a DCI format for PUSCH scheduling may be DCI formats 0_0, 0_1, and 0_2. DCI of DCI formats 0_0, 0_1, and 02 may include a TDRA field including time domain information of the PUSCH. In this case, the time domain information may include K2, which is an offset value between a slot in which the PDCCH is transmitted from the base station and a slot in which the UE transmits the PUSCH. In addition, the DCI may include a start and length indication value (SLIV) which is a joint-coded value of a starting symbol index (S) of the PUSCH and a symbol length (L, number) of the PUSCH in a slot indicated by K2. If the UE receives the DCI in slot n, a slot in which the PUSCH is scheduled may be slot (floor(n*2μPUSCH/n*2μPDCCH)+K2). μPUSCH and μPDCCH may refer to a subcarrier spacing (SCS) of a cell in which the PUSCH is scheduled and a cell in which the UE receives the PDCCH, respectively. floor(x) is a function that returns the largest integer among integers equal to or smaller than x. In the present specification, slot n may refer to a slot indexed with index n.

Referring to FIG. 12(a), a subcarrier spacing of a cell in which the UE receives a PDCCH and a cell in which a PUSCH is scheduled may be the same. In this case, if the UE receives the PDCCH in slot n and is indicated that K2 is 4, a slot in which the PUSCH is scheduled may be slot n+K2, that is, slot n+4.

As a PUSCH scheduling type, there may be two mapping types of PUSCH mapping type A and PUSCH mapping type B. According to a PUSCH mapping type, the range of possible values for a starting symbol index and an SLIV of the PUSCH may vary. In PUSCH mapping type A, only resource assignment including a DMRS symbol is possible, and the DMRS symbol may be located in a third or fourth symbol of a slot according to a value indicated by a higher layer. That is, in the case of PUSCH mapping type A, an index (S) of a starting symbol of the PUSCH may be 0, and a length (L) of the PUSCH may have one of values from 4 to 14 (12 for an extended CP) according to a DMRS symbol position. In PUSCH mapping type B, a first symbol of the PUSCH may be a DMRS symbol. Accordingly, S may have a value from 0 to 13 (11 for an extended CP), and L may have one of values from 1 to 14 (12 for an extended CP). In addition, since one PUSCH cannot cross a slot boundary, the sum of S and L needs to be smaller than or equal to 14 (12 for an extended CP).

Referring to FIG. 12(b), the base station may schedule PUSCH mapping type A in which a third symbol is a DMRS symbol, an index (S) of a starting symbol is 0, and a length (L) is 7, and may schedule PUSCH mapping type B in which a first symbol is a DMRS symbol, an index (S) of a starting symbol is 5, and a length (L) is 5. In this case, frequency domain information of the PUSCH indicated in the FDRA field of DCI format 0_0, 0_1, or 02 may be divided into two types according to frequency resource assignment types.

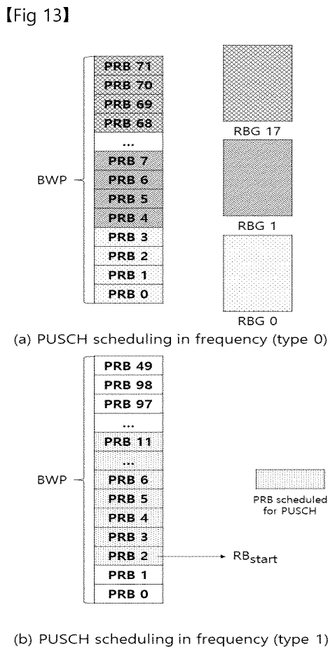

FIG. 13 illustrates a method of scheduling a physical uplink shared channel in a frequency domain according to an embodiment of the present disclosure.

Hereinafter, a frequency resource assignment type is described with reference to FIG. 13.

i) Frequency resource assignment type 0 which is a first type may be a type in which an RBG is configured by bundling a predetermined number of PRBs according to the number of RBs included in a BWP set (configured) for a UE and whether to use the RBG is indicated via a bitmap in units of RBGs. That is, the UE may determine whether to use a corresponding RBG via a bitmap transmitted from a base station. The number of PRBs included in one RBG may be set (configured) from a higher layer, and the more RBs are included in a BWP set (configured) for the UE, the more PRBs may be set (configured). Referring to FIG. 13(a), a BWP size set (configured) for the UE may be 72 PRBs, and one RBG may include 4 PRBs. In this case, the UE may determine four PRBs as one RBG in ascending order from PRB 0, and each RBG may be indexed from 0. That is, an RBG including PRBs 0 to PRB 3 may be indexed as RBG 0, and an RBG including PRBs 4 through PRB 7 may be indexed as RBG 1. Up to RBG 17 may be indexed in the same manner, and in this case, the base station may transmit 1 bit (0 or 1) per RBG, i.e., a total of 18 bits, to the UE, and the UE may determine, based on the received 18 bits, whether to use PRBs constituting a corresponding RBG. In this case, if a bit value is 0, the UE may determine that a PUSCH is not scheduled for any PRB among the PRBs constituting the corresponding RBG. If the bit value is 1, the UE may determine that a PUSCH is scheduled for all PRBs in the corresponding RBG. In this case, the bit value can be applied in reverse. ii) Frequency resource assignment type 1 which is a second type may be a type indicating information on consecutive PRBs assigned according to the size of an active BWP or an initial BWP of the UE. The information on consecutive PRBs may be a resource indication value (RIV) value in which a start index (S) and a length (L) of the consecutive PRBs are jointly coded. Referring to FIG. 13(b), when a BWP size is 50 PRBs and a PUSCH is scheduled for the UE from PRB 2 to PRB 11 among the 50 PRBs, a start index of consecutive PRBs may be 2 and a length may be 10. That is, the UE may determine the start index and the length of consecutive PRBs in which the PUSCH is scheduled, based on an RIV value received from the base station. Specifically, the RIV may be calculated by NsizeBWP*(L−1)+S. NsizeBWP may be the size of BWP configured for the UE. For example, if the RIV value received by the UE is 452, calculation of 452 is based on 452=50*(10−1)+2, and thus the UE may determine that the start index of consecutive PRBs in which the PUSCH is scheduled is 2 and the length is 10.

Via DCI of DCI format 0_1 or 0_2 for scheduling of the PUSCH, the UE may be configured, from a higher layer, to use only one of the above-described two frequency resource assignment types or dynamically use both the two types. If the UE is configured to dynamically use the two types, the UE may determine a type to be used, via 1 bit of a most significant bit (MSB) of an FDRA field of the DCI.

There may be an uplink shared channel transmission method based on a configured grant for URLLC transmission, etc. The uplink shared channel transmission method based on a configured grant may be described as grant-free transmission. The uplink shared channel transmission method based on a configured grant may be a method in which if the base station configures, for the UE, available resources for uplink transmission via a higher layer (i.e., RRC signaling), the UE transmits an uplink shared channel by using the configured resources. The uplink shared channel transmission method based on a configured grant may be classified into two types depending on whether DCI indicates activation and release. i) Type 1 of the uplink shared channel transmission method based on a configured grant may be a method of configuring a transmission method and resources in advance via a higher layer. ii) Type 2 of the uplink shared channel transmission method based on a configured grant may be a method of configuring configured grant-based transmission via a higher layer, and configuring, via DCI, a method and resources for actual transmission.

The uplink transmission method based on a configured grant may support URLLC transmission. Accordingly, uplink transmission may be repeatedly performed on multiple slots to ensure high reliability. In this case, a redundancy version (RV) sequence may be one of (0, 0, 0, 0), (0, 2, 3, 1), and (0, 3, 0, 3), and an RV corresponding to a (mod(n−1, 4)+1)^{th} value may be used in an nm repetition transmission. That is, an RV corresponding to a value obtained by adding 1 to a remainder of dividing n−1 by 4 may be used. In addition, the UE configured to repeatedly transmit an uplink channel may start repetition transmission only in a slot having an RV value of 0. However, if an RV sequence is (0, 0, 0, 0) and an uplink channel is configured to be repeatedly transmitted in 8 slots, the UE cannot start repetition transmission in an 8^{th} slot. The UE may terminate repetition transmission when a UL grant having the same HARQ process ID is received or when the number of repetition transmissions configured via a higher layer is reached or a periodicity is exceeded. The UL grant may refer to DCI for PUSCH scheduling.

As described above, in order to improve PUSCH transmission/reception reliability between a base station and a UE in a wireless communication system, the base station may configure for the UE to repeatedly transmit a PUSCH.

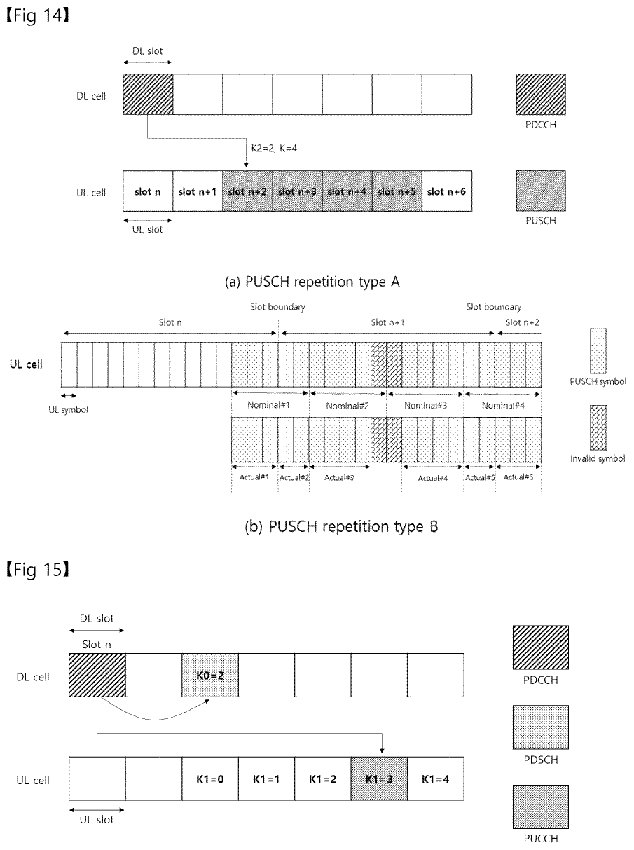

FIG. 14 illustrates repetition transmission of a physical uplink shared channel according to an embodiment of the present disclosure.

There may be two types of PUSCH repetition transmission performed by a UE. i) First, PUSCH repetition transmission type A is described. When a UE receives DCI of DCI format 0_1 or 0_2 included in a PDCCH for PUSCH scheduling from a base station, the UE may repeatedly transmit a PUSCH on K consecutive slots. A K value may be configured from a higher layer or may be a value included in a TDRA field of the DCI so as to be configured for the UE. For example, referring to FIG. 14(a), the UE may receive the PDCCH for PUSCH scheduling in slot n, and a K2 value may be configured from DCI included in the received PDCCH. In this case, if the K2 value is 2 and the K value is 4, the UE may start PUSCH repetition transmission in slot n+K2, and may repeatedly transmit a PUSCH until slot n+K2+K−1. That is, the UE starts PUSCH repetition transmission in slot n+2 and repeatedly transmits a PUSCH until slot n+5. In this case, time and frequency domain resources in which the PUSCH is transmitted in each slot may be the same as those indicated in the DCI. That is, the PUSCH may be transmitted in the same symbol and PRB(s) within a slot. ii) Next, PUSCH repetition transmission type B is described. PUSCH repetition transmission type B may be a type used for the UE to perform low-latency PUSCH repetition transmission in order to satisfy URLLC requirements, etc. The UE may be configured with a symbol (S) in which PUSCH repetition transmission starts and a length (L) of the PUSCH repeatedly transmitted, via the TDRA field of the DCI transmitted by the base station. In this case, the starting symbol (S) and the length (L) may be for a temporarily obtained nominal PUSCH rather than an actual PUSCH actually transmitted by the UE. A separate symbol may not exist between nominal PUSCHs configured to be repeatedly transmitted. That is, nominal PUSCHs may be consecutive in the time domain. The UE may determine an actual PUSCH from the nominal PUSCHs. One nominal PUSCH may be determined to be one or multiple actual PUSCHs. The base station may configure, for the UE, symbols unavailable for PUSCH repetition transmission type B. Symbols unavailable for PUSCH repetition transmission type B may be described as invalid symbols. The UE may exclude invalid symbols from among resources configured to transmit nominal PUSCHs. As described above, nominal PUSCHs are configured to be repeatedly transmitted on consecutive symbols, but if invalid symbols are excluded, resources for nominal PUSCH transmission become inconsecutive. An actual PUSCH may be configured to be transmitted on consecutive symbols configured for one nominal PUSCH transmission except for invalid symbols. In this case, if consecutive symbols cross a slot boundary, an actual PUSCH actually transmitted may be divided with reference to the slot boundary. Invalid symbols may include downlink symbols configured for the UE by the base station. Referring to FIG. 14(b), the UE may be scheduled with PUSCH transmission having a length of 5 symbols starting from a 12^{th} symbol of a first slot (slot n), and may be configured with 4 times of type B repetition transmission. In this case, resources scheduled for a first nominal PUSCH (nominal #1) may include symbol (n,11), symbol (n,12), symbol (n,13), symbol (n+1,0), and symbol (n+1,1). Resources scheduled for a second nominal PUSCH (nominal #2) may include symbol (n+1,2), symbol (n+1,3), symbol (n+1,4), symbol (n+1,5), and symbol (n+1,6). Resources scheduled for a third nominal PUSCH (nominal #3) may include symbol (n+1,7), symbol (n+1,8), symbol (n+1,9), symbol (n+1,10), and symbol (n+1,11). Resources scheduled for a fourth nominal PUSCH (nominal #4) may include symbol (n+1,12), symbol (n+1,13), symbol (n+2,0), symbol (n+2,1), and symbol (n+2,2). In this case, symbol (n,k) represents symbol k of slot n. That is, k may be a value starting from 0 to 13 for a normal CP, and may be a value from 0 to 11 for an extended CP. Invalid symbols may be configured to be symbols 6 and 7 of slot n+1. In this case, in order to determine an actual PUSCH, a last symbol of the second nominal PUSCH (nominal #2) may be excluded, and a first symbol of the third nominal PUSCH (nominal #3) may be excluded. The first nominal PUSCH (nominal #1) may be divided into two actually transmitted actual PUSCHs (actual #1 and actual #2) by a slot boundary. Each of the second nominal PUSCH (nominal #2) and the third nominal PUSCH (nominal #3) may be divided into one actual PUSCH (actual #3 and actual #4) by combining consecutive symbols except for an invalid symbol. Finally, the fourth nominal PUSCH (nominal #4) is divided into two actually transmitted (actual) PUSCHs (actual #5 and actual #6) by a slot boundary. The UE finally transmits actually transmitted (actual) PUSCHs. One actual PUSCH needs to include at least one DMRS symbol. Accordingly, in a case where PUSCH repetition transmission type B is configured, when a total length of the actual PUSCH is one symbol, the actual PUSCH may be omitted without being transmitted. This is because the actual PUSCH corresponding to one symbol cannot include information other than a DMRS.

In order to obtain diversity gain in the frequency domain, frequency hopping may be configured for uplink channel transmission.

For PUSCH repetition transmission type A, one of intra-slot frequency hopping, in which frequency hopping is performed within a slot, and inter-slot frequency hopping, in which frequency hopping is performed in each slot, may be configured for the UE. If intra-slot frequency hopping is configured for the UE, the UE may divide the PUSCH in half in the time domain in a slot for transmitting the PUSCH and transmit one half of the PUSCH in a scheduled PRB, and may transmit the other half in a PRB obtained by adding an offset value to the scheduled PRB. In this case, two or four offset values may be configured according to an active BWP size via a higher layer, and one of the values may be configured for (indicated to) the UE via DCI. If inter-slot frequency hopping is configured for the UE, the UE may transmit the PUSCH in a scheduled PRB in a slot having an even-numbered slot index, and may transmit the PUSCH in a PRB obtained by adding an offset value to the scheduled PRB in an odd-numbered slot.

For PUSCH repetition transmission type B, one of inter-repetition frequency hopping, in which frequency hopping is performed at a nominal PUSCH boundary, and inter-slot frequency hopping, in which frequency hopping is performed in every slot, may be configured for the UE. If inter-repetition frequency hopping is configured for the UE, the UE may transmit actual PUSCH(s) corresponding to an odd-numbered nominal PUSCH on a scheduled PRB, and the UE may transmit actual PUSCH(s) corresponding to an even-numbered nominal PUSCH on a PRB obtained by adding an offset value to the scheduled PRB. In this case, two or four offset values may be configured according to an active BWP size via a higher layer, and one of the values may be configured for (indicated to) the UE via DCI. If inter-slot frequency hopping is configured for the UE, the UE may transmit the PUSCH in a scheduled PRB in a slot having an even-numbered slot index, and may transmit the PUSCH in a PRB obtained by adding an offset value to the scheduled PRB in an odd-numbered slot.

In a case where the UE performs PUSCH repetition transmission, when a symbol scheduled for PUSCH transmission in a specific slot overlaps with a semi-persistently configured DL symbol or a symbol configured for reception of an SS/PBCH block, the UE may not transmit an overlapping PUSCH on a slot including the overlapping symbol. In addition, the overlapping PUSCH may be delayed and may not be transmitted even on a subsequent slot.

If the UE receives DCI of DCI format 1_0, 1_1, or 1_2 for PUCCH scheduling, the UE needs to transmit a PUCCH to the base station. In this case, the PUCCH may include uplink control information (UCI), and UCI may include at least one of HARQ-ACK, a scheduling request (SR), and channel state information (CSI). HARQ-ACK may be HARQ-ACK indicating whether the UE has successfully received two types of channels. A first type may be HARQ-ACK for a PDSCH when the UE is scheduled with the PDSCH via DCI of DCI format 1_0, 1_1, or 1_2. A second type may be HARQ-ACK for DCI when the DCI of DCI format 1_0, 1_1, or 1_2 is DCI indicating release of a semi-persistently scheduled (SPS) PDSCH. For PUCCH transmission including HARQ-ACK, a “PDSCH-to-HARQ_feedback timing indicator” field of DCI may indicate K1 which is information (value) for a slot in which the scheduled PUCCH is transmitted. Here, K1 may be a non-negative integer value. DCI of DCI format 1_0 may indicate one of {0, 1, 2, 3, 4, 5, 6, 7} as a K1 value. The K1 value that can be indicated in DCI of DCI format 1_1 or 1_2 may be set (configured) from a higher layer.

A method of determining a slot in which a PUCCH including a first type HARQ-ACK is transmitted is described. An uplink slot overlapping with a last symbol in which a PDSCH corresponding to HARQ-ACK is transmitted may exist. In this case, if an index of the overlapping uplink slot is m, the UE may transmit a PUCCH including HARQ-ACK on slot m+K1. The index of the uplink slot may be a value determined based on a subcarrier spacing of a BWP in which the PUCCH is transmitted. If the UE is configured with downlink slot aggregation, the last symbol in which the PDSCH is transmitted may refer to a last scheduled symbol within a last slot among slots in which the PDSCH is transmitted.

FIG. 15 illustrates a method of scheduling a physical uplink control channel according to an embodiment of the present disclosure.

Referring to FIG. 15, a subcarrier spacing of a DL BWP in which a PDCCH is received, a subcarrier spacing of a DL BWP scheduled for a PDSCH, and a subcarrier spacing of a UL BWP in which a PUCCH is transmitted may be the same. A UE may receive a PDCCH for scheduling of a PUCCH and a PDSCH from a base station in slot n. In this case, a K0 value and a K1 value may be configured (indicated) to be 2 and 3, respectively, by DCI included in the PDCCH received in slot n. For example, if a last symbol in which the PDSCH is transmitted is symbol n+K0 (i.e., symbol n+2), the UE may transmit HARQ-ACK for the PDSCH on slot n+2+K1 (i.e., slot n+5). In this case, HARQ-ACK for the PDSCH may be included in the PUCCH.

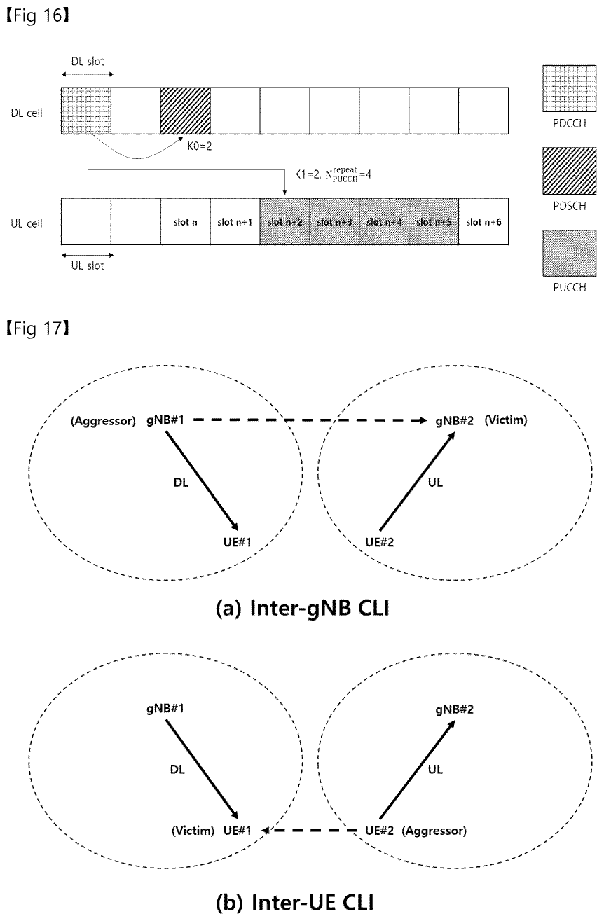

FIG. 16 illustrates repetition transmission of a physical uplink control channel according to an embodiment of the present disclosure.

In order to secure wide coverage in the NR system, a UE may repeatedly transmit a long PUCCH on 2, 4, or 8 slots. In this case, the format of the long PUCCH may be PUCCH format 1, 3, or 4. If the UE repeatedly transmits the PUCCH, the same UCI may be repeatedly transmitted in every slot. Referring to FIG. 16, when PDSCH reception is terminated in slot n and a K1 value is 2, the UE may transmit the PUCCH on slot n+K1 (i.e., slot n+2). When a base station configures the number of PUCCH repetition transmission to be 4 (NrepeatPUCCH=4), the UE may repeatedly transmit the PUCCH from slot n+2 to slot n+5. In this case, symbol configurations of repeatedly transmitted PUCCHs may be the same. That is, repetitively transmitted PUCCHs may start from the same symbol in each slot and may include the same number of symbols.

Even for PUCCH transmission, frequency hopping can be applied to obtain diversity gain in the frequency domain. If intra-slot frequency hopping is applied, the UE may divide the time domain of a slot for transmitting the PUCCH in half and transmit one half of the PUCCH on a first PRB and may transmit the other half of the PUCCH on a second PRB. The first PRB and the second PRB may be configured via a higher layer for configuration of PUCCH resources. If inter-slot frequency hopping is applied, the UE may transmit the PUCCH on a first PRB of a slot having an even-numbered slot index and may transmit the PUCCH on a second PRB of a slot having an odd-numbered slot index. In addition, in a case where the UE performs PUCCH repetition transmission, when a symbol of a specific slot scheduled for PUCCH transmission overlaps with a semi-persistently configured DL symbol or a symbol configured for reception of an SS/PBCH block, the UE may not transmit the PUCCH on a slot including the overlapping symbol. The UE may delay transmission of an untransmitted PUCCH so as to transmit the same on a subsequent slot. In this case, if a symbol of a slot for delayed PUCCH transmission does not overlap with a semi-persistently configured DL symbol or a symbol configured for reception of an SS/PBCH block, the UE may transmit the PUCCH.

FIG. 17 illustrates cross link interference (CLI) between neighboring cells according to an embodiment of the present disclosure.

In a TDD or unpaired spectrum, a dynamic and flexible slot format may be configured for or indicated to a UE. In this case, different slot formats may be configured for or indicated to UEs between neighboring cells. In this case, cross link interference (CLI) may occur due to transmission or reception in different slot formats (DL/UL) of the UEs of the neighboring cells.

Referring to FIG. 17(a), downlink transmission (toward UE #1) of base station #1 may interfere with uplink reception (from UE #2) of neighboring base station #2, which may be referred to as CLI between base stations (inter-gNB CLI). Here, base station #1 causing the interference may be referred to as an aggressor base station, and base station #2 receiving the interference may be referred to as a victim base station. Referring to FIG. 17(b), uplink transmission (toward base station #2) of UE #2 may interfere with downlink reception (from base station #1) of neighboring UE #1, which may be referred to as CLI between UEs (inter-UE CLI). Here, UE #2 causing the interference may be referred to as an aggressor UE, and UE #1 receiving the interference may be referred to as a victim UE.

### UL Muting: General

Hereinafter, a method in which a UE performs uplink transmission in order to mitigate inter-gNB CLI is described. Referring to FIG. 17(a), base station #2 may measure inter-gNB CLI through a signal/channel transmitted from base station #1. Specifically, base station #2 may receive configuration information of a signal/channel transmitted by base station #1 via downlink from base station #1, and measure, based on the received configuration information, the intensity (e.g., reference signal received power (RSRP)) of the downlink signal/channel of base station #1 so as to measure inter-gNB CLI. Base station #2 may use a result of the measured CLI to mitigate inter-gNB CLI.

The downlink signal/channel used by base station #2 for CLI measurement may be an SS/PBCH block of base station #1. That is, base station #1 may transfer, to base station #2, configuration information of an SS/PBCH block transmitted by base station #1 via downlink, and base station #2 may measure inter-gNB CLI in a resource in which the SS/PBCH block is transmitted.

Alternatively, the downlink signal/channel used by base station #2 for CLI measurement may be a non-zero power (NZP) CSI-RS of base station #1. That is, base station #1 may transfer NZP CSI-RS configuration transmitted by base station #1 via downlink to base station #2, and base station #2 may measure inter-gNB CLI in a resource in which the NZP CSI-RS of base station #1 is transmitted. Here, the NZP CSI-RS may include at least one of periodic, semi-persistent, and aperiodic NZP CSI-RSs.

A resource in which base station #2 measures inter-gNB CLI and a resource in which UE #2 transmits an uplink channel may overlap with each other. In this case, CLI measurement of base station #2 may fail, and accordingly, a problem that mitigation of inter-gNB CLI is difficult may occur. The resource in which base station #2 measures CLI and the resource in which UE #2 transmits the uplink channel may overlap with each other in units of RBs or REs. For example, when a resource for SS/PBCH block transmission of base station #1 is used for the resource for measuring CLI, the resource in which base station #2 measures CLI and the resource in which UE #2 transmits the uplink channel may overlap with each other in units of RBs or REs. As another example, when a resource for NZP CSI-RS transmission of base station #1 is used for the resource for measurement CLI, the resource in which base station #2 measures CLI and the resource in which UE #2 transmits the channel via uplink may overlap each other in units of REs.

In other to solve the above-described problem, a pattern (in units of RBs or REs) for a resource in which the base station measures inter-gNB CLI may be configured for or indicated to a UE (a UE in a cell for measurement of inter-gNB CLI, e.g., UE #2 of FIG. 17 (a)). In this case, the UE may determine whether or not to perform uplink transmission in the resource in which inter-gNB CLI is measured, according to the uplink signal/channel as below. Hereinafter, the resource pattern configured for or indicated to the UE for the base station to measure CLI is referred to as a UL muting resource.

PUSCH without UCI

When a resource configured or indicated for transmission of a PUSCH (e.g., a PUSCH not multiplexed with UCI) and a semi-persistently configured UL muting resource overlap each other, a UE may assume that PUSCH transmission is not possible in the overlapping resource. In other words, the UE may perform rate-matching of the PUSCH for RBs or REs configured as UL muting resources and transmit the PUSCH. Accordingly, in a case of UL-SCH, even though a partially overlapping resource is not used for PUSCH transmission, when transmitting the PUSCH in accordance with the configured or indicated code rate, based on the remaining resource, the UE may expect successful decoding in the base station.

A UE operation when a UL muting resource is dynamically indicated to a UE and a PUSCH resource and the UL muting resource overlap with each other is described.

In a case where the UE does not indicate capability of partialCancellation to the base station, when a first symbol configured or indicated for PUSCH transmission is a symbol within T_{proc,2} from the last symbol of a CORESET in which a PDCCH including a DCI format indicating UL muting is detected, the UE may not to be expected to cancel PUSCH transmission in a slot including the first symbol configured for PUSCH transmission. That is, the UE may transmit the PUSCH through the slot including the first symbol configured or indicated for PUSCH transmission. T_{proc,2} is a PUSCH preparation time according to UE processing capability. In order to apply UL muting to the PUSCH transmitted from the UE, the base station may transmit a PDCCH including a DCI format indicating the UL muting T_{proc,2} before the first symbol configured or indicated for PUSCH transmission, and when the first symbol indicated for PUSCH transmission is a symbol within T_{proc,2} from the last symbol of a CORESET in which the PDCCH including the DCI format indicating UL muting is detected, the UE may transmit the PUSCH without applying UL muting to the slot including the first symbol indicated for PUSCH transmission.

In a case where the UE does not indicate the capability of partialCancellation to the base station, when the first symbol configured or indicated for PUSCH transmission is a symbol within T_{proc,2} from the last symbol of the CORESET in which the PDCCH including the DCI format indicating UL muting is detected, the UE may perform puncturing of the PUSCH for the resource overlapping with the UL muting resource in the first symbol configured or indicated for PUSCH transmission and transmit the same. A timeline condition for UL cancellation of the UE is not satisfied, rate-matching and RE mapping of the PUSCH for PUSCH processing are difficult to be changed, and thus channel coding, rate-matching, and RE mapping of the PUSCH, generated through the PUSCH processing time, are maintained, but puncturing rather than rate-matching may be performed for the resource overlapping with the UL muting resource in order to prevent the inference with the CLI measurement of the base station.

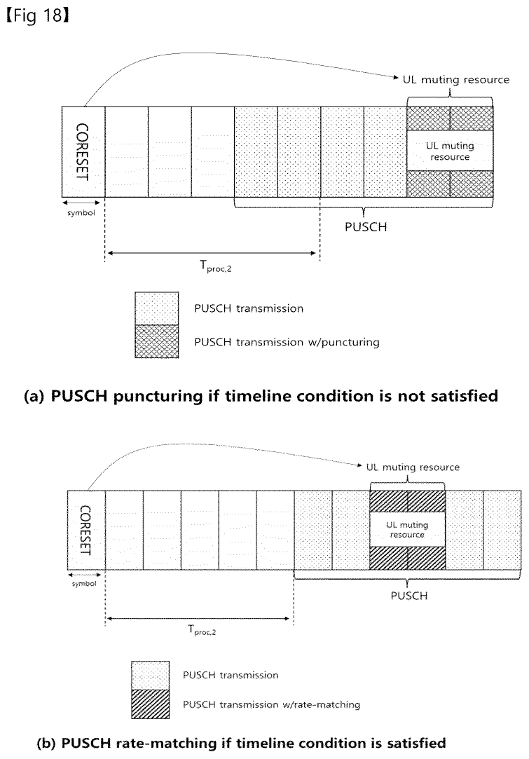

FIG. 18 illustrates a PUSCH transmission method according to an embodiment of the present disclosure.

Referring to FIG. 18(a), a UE may be configured or scheduled to transmit a PUSCH in six symbols, and may detect a PDCCH including a DCI format indicating a UL muting resource for last two symbols (i.e., the fifth and sixth symbols) among the six symbols. The UE may transmit the PUSCH by puncturing a PUSCH resource assigned to a frequency domain area and a symbol overlapping with the UL muting resource.

In a case where the UE does not indicate capability of partialCancellation to a base station, when a first symbol configured or indicated for PUSCH transmission is a symbol after T_{proc,2} from a last symbol of a CORESET in which a PDCCH including a DCI format indicating UL muting is detected, the UE may cancel PUSCH transmission in a slot including the first symbol configured or indicated for PUSCH transmission. When the base station and the UE negotiate about the capability, the base station cannot identify whether the UE has the capability of partialCancellation. Accordingly, when UL muting is indicated, the base station is aware that the UE cannot partially cancel PUSCH transmission, and thus the base station does not expect that the UE cancels the PUSCH transmission for the overlapping part and performs PUSCH transmission for the non-overlapping part. Accordingly, when resources to which the base station indicates UL muting and a scheduled or configured resource overlap each other, the UE may cancel all the PUSCH transmission in the slot including the first symbol configured or indicated for PUSCH transmission as the base station expects. However, when resources scheduled or configured for PUSCH are repeatedly transmitted or consecutively transmitted in one or more slots, the UE may transmit only the PUSCH transmission in the slot including the resource overlapping with the resources to which UL muting is indicated.

In a case where the UE does not indicate capability of partialCancellation to the base station, when a first symbol configured or indicated for PUSCH transmission is a symbol after T_{proc,2} from a last symbol of a CORESET in which a PDCCH including a DCI format indicating UL muting is detected, the UE may performing rate-matching for the PUSCH in consideration of the overlapping resource and transmit the same. The UE may transmit the rate-matched PUSCH in the resource overlapping with the UL muting resource.

For example, referring to FIG. 18(b), the UE may be configured or scheduled to transmit a PUSCH in six symbols, and may detect a PDCCH including a DCI format indicating a UL muting resource for two symbols in the middle (third and fourth symbols) among the six symbols. According to the embodiment above, the UE may perform rate-matching for the PUSCH in consideration of the PUSCH resource assigned to the frequency resource area and the symbol overlapping with the UL muting resource, and transmit the same.

In a case where the UE indicates capability of partialCancellation to the base station, when a symbol configured or indicated for transmission of a PUSCH is a symbol within T_{proc,2} from a last symbol of a CORESET in which a PDCCH including a DCI format indicating UL muting is detected, the UE may not be expected to cancel PUSCH transmission for the corresponding symbols. That is, the UE may transmit the PUSCH for the corresponding symbols. However, when there are a symbol within T_{proc,2} and a symbol after T_{proc,2} among the symbols for one PUSCH transmission, for the symbol after T_{proc,2}, the UE may perform rate-matching for the PUSCH in consideration of the resource overlapping with the UL muting resource and transmit the same. In this case, in order to apply UL muting to the PUSCH transmitted from the UE, the base station may transmit the PDCCH including the DCI format indicating UL muting before T_{proc,2} from the symbol configured or indicated for PUSCH transmission, and when the symbol indicated for transmission of the PUSCH is a symbol within T_{proc,2} from the last symbol of the CORESET in which the PDCCH including the DCI format indicating UL muting is detected, the UE may not apply UL muting to the PUSCH transmission in the corresponding symbol, and may apply UL muting to the PUSCH transmission for the symbol after T_{proc,2}.

In a case where the UE indicates capability of partialCancellation, when a symbol configured or indicated for transmission of a PUSCH is a symbol after T_{proc,2} from a last symbol of a CORESET in which a PDCCH including a DCI format indicating UL muting is detected and does not overlap with the UL muting resource, the UE may transmit the PUSCH in the symbol configured or indicated for PUSCH transmission.

In a case where the UE indicates capability of partialCancellation, when a symbol configured or indicated for transmission of a PUSCH is a symbol after T_{proc,2} from a last symbol of a CORESET in which a PDCCH including a DCI format indicating UL muting is detected and overlaps with the UL muting resource, the UE may cancel PUSCH transmission for the overlapping symbol. However, when the first symbol configured or indicated for transmission of the PUSCH is a symbol after T_{proc,2} (i.e., when symbols for one PUSCH transmission are all symbols after T_{proc,2}), the UE may perform rate-matching for the PUSCH in consideration of the resource overlapping with the UL muting resource and transmit the same. When a timeline condition for UL cancellation of the UE is satisfied, channel coding, rate-matching, and RE mapping of the PUSCH for PUSCH processing can be changed. Accordingly, in order to prevent interference with CLI measurement of the base station, the UE may perform rate-matching for the PUSCH for the resource overlapping with the UL muting resource and transmit the same.

PUCCH without HARQ-ACK or SR)

When a resource configured or indicated for transmission of a PUCCH (e.g., a PUCCH without HARQ-ACK or SR) and a semi-persistently configured UL muting resource overlap each other, the UE may not transmit the PUCCH in a slot including the source for PUCCH transmission. When the PUCCH does not include UCI having a relatively high priority, such as HARQ-ACK or SR (i.e., CSI), CLI measurement of the base station is prioritized in the slot, and the UE may not transmit the PUCCH.

When a resource configured or indicated for transmission of a PUCCH (e.g., a PUCCH without HARQ-ACK or SR) and a semi-persistently configured UL muting resource overlap each other, the UE may prioritize the PUCCH in a slot including the resource for PUCCH transmission, and transmit the PUCCH by prioritizing an operation such as link adaptation in a cell, regardless of configuration of the UL muting resource and inter-gNB CLI measurement.

Hereinafter, a UE operation when a UL muting resource is dynamically indicated to a UE and a PUCCH resource and the UL muting resource overlap each other is described.

In a case where the UE does not indicate capability of partialCancellation to the base station, when a first symbol configured or indicated for transmission of a PUCCH is a symbol within T_{proc,2} from a last symbol of a CORESET in which a PDCCH including a DCI format indicating UL muting is detected, the UE may not be expected to cancel PUCCH transmission in a slot including the first symbol configured or indicated for transmission of the PUCCH. That is, the UE may transmit the PUCCH in the slot including the first symbol configured or indicated for transmission of the PUCCH. In order to apply UL muting to the PUCCH transmitted from the UE, the base station may allow the PDCCH including the DCI format indicating UL muting to be transmitted T_{proc,2} before from the first symbol configured or indicated for transmission of the PUCCH, and when the first symbol indicated for transmission of the PUCCH is a symbol within T_{proc,2} from the last symbol of the CORESET in which the PDCCH including the DCI format indicating UL muting is detected, the UE may not apply UL muting to the PUCCH transmission in the slot including the first slot indicated for transmission of the PUCCH.

In a case where the UE does not indicate capability of partialCancellation to the base station, when a first symbol configured or indicated for transmission of a PUCCH is a symbol after T_{proc,2} from a last symbol of a CORESET in which a PDCCH including a DCI format indicating UL muting is detected, the UE may cancel PUCCH transmission in the slot including the first symbol configured or indicated for transmission of the PUCCH. This is because when the base station and the UE negotiate about the capability, the base station cannot identify whether or not the UE has capability of partialCancellation. Accordingly, when UL muting is indicated, the base station is aware that the UE cannot partially cancel PUCCH transmission, and thus the base station does not expect that the UE partially cancels the PUCCH for the overlapping part and transmits the PUCCH for the non-overlapping part. Accordingly, when resources for which the base station has indicated UL muting and a scheduled or configured resource overlap each other, the UE may cancel all the PUCCH transmission in the slot indicating the overlapping resource as the base station expects. However, when resources scheduled or configured for PUCCH are repeatedly transmitted or consecutively transmitted in one or more slots, the UE may cancel only the PUCCH transmission in the slot including the resource overlapping with the resources to which UL muting is indicated.

In a case where the UE does not indicate capability of partialCancellation to the base station, when a symbol configured or indicated for transmission of a PUCCH is a symbol within T_{proc,2} from a last symbol of a CORESET in which a PDCCH including a DCI format indicating UL muting is detected, the UE may not be expected to cancel PUCCH transmission for the symbols. That is, the UE may transmit the PUCCH in the symbols. In order to apply UL muting to the PUCCH transmitted from the UE, the base station may allow a PDCCH including a DCI format indicating UL muting to be transmitted T_{proc,2} before the symbol configured or indicated for transmission of the PUCCH, and when the symbol indicated for transmission of the PUCCH is a symbol within T_{proc,2} from a last symbol of the CORESET in which the PDCCH including the DCI format indicating UL muting is detected, the UE may not perform UL muting in the PUCCH transmission.

In a case where the UE does not indicate capability of partialCancellation to the base station, when a symbol configured or indicated for transmission of a PUCCH is a symbol T_{proc,2} after a last symbol of a CORESET in which a PDCCH including a DCI format indicating UL muting is detected and does not overlap with the UL muting resource, the UE may transmit the PUCCH in the symbol.

In a case where the UE indicates capability of partialCancellation to the base station, a symbol configured or indicated for transmission of a PUCCH is a symbol T_{proc,2} after a last symbol of a CORESET in which a PDCCH including a DCI format indicating UL muting is detected and overlaps with the UL muting resource, the UE may cancel the PUCCH transmission for the overlapping symbols.

### SRS

When a resource configured or indicated for transmission of an SRS and a semi-persistently configured UL muting resource overlap each other, regardless of an SRS transmission type (e.g., a periodic SRS or an SRS aperiodically transmitted according to triggering of the base station), the UE may not transmit the SRS in the overlapping SRS, and may transmit the SRS in the non-overlapping symbol. The UE cannot cancel the SRS transmission in units of symbols, may thus not transmit the SRS in the symbol overlapping with the semi-persistently configured UL muting resource, and may transmit the SRS in the symbol not overlapping with the semi-persistently configured UL muting resource.

When the SRS is configured or indicated to be transmitted, there may be a periodically configured SRS resource, and there may be an SRS resource aperiodically configured by triggering of the base station. The above-described method is applicable to the periodically configured SRS resource. When the aperiodically configured SRS resource and the semi-persistently configured UL muting resource overlap each other, the UE may transmit the SRS in the overlapping symbol.

Hereinafter, an operation method of a UE when a UL muting resource is dynamically indicated to the UE and an SRS resource configured or indicated for transmission of the SRS and the UL muting resource overlap each other, regardless of an SRS transmission type is described.

When the symbol configured or indicated for transmission of the SRS is a symbol within T_{proc,2} from a last symbol of a CORESET in which a PDCCH including a DCI format indicating UL muting is detected, the UE may not be expected to cancel SRS transmission in the symbol. In order to apply UL muting to the SRS transmitted from the UE, the base station may allow the PDCCH including the DCI format indicating UL muting to be transmitted T_{proc,2} before the symbol configured or indicated for transmission of the SRS, and when the symbol indicated for transmission of the SRS is a symbol within T_{proc,2} from the last symbol of the CORESET in which the PDCCH including the DCI format indicating UL muting is detected, the UE may not apply the UL muting to the SRS transmission in the symbol.

When the symbol configured or indicated for transmission of the SRS is a symbol T_{proc,2} after the last symbol of the CORESET in which the PDCCH including the DCI format indicating UL muting is detected and does not overlap with the UL muting resource, the UE may transmit the SRS in the symbol.

When the symbol configured or indicated for transmission of the SRS is a symbol T_{proc,2} after the last symbol of the CORESET in which the PDCCH including the DCI format indicating UL muting is detected and overlaps with the UL muting resource, the UE may cancel SRS transmission in the overlapping symbol.

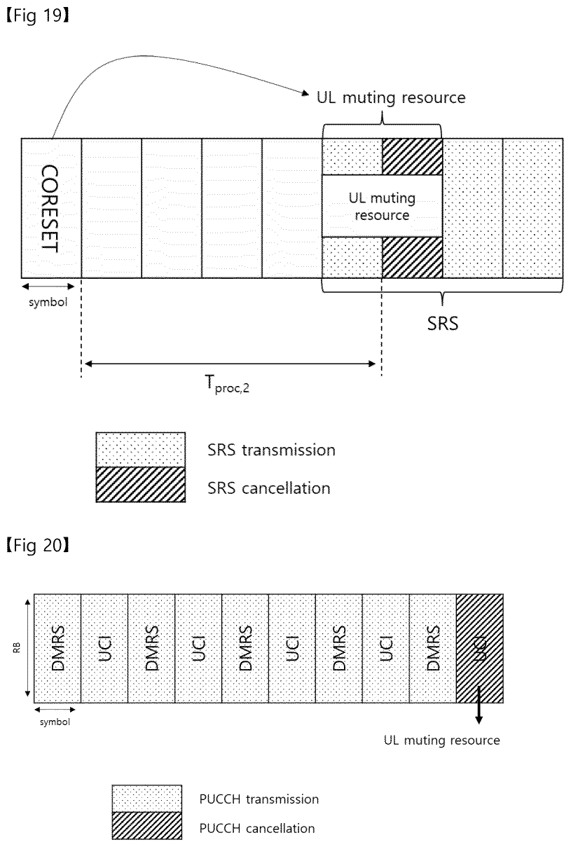

FIG. 19 illustrates an SRS transmission method according to an embodiment of the present disclosure.

Referring to FIG. 19, for the first two symbol among four symbols configured to transmit an SRS, a UL muting resource may be dynamically indicated to a UE. In this case, the UL muting resource and the symbol configured to transmit the SRS may overlap each other. In addition, T_{proc,2} of the UE may be five symbols. The UE may transmit the SRS in a symbol (i.e., the first symbol for the SRS) which is a symbol within T_{proc,2} from a last symbol of a CORESET in which a DCI format indicating UL muting is detected among the four symbols for the SRS and overlaps with the UL muting resource. The UE may cancel the SRS transmission in a symbol (e.g., the second symbol of the SRSR) which is a symbol T_{proc,2} after the last symbol of the CORESET in which the DCI format indicating UL muting is detected among the four symbols for the SRS and overlaps with the UL muting resource.

When a UL muting resource is dynamically indicated to the UE and the periodically configured SRS resource and the UL muting resource overlap each other, the UE may use the above-described method. When an aperiodically configured SRS resource and the semi-persistently configured UL muting resource overlap each other, the UE may transmit the SRS regardless of a collision with the UL muting resource in the overlapping symbol.

### PRACH

Hereinafter, a UE operation when a resource in which a UE is configured or indicated for transmission of a PRACH and a semi-persistently configured or dynamically indicated UL muting resource overlap each other is described.

The UE may transmit the PRACH in the overlapping resource. The PRACH may be is for uplink synchronization and timing advance (TA) alignment, and may be a channel that the UE needs to prioritize to transmit to a base station, such as a scheduling request (SR), a beam failure recovery (BFR), and an on-demand system information (SI) request. Accordingly, the UE may prioritize PRACH transmission.

The UE may not expect that the resource configured to indicate to transmit the PRACH and the semi-persistently configured or dynamically indicated UL muting resource overlap each other.

In addition, for transmission of an uplink PUSCH used for transmission of Msg3 or a PUSCH used for a 2-step random access procedure (i.e., a type-2 random access procedure) as a channel for a random access procedure, the UE may prioritize to transmit the PUSCH regardless of a collision with the UL muting resource.

### PUSCH Including UCI

There may be a case where a resource configured or indicated for transmission of a PUSCH (a PUSCH multiplexed with UCI) and a semi-persistently configured UL muting resource overlap each other. Hereinafter, a PUSCH transmission operation of a UE according to the type of UCI multiplexed with the PUSCH is described.

(First embodiment) When a resource overlapping with a UL muting resource corresponds to an RE to which HARQ-ACK is mapped among the REs to which multiplexing with PUSCH transmission and mapping are performed, a UE may transmit the mapped HARQ-ACK in the RE of the overlapping resource regardless of UL muting. When the resource overlapping with the UL muting resource corresponds to an RE to which CSI part 1, CSI part 2, or data (e.g., UL-SCH) is mapped among the REs to which multiplexing with PUSCH transmission and mapping are performed, the UE may not transmit the mapped CSI part 1, CSI part 2, or data (e.g., UL-SCH) in the RE of the overlapping resource. That is, the UE may transmit a rate-matched PUSCH or a punctured PUSCH by using a PUSCH resource remaining after excluding the RE of the overlapping resource. This is to guarantee transmission of HARQ-ACK having the highest priority of the UCI.

(Second embodiment) When a resource overlapping with a UL muting resource corresponds to an RE to which HARQ-ACK and CSI part 1 are mapped among the REs to which multiplexing with PUSCH transmission and mapping are performed, a UE may transmit HARQ-ACK and CSI part 1 in the mapped RE regardless of UL muting. When the resource overlapping with the UL muting resource corresponds to an RE to which CSI part 2 or data (e.g., UL-SCH) is mapped among the REs to which multiplexing with PUSCH transmission and mapping are performed, the UE may not transmit CSI part 2 or data (e.g., UL-SCH) in the corresponding RE. That is, the UE may transmit a rate-matched PUSCH or transmit a punctured PUSCH by using a PUSCH resource remaining after excluding the overlapping RE. This is to guarantee transmission of UCI remaining after excluding CSI part 2 having a low priority of the UCI.

(Third embodiment) When a resource overlapping with a UL muting resource corresponds to an RE to which UCI (e.g., HARQ-ACK, CSI part 1, and CSI part 2) is mapped among the REs to which multiplexing with PUSCH transmission and mapping are performed, a UE may transmit the UCI (e.g., HARQ-ACK, CSI part 1, and CSI part 2) in the mapped RE regardless of UL muting. When the resource overlapping with the UL muting resource corresponds to an RE to which data (e.g., UL-SCH) is mapped among the REs to which multiplexing with PUSCH transmission and mapping are performed, the UE may not transmit the data (e.g., UL-SCH) in the RE of the overlapping resource. That is, the UE may transmit a rate-matched PUSCH or a punctured PUSCH by using a PUSCH resource remaining after excluding the RE of the overlapping resource. This is to guarantee transmission of UCI for the PUSCH multiplexed with the UCI.

When a UL muting resource is dynamically indicated to the UE and a PUSCH resource and the UL muting resource overlap each other, the UE may apply the above-described PUSCH (including/not including UCI) transmission method. However, in this case, according to the first to third embodiments, the UE may determine whether to prioritize PUSCH transmission without selectively applying UL muting according to the mapped information (e.g., HARQ-ACK, CSI part 1, CSI part 2, or data) in the resource overlapping with the UL muting resource, or to transmit the PUSCH by rate-matching the same or transmit the PUSCH by puncturing the same in consideration of the resource overlapping with the UL muting resource. For example, according to the first embodiment, when the resource overlapping with the UL muting resource corresponds to the RE to which HARQ-ACK is mapped, the UE may transmit the HARQ-ACK in the corresponding RE, and when the overlapping resource corresponds to an RE to which other type of UCI (e.g., CSI part 1 or CSI part 2) or data is mapped, the UE may rate-match the PUSCH for the overlapping resource and transmit the same, or may transmit a punctured PUSCH.

### PUCCH Including HARQ-ACK or SR

When a resource configured or indicated for transmission of HARQ-ACK or SR on a PUCCH and a semi-persistently configured or dynamically indicated UL muting resource overlap each other, a UE may prioritize to transmit a PUCCH (a PUCCH including HARQ-ACK or an SRS) by prioritizing an operation such as link adaptation in a cell, regardless of inter-gNB CLI measurement and a configuration of the UL muting resource in a lost including the overlapping resource.

When a resource configured or indicated for transmission of CSI together with HARQ-ACK or SR on a PUCCH and a semi-persistently configured or dynamically indicated UL muting resource overlap each other and when the PUCCH includes the HARQ-ACK or the SR in a slot including the overlapping resource, the UE may prioritize to transmit the PUCCH by prioritizing an operation such as link adaptation in a cell regardless of inter-gNB CLI measurement and a configuration of the UL muting resource.

When a resource configured or indicated for transmission of a PUCCH (a PUCCH including HARQ-ACK or SR) and a semi-persistently configured or dynamically indicated UL muting resource overlap each other, a UE may perform an operation according to a PUCCH format.

When PUCCH format 0 and the semi-persistently configured UL muting resource overlap each other, the UE may prioritize PUCCH transmission. PUCCH format 0 is transmitted as a sequence, when any one of the REs assigned to PUCCH transmission is not used for the PUCCH transmission, a base station may not be able to detect PUCCH format 0. PUCCH format 0 may be a format which can be scheduled for low-latency transmission of HARQ-ACK or SR. Accordingly, when a resource configured or indicated for transmission of PUCCH format 0 including HARQ-ACK or SR and a semi-persistently configured UL muting resource overlap each other, the UE may transmit PUCCH format 0 including the HARQ-ACK or SR.

A UE operation when PUCCH format 0 and a UL muting resource overlap each other is described.

In a case where the UE does not indicate capability of partialCancellation to the base station, when a first symbol configured or indicated for transmission of a PUCCH is a symbol within T_{proc,2} from a last symbol of a CORESET in which a PDCCH including a DCI format indicating UL muting is detected, the UE may not be expected to cancel PUCCH transmission in a slot including the slot configured or indicated for transmission of the PUCCH. That is, the UE may transmit the PUCCH in the slot including the first symbol configured or indicated for transmission of the PUCCH. In order to apply UL muting to the PUCCH transmitted from the UE, the base station may allow the PDCCH including the DCI format indicating UL muting to be transmitted T_{proc,2} before the first symbol configured or indicated for transmission of the PUCCH, and when the first symbol indicated for transmission of the PUCCH is a symbol within T_{proc,2} from a last symbol of the CORESET in which the PDCCH including the DCI format indicating UL muting is detected, the UE may not apply UL muting to the PUCCH transmission in a slot including the first symbol configured or indicated for transmission of the PUCCH.

In a case where the UE does not indicate capability of partialCancellation to the base station, when a first symbol configured or indicated for transmission of a PUCCH is a symbol T_{proc,2} after a last symbol of a CORESET in which a PDCCH including a DCI format indicating UL muting is detected, the UE may cancel the PUCCH transmission in a slot including the first symbol configured or indicated for transmission of the PUCCH. This is to prioritize CLI measurement of the base station by allowing no PUCCH transmission.

In a case where the UE does not indicate capability of partialCancellation to the base station, when a first symbol configured or indicated for transmission of a PUCCH is a symbol T_{proc,2} after a last symbol of a CORESET in which a PDCCH including a DCI format indicating UL muting is detected, the UE may not be expected to cancel the PUCCH transmission. That is, the UE may transmit the PUCCH in a slot included in the first slot configured or indicated for transmission of the PUCCH.

In a case where the UE indicates capability of partialCancellation to the base station, when a symbol configured or indicated for transmission of a PUCCH is a symbol within T_{proc,2} from a last symbol of a CORESET in which a PDCCH including a DCI format indicating UL muting is detected, the UE may not be expected to cancel PUCCH transmission in the symbol configured or indicated for the transmission of the PUCCH. That is, the UE may transmit the PUCCH in the symbol configured or indicated for transmission of the PUCCH. In order to apply UL muting to the PUCCH transmitted from the UE, the base station may allow the PDCCH including the DCI format indicating UL muting to be transmitted T_{proc,2} before the symbol configured or indicated for transmission of the PUCCH, and when the symbol indicated for transmission of the PUCCH is a symbol within T_{proc,2} from the last symbol of the CORESET in which the PDCCH including the DCI format indicating UL muting is detected, the UE may not apply UL muting to the PUCCH transmission in the symbol indicated for transmission of the PUCCH.

In a case where the UE indicates capability of partialCancellation to the base station, when a symbol configured or indicated for transmission of a PUCCH is a symbol T_{proc,2} after a last symbol of a CORESET in which a PDCCH including a DCI format indicating UL muting is detected and is a symbol not overapplying with the UL muting resource, the UE may transmit the PUCCH in the overlapping symbol.

In a case where the UE indicates capability of partialCancellation to the base station, when a symbol configured or indicated for transmission of a PUCCH is a symbol T_{proc,2} after a last symbol of a CORSET in which a PDCCH including a DCI format indicating UL muting is detected and is a symbol overlapping with the UL muting resource, the UE may cancel the PUCCH transmission for the overlapping symbols.

FIG. 20 illustrates a method of transmitting PUCCH format 1 according to an embodiment of the present disclosure.

When PUCCH format 1 and a semi-persistently configured UL muting resource overlap each other, a UE may not transmit a PUCCH in the overlapping symbol, and may transmit the PUCCH in the remaining non-overlapping symbol. When even a part of a symbol on which the PUCCH is scheduled overlaps with the UL muting resource in the frequency domain, the UE may not transmit the PUCCH in the overlapping symbol, and may transmit the PUCCH in the remaining non-overlapping symbol. For example, referring to FIG. 20, the UE may be configured or indicated, by the base station, to transmit PUCCH format 1 in the 10^{th} symbol. The UE may map a DMRS to an even-numbered symbol (0^{th}, 2^{nd}, 4^{th}, 6^{th}, or 8^{th}) and map UCI to an odd-numbered symbol (1^{st}, 3^{rd}, 5^{th}, 7^{th}, or 9^{th}). In this case, when the ninth symbol and the semi-persistently configured UL muting resource partially or fully overlap with each other in units of REs, the UE may not map the overlapping symbol UCI. That is, the UE may transmit PUCCH format 1 by mapping the UCI or DMRS to the remaining eight symbols remaining after excluding the ninth symbol. In addition, the UE may determine an orthogonal cover code (OCC) for multiplexing of PUCCH format 1 between UEs in a cell so that the OCC is suitable for eight symbols. In PUCCH format 1, a single modulation symbol (π/2-BPSK or QPSK) is mapped to 12 REs (1 symbol×12 subcarriers) as a single sequence, and thus when even some subcarriers in one symbol are not used for PUCCH transmission, the base station cannot detect PUCCH format 1. Accordingly, when even some of the symbols configured or indicated for PUCCH transmission and the UL muting resource overlap each other, the UE may determine again OCC and RE mapping for the symbols remaining after excluding the overlapping symbol and transmit the PUCCH. Referring to FIG. 20, the UE may transmit PUCCH format 1 (e.g., four symbols for UCI and five symbols for DMRS) for the symbols remaining after excluding the symbol having the resource overlapping with the UL muting resource.

A UE operation when PUCCH format 1 and a dynamically indicated UL muting resource overlap each other is described.

In a case where the UE does not indicate capability of partialCancellation to the base station, when a symbol configured or indicated for PUCCH transmission is a symbol within T_{proc,2} from a last symbol of a CORESET in which a PDCCH including a DCI format indicating UL muting is detected, the UE may not be expected to cancel the PUCCH transmission in the symbol configured or indicated for the PUCCH transmission. That is, the UE may transmit the PUCCH in a slot including the symbol configured or indicated for the PUCCH transmission. In order to apply UL muting to a PUCCH transmitted from the UE, the base station may allow the PDCCH including the DCI format indicating UL muting to be transmitted T_{proc,2} before the first symbol configured or indicated for the PUCCH transmission, and when the first symbol indicated for PUCCH transmission is a symbol within T_{proc,2} from the last symbol of the CORESET in which the PDCCH including the DCI format indicating UL muting is detected, the UE may not apply the UL muting to the PUCCH transmission in the slot including the first symbol indicated for PUCCH transmission.

In a case where the UE does not indicate capability of partialCancellation to the base station, when a first symbol configured or indicated for PUCCH transmission is a symbol T_{proc,2} after a last symbol of a CORESET in which a PDCCH including a DCI format indicating UL muting is detected, the UE may cancel the PUCCH transmission in a slot including the first symbol configured or indicated for PUCCH transmission. The UL muting resource is dynamically indicated to the UE by the base station in order to at least prioritize CLI measurement of the base station, and thus this is a method for refraining from transmitting the PUCCH.

In a case where the UE does not indicate capability of partialCancellation to the base station, when a first symbol configured or indicated for PUCCH transmission is a symbol T_{proc,2} after a last symbol of a CORESET in which a PDCCH including a DCI format indicating UL muting is detected, the UE may transmit the PUCCH in a PUCCH format having a shorted symbol length (a shorthand PUCCH format) in consideration of symbols including the overlapping resource. Unlike the method in which PUCCH transmission is cancelled in the slot including the overlapping resource when the UL muting resource and the PUCCH resource even partially overlap each other, the UE may at least transmit the PUCCH through the shortened PUCCH format in the symbol not overlapping with the UL muting resource.

In a case where the UE indicates capability of partialCancellation to the base station, when a symbol configured or indicated for PUCCH transmission is a symbol within T_{proc,2} from a last symbol of a CORESET in which a PDCCH including a DCI format indicating UL muting is detected, the UE may not be expected to cancel the PUCCH transmission in the symbol configured or indicated for PUCCH transmission. In order to apply UL muting to the PUCCH transmitted from the UE, the base station may allow the PDCCH including the DCI format indicating UL muting to be transmitted T_{proc,2} before the symbol configured or indicated for PUCCH transmission, and when the symbol indicated for PUCCH transmission is a symbol within T_{proc,2} from the last symbol of the CORESET in which the PDCCH including the DCI format indicating UL muting is detected, the UE may not apply UL muting to the PUCCH transmission in the symbol indicated for PUCCH transmission.

In a case where the UE indicates capability of partialCancellation to the base station, when a symbol configured or indicated for PUCCH transmission is a symbol T_{proc,2} after a last symbol of a CORESET in which a PDCCH including a DCI format indicating UL muting is detected and does not overlap with a UL muting resource, the UE may transmit the PUCCH in the symbol configured or indicated for PUCCH transmission.

In a case where the UE indicates capability of partialCancellation to the base station, when a symbol configured or indicated for PUCCH transmission is a symbol T_{proc,2} after a last symbol of a CORESET in which a PDCCH including a DCI format indicating UL muting is detected and overlaps with a UL muting resource, the UE may cancel PUCCH transmission in the overlapping symbol.

When the above-described PUCCH format having a shortened symbol length (shortened PUCCH format) is used, the same time area OCC used for UCI or DMRS multiplexing with other UEs may be cell-specifically configured for all UEs in a cell. In addition, when the length of a remaining symbol for a transmission resource for PUCCH format 1 is less than 4 due to UL muting, the PUCCH transmission may be cancelled. Alternatively, a new PUCCH format having the length of 3 less than 4, which includes symbols in the sequence of DMRS, UCI, and DRMS (or UCI, DMRS, and UCI), may be defined, and the UE may transmit the new PUCCH format.

When PUCCH format 2 and a semi-persistently configured UL muting resource overlap each other, the UE may assume that the overlapping resource corresponds to a resource in which PUCCH transmission is not possible. In other words, for RBs or REs overlapping with the UL muting resource, the UE may perform rate-matching for the PUCCH and transmit the rate-matched PUCCH. This is because PUCCH format 2 may be scheduled in multiple RBs ranging from 1 RB to 16 RBs, and thus the UE may expect successful decoding at the base station when transmitting the PUCCH by determining again channel coding, rate-matching, and RE mapping for the remaining resource even though some overlapping resources are not used for PUCCH transmission.

A UE operation when PUCCH format 2 and a dynamically indicated UL muting resource overlap each other is described.

In a case where the UE does not indicate capability of partialCancellation to the base station, when a first symbol configured or indicated for PUCCH transmission is a symbol within T_{proc,2} from a last symbol of a CORESET in which a PDCCH including a DCI format indicating UL muting is detected, the UE may not be expected to cancel the PUCCH transmission in a slot including the first symbol configured or indicated for PUCCH transmission. That is, the UE may transmit the PUCCH in the slot including the first symbol configured or indicated for PUCCH transmission. In this case, in order to apply UL muting to the PUCCH transmitted from the UE, the base station may allow the PDCCH including the DCI format indicating UL muting to be transmitted T_{proc,2} before the first symbol configured or indicated for PUCCH transmission, and when the first symbol indicated for PUCCH transmission is a symbol within T_{proc,2} from the last symbol of the CORESET in which the PDCCH including the DCI format indicating UL muting is detected, the UE may not apply UL muting to the PUCCH transmission in the slot including the first symbol configured or indicated for PUCCH transmission.

In a case where the UE does not indicate capability of partialCancellation to the base station, when a first symbol configured or indicated for PUCCH transmission is a symbol withing T_{proc,2} from a last symbol of a CORESET in which a PDCCH including a DCI format indicating UL muting is detected, the UE may puncture the PUCCH for the resource overlapping with the UL muting resource in the first symbol configured or indicted for PUCCH transmission and transmit the punctured PUCCH. This is for causing no interference with CLI measurement of the base station while maintaining channel coding and RE mapping of the PUCCH generated through a PUCCH processing time because a timeline condition for UL cancellation of the UE fails to be satisfied and channel coding, rate-matching, and RE mapping of the PUCCH for PUCCH processing are difficult to be changed.

In a case where the UE indicates capability of partialCancellation to the base station, when a first symbol configured or indicated for PUCCH transmission is a symbol T_{proc,2} after a last symbol of a CORESET in which a PDCCH including a DCI format indicating UL muting is detected, the UE may cancel PUCCH transmission in a slot including the first symbol configured or indicted for PUCCH transmission.

In a case where the UE does not indicate capability of partialCancellation to the base station, when a first symbol configured or indicated for PUCCH transmission is a symbol T_{proc,2} after a last symbol of a CORESET in which a PDCCH including a DCI format indicating UL muting is detected, the UE may rate-match the PDCCH in consideration of the overlapping resource and transmit the rate-matched PUCCH. Unlike the method in which PUCCH transmission is cancelled in the slot including the first symbol configured or indicated for PUCCH transmission, the UE may transmit the PUCCH in the symbol not overlapping with the UL muting resource.

In a case where the UE indicates capability of partialCancellation to the base station, when a symbol configured or indicated for PUCCH transmission is a symbol within T_{proc,2} from a last symbol of a CORESET in which a PDCCH including a DCI format indicating UL muting is detected, the UE may not be expected to cancel the PUCCH transmission for the symbol configured or indicated for PUCCH transmission. That is, the UE may transmit the PUCCH for the symbol configured or indicated for PUCCH transmission. However, when there are a symbol within T_{proc,2} and a symbol after T_{proc,2} among the symbols for one PUCCH transmission, the UE may rate-match the PUCCH in consideration of the resource overlapping with the UL muting resource and transmit the rate-matched PUCCH, for the symbol after T_{proc,2}. In this case, in order to apply UL muting to the PUCCH transmitted from the UE, the base station may allow the PDCCH including the DCI format indicating UL muting to be transmitted T_{proc,2} before the symbol configured or indicated for PUCCH transmission, and when the symbol indicated for PUCCH transmission is a symbol within T_{proc,2} from the last symbol of the CORESET in which the PDCCH including the DCI format indicating UL muting is detected, the UE may not apply UL muting to the PUCCH transmission in the symbol indicated for PUCCH transmission, and may apply UL muting to the PUCCH transmission for the symbol after T_{proc,2}.

In a case where the UE indicates capability of partialCancellation to the base station, when a symbol configured or indicated for PUCCH transmission is a symbol Tproc,2 after a last symbol a CORESET in which a PDCCH including a DCI format indicating UL muting is detected and does not overlap with a UL muting resource, the UE may transmit the PUCCH in the symbol configured or indicated for PUCCH transmission.

In a case where the UE indicates capability of partialCancellation to the base station, when a symbol configured or indicated for PUCCH transmission is a symbol T_{proc,2} after a last symbol of a CORESET in which a PDCCH including a DCI format indicating UL muting is detected and overlaps with a UL muting resource, the UE may cancel the PUCCH transmission for the symbol configured or indicated for PUCCH transmission.

In the case of PUCCH format 2, UL muting can be applied in units of RBs. This is because the DMRS and UCI are configured in the manner of FDM, thus there is no point in transmitting the DMRS when the UCI muted, channel estimation is affected when the DMRS is muted, and thus it may be difficult to perform UCI decoding.

Alternatively, UL muting may not be applied to a DMRS RE and can be applied to a UCI RE. This is because with respect to PUCCH format 2 having up to 16 RBs, UCI assigned to the entire RBs is decoded through channel estimation through the DMRS for the entire assigned RBs having PUCCH format 2, and thus UCI decoding deterioration may occur when a part of the DMRS is muted.

A UE operation when PUCCH format 2 and a semi-persistently muting resource overlap each other is described.

The UE may assume that an overlapping resource is a resource in which PUCCH transmission is not possible. In other words, the UE may rate-match the PUCCH for the RBs or REs overlapping with the UL muting resource and transmit the rate-matched PUCCH.

The UE may not transmit the PUCCH in the overlapping symbol and may transmit the PUCCH in the non-overlapping symbol. When even a part of a symbol on which the PUCCH is scheduled overlaps with the UL muting resource in the frequency domain, the UE may not transmit the PUCCH in the overlapping symbol, and may transmit the PUCCH in the non-overlapping symbol.

PUCCH format 3 may be scheduled in multiple RBs ranging from 1 RB to 16 RBs and multiple symbols ranging from 4 symbols to 14 symbols. Accordingly, even when some of the overlapping resources are not used for PUCCH transmission, when the UE determines again channel coding, rate-matching, and RE mapping for the remaining resources and transmits the PUCCH, successful decoding at the base station can be expected.

A UE operation when PUCCH format 3 and a semi-persistently indicated UL muting resource overlap each other is described.

In a case where the UE does not indicate capability of partialCancellation to the base station, when a first symbol configured or indicated for PUCCH transmission is a symbol within T_{proc,2} from a last symbol of a CORESET in which a PDCCH including a DCI format indicating UL muting is detected, the UE may not be expected to cancel the PUCCH transmission in a slot including the first symbol configured or indicated for PUCCH transmission. That is, the UE may transmit the PUCCH in the slot including the first symbol configured or indicated for PUCCH transmission. In order to apply UL muting to the PUCCH transmitted from the UE, the base station may cause the PDCCH including the DCI format indicating UL muting to be transmitted T_{proc,2} before the first symbol configured or indicated for PUCCH transmission, and when the first symbol indicated for PUCCH transmission is a symbol within T_{proc,2} from the last symbol of the CORESET in which the PDCCH including the DCI format indicating UL muting is detected, the UE may not apply UL muting to the PUCCH transmission in the slot including the first symbol indicated for PUCCH transmission.

In a case where the UE does not indicate capability of partialCancellation to the base station, a first symbol configured or indicated for PUCCH transmission is a symbol within T_{proc,2} from a last symbol of a CORESET in which a PDCCH including a DCI format indicating UL muting is detected, the UE may puncture the PUCCH for the resource overlapping with the UL muting resource and transmit the punctured PUCCH in the first symbol configured or indicated for PUCCH transmission. This is for causing no interference with CLI measurement of the base station while maintaining channel coding and RE mapping of the PUCCH generated through a PUCCH processing time because a timeline condition for UL cancellation of the UE fails to be satisfied and channel coding, rate-matching, and RE mapping of the PUCCH for PUCCH processing are difficult to be changed.

In a case where the UE does not indicate capability of partialCancellation to the base station, when a first symbol configured or indicated for PUCCH transmission is a symbol T_{proc,2} after a last symbol of a CORESET in which a PDCCH including a DCI format indicating UL muting is detected, the UE may cancel the PUCCH transmission in a slot including the first symbol configured or indicated for PUCCH transmission. The UL muting resource is dynamically indicated to the UE by the base station in order to prioritize CLI measurement of the base station, and thus the UE may not transmit the PUCCH in the slot including the first symbol configured or indicated for PUCCH transmission.

In a case where the UE does not indicate capability of partialCancellation to the base station, when a first symbol configured or indicated for PUCCH transmission is a symbol T_{proc,2} after a last symbol of a CORESET in which a PDCCH including a DCI format indicating UL muting is detected, the UE may rate-match the PUCCH in consideration of the overlapping resource and transmit the rate-matched PUCCH. Unlike the method of cancelling PUCCH transmission in the slot including the first symbol configured or indicated for PUCCH transmission, this is a method enabling PUCCH transmission in a resource not overlapping with the UL muting resource.

In a case where the UE does not indicate capability of partialCancellation to the base station, when a first symbol configured or indicated for PUCCH transmission is a symbol T_{proc,2} after a last symbol of a CORESET in which a PDCCH including a DCI format indicating UL muting is detected, the UE may rate-match the PUCCH in consideration of symbols including the overlapping resource and transmit the rate-matched PUCCH. PUCCH format 3 is scheduled in multiple symbols ranging from 4 to 14, and thus the UE may determine again channel coding, rate-matching, and RE mapping for symbols remaining after excluding the symbol overlapping with the UL muting resource at least for some REs in the frequency domain among the symbols scheduled for PUCCH transmission, and transmit the PUCCH.

In a case where the UE indicates capability of partialCancellation to the base station, when a symbol configured or indicated for PUCCH transmission is a symbol within T_{proc,2} from a last symbol of a CORESET in which a PDCCH including a DCI format indicating UL muting is detected, the UE may not be expected to cancel PUCCH transmission for the symbol configured or indicated for PUCCH transmission. That is, the UE may transmit the PUCCH in the symbol configured or indicated for PUCCH transmission. In order to apply UL muting to the PUCCH transmitted from the UE, the base station may allow the PDCCH including the DCI format indicating UL muting to be transmitted T_{proc,2} before the symbol configured or indicated for PUCCH transmission, and when the symbol indicated for PUCCH transmission is a symbol within Tproc2, from the last symbol of the CORESET in which the PDCCH including the DCI format indicating UL muting is detected, the UE may not apply UL muting to the PUCCH transmission in the symbol indicated for PUCCH transmission.

In a case where the UE indicates capability of partialCancellation to the base station, when a symbol configured or indicated for PUCCH transmission is a symbol within T_{proc,2} from a last symbol of a CORESET in which a PDCCH including a DCI format indicating UL muting is detected, the UE may not be expected to cancel the PUCCH transmission for the symbol configured or indicated for PUCCH transmission. That is, the UE may transmit the PUCCH in the symbol configured or indicated for PUCCH transmission. However, when there are a symbol within T_{proc,2} and a symbol after T_{proc,2} among the symbols for one PUCCH transmission, the UE may rate-match the PUCCH in consideration of the resource overlapping with the UL muting resource for the symbol after T_{proc,2} and transmit the rate-matched PUCCH. In this case, in order to apply UL muting to the PUCCH transmitted from the UE, the base station may allow the PDCCH including the DCI format indicating UL muting to be transmitted T_{proc,2} before the symbol configured or indicated for PUCCH transmission, and when the symbol indicated for PUCCH transmission is a symbol within T_{proc,2} from the last symbol of the CORESET in which the PDCCH including the DCI format indicating UL muting is detected, the UE may not apply UL muting to the PUCCH transmission in the symbol indicated for PUCCH transmission, and may apply UL muting to the PUCCH transmission in the symbol after T_{proc,2}.

In a case where the UE indicates capability of partialCancellation to the base station, when a symbol configured or indicated for PUCCH transmission is a symbol T_{proc,2} after a last symbol of a CORESET in which a PDCCH including a DCI format indicating UL muting is detected and does not overlap with the UL muting resource, the UE may transmit the PUCCH for the corresponding symbol.

In a case where the UE indicates capability of partialCancellation to the base station, when a symbol configured or indicated for PUCCH transmission is a symbol T_{proc,2} after a last symbol of a CORESET in which a PDCCH including a DCI format indicating UL muting is detected and does not overlap with the UL muting resource, the UE may cancel the PUCCH transmission for the corresponding symbol.

In the above-described method related to PUCCH format 3, when the length of the remaining symbol as a transmission resource for PUCCH format 3 is less than 4 due to UL muting, the PUCCH transmission may be cancelled. Alternatively, a new PUCCH format having the length of 3 less than 4, which includes symbols in the sequence of DMRS, UCI, and DRMS (or UCI, DMRS, and UCI), may be defined, and the UE may transmit the new PUCCH format.

When PUCCH format 4 and a semi-persistently configured UL muting resource overlap each other, the UE may not transmit the PUCCH in the overlapping symbol and transmit the PUCCH in the non-overlapping symbol. Even a part of a symbol to which the PUCCH is scheduled and the UL muting resource overlap each other in the frequency domain, the UE may not transmit the PUCCH in the overlapping symbol and may transmit the PUCCH in the non-overlapping symbol. For intra-cell multiplexing, PUCCH format 4 may be transmitted by multiplying the PUCCH with as many OCCs as the number of multiplexed UEs. When even any one of these REs is not used, it is difficult for the base station to distinguish a UE from which a signal is transmitted. Accordingly, the UE may determine again channel code, rate-matching, and RE mapping for symbols in which all subcarriers scheduled in the frequency domain are available for PUCCH transmission and transmit the PUCCH, except for a symbol which cannot be used for PUCCH transmission even for some subcarriers in the frequency domain among the symbols scheduled for PUCCH transmission.

A UE operation when PUCCH format 4 and a dynamically indicated UL muting resource overlap each other is described.

In a case where the UE does not indicate capability of partialCancellation to the base station, when a first symbol configured or indicated for PUCCH transmission is a symbol within T_{proc,2} from a last symbol of a CORESET in which a PDCCH including a DCI format indicating UL muting is detected, the UE may not be expected to cancel the PUCCH transmission in a slot including the first symbol configured or indicated for PUCCH transmission. That is, the UE may transmit the PUCCH in the slot including the first symbol configured or indicated for PUCCH transmission. In this case, in order to apply UL muting to the PUCCH transmitted from the UE, the base station may allow the PDCCH including the DCI format indicating UL muting to be transmitted T_{proc,2} before the first symbol configured or indicated for PUCCH transmission, and when the first symbol indicated for PUCCH transmission is a symbol within T_{proc,2} from the last symbol of the CORESET in which the PDCCH including the DCI format indicating UL muting is detected, the UE may not apply UL muting to the PUCCH transmission in the slot including the first symbol indicated for PUCCH transmission.

In a case where the UE does not indicate capability of partialCancellation to the base station, when a first symbol configured or indicated for PUCCH transmission is a symbol T_{proc,2} after a last symbol of a CORESET in which a PDCCH including a DCI format indicating UL muting is detected, the UE may cancel the PUCCH transmission in a slot including the first symbol configured or indicated for PUCCH transmission. This is to prioritize CLI measurement of the base station.

In a case where the UE does not indicate capability of partialCancellation to the base station, when a first symbol configured or indicated for PUCCH transmission is a symbol T_{proc,2} from a last symbol of a CORESET in which a PDCCH including a DCI format indicating UL muting is detected, the UE may rate-match the PUCCH in consideration of symbols including the overlapping resource and transmit the rate-matched PUCCH. For intra-cell multiplexing, PUCCH format 4 is transmitted by multiplying the PUCCH with as many OCCs as the number of multiplexed UEs, and when even any one of these REs is not used, it is difficult for the base station to distinguish a UE from which a signal is transmitted. Accordingly, when even some of the symbols configured or indicated for PUCCH transmission and the UL muting resource overlap each other, the UE may determine again channel code, rate-matching, and RE mapping for a non-overlapping symbol, except for the overlapping symbol, and transmit the PUCCH.

In a case where the UE indicates capability of partialCancellation to the base station, when a symbol configured or indicated for PUCCH transmission is a symbol within T_{proc,2} from a last symbol of a CORESET in which a PDCCH including a DCI format indicating UL muting is detected, the UE may not be expected to cancel PUCCH transmission for the symbol configured or indicated for PUCCH transmission. That is, the UE may transmit the PUCCH in the symbol configured or indicated for PUCCH transmission. In this case, in order to apply UL muting to the PUCCH transmitted from the UE, the base station may allow the PDCCH including the DCI format indicating UL muting to be transmitted T_{proc,2} before the symbol configured or indicated for PUCCH transmission, and when the symbol indicated for PUCCH transmission is a symbol within T_{proc,2} from the last symbol of the CORESET in which the PDCCH including the DCI format indicating UL muting is detected, the UE may not apply UL muting to the PUCCH transmission in the symbol indicated for PUCCH transmission.

In a case where the UE indicates capability of partialCancellation to the base station, when a symbol configured or indicated for PUCCH transmission is a symbol T_{proc,2} from a last symbol of a CORESET in which a PDCCH including a DCI format indicating UL muting is detected and does not overlap with the UL muting resource, the UE may transmit the PUCCH for the non-overlapping symbol.

In a case where the UE indicates capability of partialCancellation to the base station, when a symbol configured or indicated for PUCCH transmission is a symbol T_{proc,2} after a last symbol of a CORESET in which a PDCCH including a DCI format indicating UL muting and does not overlap with the UL muting resource, the UE may cancel the PUCCH transmission for the non-overlapping symbol.

In relation to the method of PUCCH format 4, when the PUCCH format having a shortened symbol length (shortened PUCCH format) is used, the same time area OCC used for UCI or DMRS multiplexing with other UEs may be cell-specifically configured for all UEs in a cell. In addition, when the length of a remaining symbol for a transmission resource for PUCCH format 4 is less than 4 due to UL muting, the PUCCH transmission may be cancelled. Alternatively, a new PUCCH format having the length of 3 less than 4, which includes symbols in the sequence of DMRS, UCI, and DRMS (or UCI, DMRS, and UCI), may be defined, and the UE may transmit the new PUCCH format.

In relation to the above-described methods related to the PUSCH or the PUCCH, the UE may not expect that the RE scheduled for PUSCH DMRS or PUCCH DMRS transmission and the UE muting resource overlap each other. Since the DMRS is a signal for channel estimation, and thus to give no impact to channel decoding at the base station, the UE may not expect that the base station configures or indicates overlapping between a PUCCH DMRS resource or a PUCCH DMRS resource and the UL muting resource.

### UL Muting: PHY Priority

An NR system may provide different types of services to one UE. For example, one UE may simultaneously receive an enhanced mobile broadband (eMBB) service and an ultra-reliable low-latency communication (URLLC) service. Here, compared to the eMBB service, the URLLC service needs to be provided as an ultra-reliable low-latency service. To this end, a physical layer of an NR system has introduced a priority to a channel and a signal. For example, a priority indicator value may be indicated as “0” to a channel and a signal providing the eMBB service, and a priority indicator value may be indicated “1” to a channel and a signal providing the URLLC service. In the present disclosure, the channel and signal providing the eMBB service may be described as a low priority (LP) (or priority=0) channel/signal, and the channel and signal providing the URLLC service may be described as a high priority (HPP (or priority=1) channel/signal.

When transmitting or receiving each channel or signal, the UE may perform different operations according to the priority of the corresponding channel. For example, when a PUCCH carrying LP UCI (an LP PUCCH) and a PUCCH carrying HP UCI (an HP PUCCH) overlap each other in the same RE, the UE may transmit the HP PUCCH having a higher priority between the two PUCCHs, and may not transmit the LP PUCCH having a lower priority.

The UE operation according to the priority may be also applied to a case where a UL muting resource and an uplink channel/signal collide with each other.

i) In a situation where a semi-persistently configured UL muting resource and an uplink channel/signal collide with each other, the UE may always transmit an HP channel/signal, and may not transmit an LP channel/signal at all times. For URLLC traffic to be transmitted with low latency and ultra-reliability, uplink transmission may be prioritized over CLI measurement of the base station.

For example, in a situation in which a dynamically indicated UL muting resource and an uplink channel/signal collide with each other, the UE may always transmit the HP channel/signal. That is, the dynamically indicated UL muting may not be applied to the HP channel/signal.

A UE operation for an HP channel/signal in a situation in which a dynamically indicated UL muting resource and an uplink channel/signal collide with each other is described.

In a case where the UE does not indicate capability of partialCancellation to the base station, when a first symbol configured or indicated for PUSCH, PUCCH, or PRACH transmission is a symbol within T_{proc,2} from a last symbol of a CORESET in which a PDCCH including a DCI format indicating UL muting is detected, the UE may not be expected to cancel PUSCH, PUCCH, or PRACH transmission in a slot including the first symbol configured or indicated for PUSCH, PUCCH, or PRACH transmission. That is, the UE may transmit a PUSCH, PUCCH, or PRACH in the slot including the first symbol configured or indicated for PUSCH, PUCCH, or PRACH transmission. In this case, in order to apply UL muting to the PUSCH, PUCCH, or PRACH transmitted from the UE, the base station may allow the PDCCH including the DCI format indicating UL muting to be transmitted T_{proc,2} before the first symbol configured or indicated for PUSCH, PUCCH, or PRACH transmission, and when the first symbol indicated for PUSCH, PUCCH, or PRACH transmission is a symbol within T_{proc,2} from the last symbol of the CORESET in which the PDCCH including the DCI format indicating UL muting is detected, the UE may not apply UL muting to the PUSCH, PUCCH, or PRACH transmission in the slot including the first symbol indicated for PUSCH, PUCCH, or PRACH transmission.

In a case where the UE does not indicate capability of partialCancellation to the base station, when a first symbol configured or indicated for PUSCH, PUCCH, or PRACH transmission is a symbol T_{proc,2} after a last symbol of a CORESET in which a PDCCH including a DCI format indicating UL muting is detected, the UE may cancel the PUSCH, PUCCH, or PRACH transmission in a slot including the first symbol configured or indicated for PUSCH, PUCCH, or PRACH transmission.

In a case where the UE indicates capability of partialCancellation to the base station, when a symbol configured or indicated for PUSCH, PUCCH, or PRACH transmission is a symbol within T_{proc,2} from a last symbol of a CORESET in which a PDCCH including a DCI format indicating UL muting is detected, the UE may not be expected to cancel the PUSCH, PUCCH, or PRACH transmission for the symbol configured or indicated for PUSCH, PUCCH, or PRACH transmission. That is, the UE may transmit a PUSCH, PUCCH, or PRACH in the symbol configured or indicated for PUSCH, PUCCH, or PRACH transmission. In this case, in order to apply UL muting to the PUSCH, PUCCH, or PRACH transmitted from the UE, the base station may allow the PDCCH including the DCI format indicating UL muting to be transmitted T_{proc,2} before the symbol configured or indicated for PUSCH, PUCCH, or PRACH transmission, and when the symbol indicated for PUSCH, PUCCH, or PRACH transmission is a symbol within T_{proc,2} from the last symbol of the CORESET in which the PDCCH including the DCI format indicating UL muting is detected, the UE may not apply UL muting to the PUSCH, PUCCH, or PRACH transmission in the symbol indicated for PUSCH, PUCCH, or PRACH transmission.

In a case where the UE indicates capability of partialCancellation to the base station, when a symbol configured or indicated for PUSCH, PUCCH, or PRACH transmission is a symbol T_{proc,2} after a last symbol of a CORESET in which a PDCCH including a DCI format indicating UL muting is detected, the UE may cancel the PUSCH, PUCCH, or PRACH transmission for the symbol configured or indicated for PUSCH, PUCCH, or PRACH transmission.

When a symbol in which the UE is configured or indicated to transmit an SRS is a symbol within T_{proc,2} from a last symbol of a CORESET in which a PDCCH including a DCI format indicating UL muting is detected, the UE may not be expected to cancel the SRS transmission in the symbol configured or indicated for SRS transmission. That is, the UE may transmit the SRS in the symbol configured or indicated for SRS transmission. In this case, in order to apply UL muting to the SRS transmitted from the UE, the base station may allow the PDCCH including the DCI format indicating UL muting to be transmitted T_{proc,2} before the symbol configured or indicated for SRS transmission, and when the symbol indicated for SRS transmission is a symbol within T_{proc,2} from the last symbol of the CORESET in which the PDCCH including the DCI format indicating UL muting is detected, the UE may not apply UL muting to the SRS transmission in the symbol indicated for SRS transmission.

When the symbol configured or indicated for SRS transmission is a symbol T_{proc,2} after the last symbol of the CORESET in which the PDCCH including the DCI format indicating UL muting is detected, the UE may cancel the SRS transmission in the symbol configured or indicated for SRS transmission.

A UE operation for an LP channel/signal in a situation in which a dynamically indicated UL muting resource and an uplink channel/signal collide with each other is described.

In a situation in which the UE does not indicate capability of partialCancellation to the base station, when a first symbol configured or indicated for PUSCH, PUCCH, or PRACH transmission is a symbol within T_{proc,2} from a last symbol of a CORESET in which a PDCCH including a DCI format indicating UL muting is detected, the UE may not be expected to cancel the PUSCH, PUCCH, or PRACH transmission in a slot including the first symbol configured or indicated for PUSCH, PUCCH, or PRACH transmission. That is, the UE may transmit a PUSCH, PUCCH, or PRACH in the slot including the first symbol configured or indicated for PUSCH, PUCCH, or PRACH transmission. In this case, in order to apply UL muting to the PUSCH, PUCCH, or PRACH transmitted from the UE, the base station may allow the PDCCH including the DCI format indicating UL muting to be transmitted T_{proc,2} before the first symbol configured or indicated for PUSCH, PUCCH, or PRACH transmission, and when the first symbol indicated for PUSCH, PUCCH, or PRACH transmission is a symbol within T_{proc,2} from the last symbol of the CORESET in which the PDCCH including the DCI format indicating UL muting is detected, the UE may not apply UL muting to the PUSCH, PUCCH, or PRACH transmission in the slot including the first symbol indicated for PUSCH, PUCCH, or PRACH transmission.

In a case where the UE does not indicate capability of partialCancellation to the base station, when a first symbol configured or indicated for PUSCH, PUCCH, or PRACH transmission is a symbol T_{proc,2} after a last symbol of a CORESET in which a PDCCH including a DCI format indicating UL muting is detected, the UE may cancel the PUSCH, PUCCH, or PRACH transmission in a slot including the first symbol configured or indicated for PUSCH, PUCCH, or PRACH transmission.

In a case where the UE indicates capability of partialCancellation to the base station, when a symbol configured or indicated for PUSCH, PUCCH, or PRACH transmission is a symbol within T_{proc,2} from a last symbol of a CORESET in which a PDCCH including a DCI format indicating UL muting is detected, the UE may not be expected to cancel the PUSCH, PUCCH, or PRACH transmission for the symbol configured or indicated for PUSCH, PUCCH, or PRACH transmission. That is, the UE may transmit a PUSCH, PUCCH, or PRACH in the symbol configured or indicated for PUSCH, PUCCH, or PRACH transmission. In this case, in order to apply UL muting to the PUSCH, PUCCH, or PRACH transmitted from the UE, the base station may allow the PDCCH including the DCI format indicating UL muting to be transmitted T_{proc,2} before the symbol configured or indicated for PUSCH, PUCCH, or PRACH transmission, and when the symbol indicated for PUSCH, PUCCH, or PRACH transmission is a symbol within T_{proc,2} from the last symbol of the CORESET in which the PDCCH including the DCI format indicating UL muting is detected, the UE may not apply UL muting to the PUSCH, PUCCH, or PRACH transmission in the symbol indicated for PUSCH, PUCCH, or PRACH transmission.

In a case where the UE indicates capability of partialCancellation to the base station, when a symbol configured or indicated for PUSCH, PUCCH, or PRACH transmission is a symbol T_{proc,2} after a last symbol of a CORESET in which a PDCCH including a DCI format indicating UL muting is detected, the UE may cancel the PUSCH, PUCCH, or PRACH transmission for the symbol configured or indicated for PUSCH, PUCCH, or PRACH transmission.

When a symbol in which the UE is configured or indicated to transmit an SRS is a symbol within T_{proc,2} from a last symbol of a CORESET in which a PDCCH including a DCI format indicating UL muting is detected, the UE may not be expected to cancel SRS transmission in the symbol configured or indicated for SRS transmission. That is, the UE may transmit the SRS in the symbol configured or indicated for SRS transmission. In this case, in order to apply UL muting to the SRS transmitted from the UE, the base station may allow the PDCCH including the DCI format indicating UL muting to be transmitted T_{proc,2} before the symbol configured or indicated for SRS transmission, and when the symbol indicated for SRS transmission is a symbol within T_{proc,2} from the last symbol of the CORESET in which the PDCCH including the DCI format indicating UL muting is detected, the UE may not apply UL muting to the SRS transmission in the symbol indicated for SRS transmission.

When the symbol configured or indicated for SRS transmission is a symbol T_{proc,2} after the last symbol of the CORESET in which the PDCCH including the DCI format indicating UL muting is detected, the UE may cancel the SRS transmission in the symbol configured or indicated for SRS transmission.

ii) In a situation in which a semi-persistently configured UL muting resource and an uplink channel/signal collide with each other, the UE may always transmit an HP channel/signal, and may transmit a part or all of the LP channel/signal according to the methods described in the “UL muting: General” above, or may not transmit the LP channel/signal.

For example, when a resource overlapping with a semi-persistently configured UL muting resource is a resource scheduled with HP PUSCH transmission, the UE may always transmit an HP PUSCH, regardless of whether the resource is an RE to which a UCI type (e.g., HARQ-ACK, CSI part 1, or CSI part 2) or data is mapped.

When a resource overlapping with a semi-persistently configured UL muting resource is an RE to which HARQ-ACK is mapped among the REs scheduled for LP PUSCH transmission, the UE may transmit an LP PUSCH in the RE of the overlapping resource, and when the overlapping resource is an RE to which CSI part 1, CSI part 2, or data (e.g., UL-SCH) is mapped, the UE may not transmit the LP PUSCH in the RE of the overlapping resource. That is, the UE may rate-match the LP PUSCH in the RE of the overlapping resource and transmit the rate-matched LP PUSCH.

When a resource overlapping with a semi-persistently configured UL muting resource is a resource to which PUCCH format 1 is scheduled among the REs scheduled for LP PUSCH transmission, the UE may transmit an LP PUCCH in the symbol not overlapping with the UL muting resource, and may not transmit an LP PUSCH in the symbol overlapping with the UL muting resource.

In a situation in which a dynamically indicated UL muting resource and an uplink channel/signal collide with each other, the UE may always transmit an HP channel/signal. That is, the UE may not apply the dynamically indicated UL muting to the HP channel/signal.

A UE operation for an HP channel/signal in a situation in which a dynamically indicated UL muting resource and an uplink channel/signal collide with each other is described.

In a case where the UE does not indicate capability of partialCancellation to the base station, when a first symbol configured or indicated for PUSCH, PUCCH, or PRACH transmission is a symbol within T_{proc,2} from a last symbol of a CORESET in which a PDCCH including a DCI format indicating UL muting is detected, the UE may not be expected to cancel the PUSCH, PUCCH, or PRACH transmission in a slot including the first symbol configured or indicated for PUSCH, PUCCH, or PRACH transmission. That is, the UE may transmit a PUSCH, PUCCH, or PRACH in the slot including the first symbol configured or indicated for PUSCH, PUCCH, or PRACH transmission. In this case, in order to apply UL muting to the PUSCH, PUCCH, or PRACH transmitted from the UE, the base station may allow the PDCCH including the DCI format indicating UL muting to be transmitted T_{proc,2} before the first symbol configured or indicated for PUSCH, PUCCH, or PRACH transmission, and when the first symbol indicated for PUSCH, PUCCH, or PRACH transmission is a symbol within T_{proc,2} from the last symbol of the CORESET in which the PDCCH including the DCI format indicating UL muting is detected, the UE may not apply UL muting to the PUSCH, PUCCH, or PRACH transmission in the slot including the first symbol configured or indicated for PUSCH, PUCCH, or PRACH transmission.

In a case where the UE does not indicate capability of partialCancellation to the base station, when a first symbol configured or indicated for PUSCH, PUCCH, or PRACH transmission is a symbol T_{proc,2} after a last symbol of a CORESET in which a PDCCH including a DCI format indicating UL muting is detected, the UE may cancel the PUSCH, PUCCH, or PRACH transmission in a slot including the first symbol configured or indicated for PUSCH, PUCCH, or PRACH transmission.

In a case where the UE indicates capability of partialCancellation to the base station, when a symbol configured or indicated for PUSCH, PUCCH, or PRACH transmission is a symbol within T_{proc,2} from a last symbol of a CORESET in which a PDCCH including a DCI format indicating UL muting is detected, the UE may not be expected to cancel the PUSCH, PUCCH, or PRACH transmission for the symbol configured or indicated for PUSCH, PUCCH, or PRACH transmission. That is, the UE may transmit a PUSCH, PUCCH, or PRACH for the symbol configured or indicated for PUSCH, PUCCH, or PRACH transmission. In this case, in order to apply UL muting to the PUSCH, PUCCH, or PRACH transmitted from the UE, the base station may allow the PDCCH including the DCI format indicating UL muting to be transmitted T_{proc,2} before the symbol configured or indicated for PUSCH, PUCCH, or PRACH transmission, and when the symbol indicated for PUSCH, PUCCH, or PRACH transmission is a symbol within T_{proc,2} from the last symbol of the CORESET in which the PDCCH including the DCI format indicating UL muting is detected, the UE may not apply UL muting to the PUSCH, PUCCH, or PRACH in the symbol indicated for PUSCH, PUCCH, or PRACH transmission.

In a case where the UE indicates capability of partialCancellation, when a symbol configured or indicated for PUSCH, PUCCH, or PRACH transmission is a symbol T_{proc,2} after a last symbol of a CORESET in which a PDCCH including a DCI format indicating UL muting is detected, the UE may cancel the PUSCH, PUCCH, or PRACH transmission for the symbol configured or indicated for PUSCH, PUCCH, or PRACH transmission.

In a case where a symbol in which the UE is configured or indicated to transmit an SRS is a symbol with T_{proc,2} from a last symbol of a CORESET in which a PDCCH including a DCI format indicating UL muting is detected, the UE may not be expected to cancel SRS transmission in the symbol configured or indicated for SRS transmission. That is, the termina may transmit an SRS in the symbol configured or indicated for SRS transmission. In this case, in order to apply UL muting to the SRS transmitted from the UE, the base station may allow the PDCCH including the DCI format indicating UL muting to be transmitted T_{proc,2} before the symbol configured or indicated for SRS transmission, and when the symbol indicated for SRS transmission is a symbol within T_{proc,2} from the last symbol of the CORESET in which the PDCCH including the DCI format indicating UL muting is detected, the UE may not apply UL muting to the SRS transmission in the symbol indicated for SRS transmission.

When a symbol configured or indicated for SRS transmission is a symbol T_{proc,2} after a last symbol of a COREST in which a PDCCH including a DCI format indicating UL muting is detected, the UE may cancel the SRS transmission in the symbol configured or indicated for SRS transmission.

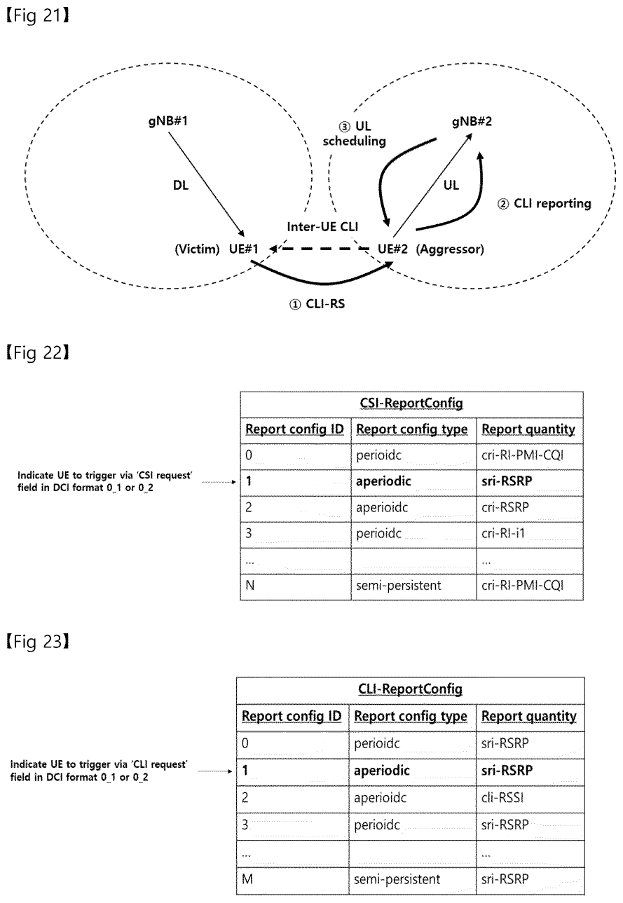

FIG. 21 illustrates an uplink transmission method of a UE for mitigation of inter-gNB CLI.

a. CLI-RS Measurement

Referring to FIG. 21, in order to mitigate inter-gNB CLI from UE #2 to UE #1, UE #2 may be configured, by gNB #2, to measure a pathloss from UE #1 through a cross link interference-reference signal (CLI-RS) transmitted from UE #1. Here, the CLI-RS transmitted from UE #1 may be a sounding reference signal (SRS) transmitted from UE #1.

The information configured for UE #2 by gNB #2 to receive the SRS transmitted by UE #1 may include SRS resource configuration information of UE #1, a reference service cell index for receiving the SRS transmitted by UE #1, a reference DL BWP ID for receiving the SRS transmitted by UE #1, and a reference SCS for receiving the SRS transmitted by UE #1.

UE #2 may measure, based on the configured information, reference signal received power (RSRP) of the SRS transmitted by UE #1 so as to measure inter-UE CLI.

The CLI-RS transmitted from UE #1 may be an unspecified uplink signal/channel rather than the SRS. In this case, UE #2 may be configured, by gNB #2, to measure the strength (a received signal strength indicator) of a signal/channel received by UE #2 in a specific time/frequency domain resource, and measure inter-UE CLI through the configuration.

b. CLI-RS Reporting

UE #2 may report a result of the above-described inter-UE CLI measurement to gNB #2. UE #2 may be configured with configuration for reporting the CLI measurement result to gNB #2 from gNB #2. Hereinafter, the configuration information configured for UE #2 by gNB #2 is described.

UE #2 may be jointly configured with configuration information for channel state information (CSI) reporting and configuration information for CLI reporting from gNB #2. UE #2 may be configured with configuration information for CLI reporting as one of pieces of configuration information for CSI reporting (CSI-ReportConfig). Here, the configuration information for CSI reporting is information that a base station configures for a UE so that the UE measures and reports a downlink channel state, and may include a report config ID, a report type, and a report quantity. The report type may be periodic, semi-persistent, or aperiodic. In this case, the report quantity may include cri-RI-PMI-CQI, cri-RSRP, etc. In addition to the configuration information for CSI reporting, the UE may receive the configuration information including the report config ID, report type, and report quantity from the base station for inter-UE CLI measurement and reporting. In this case, the report quantity may include sri-RSRP or cli-RSSI. Here, sri-RSRP may include an SRS resource indicator (SRI) including SRS configuration information of UE #1, measured by UE #2, and an SRS-RSRP value. Here, cli-RSSI may include specific time/frequency domain resource information configured from gNB #2 to enable UE #2 to measure CLI, and an RSSI value of a specific signal/channel, measured in the corresponding resource. UE #2 may be configured with up to N (e.g., 48) pieces of CSI report configuration information.

When receiving configuration of the report type as “periodic”, UE #2 may receive configuration of a specific slot offset and period for periodic CSI/CLI reporting, and may perform periodic CSI/CLI reporting through a PUCCH, based on the configured separate slot offset and period. When receiving configuration of the report type as “semi-persistent” and receiving a medium access control (MAC) control element (CE) triggering semi-persistent CSI/CLI reporting through a PDSCH, UE #2 may perform semi-persistent CSI/CLI reporting through a PUCCH or a PUSCH according to the configured separate slot offset and period. When receiving configuration of the report type as “aperiodic” and receiving information indicating triggering of aperiodic CSI/CLI reporting in a “CSI request” field of DCI format 0_1 or 0_2 within the PDCCH, UE #2 may transmit an aperiodic CSI/CLI report through a PUSCH scheduled in the corresponding DCI format.

FIG. 22 illustrates configuration information for CSI reporting according to an embodiment of the present disclosure.

Referring to FIG. 22, UE #2 may receive, from gNB #2, configuration of report config ID=1, report config type=aperiodic, report quantity=sri-RSRP through configuration information for CSI reporting for inter-UE CLI measurement and reporting. When receiving a PDCCH including DCI format 0_1 or 0_2 from gNB #2 and receiving indication for triggering report config ID=1 in a “CSI request” field within a DCI format, UE #2 may transmit sri-RSRP, i.e., inter-UE CLI reporting information measured from UE #1, to gNB #2 through a PUSCH scheduled in the DCI format.

The inter-UE CLI measurement and reporting of UE #2 is irrelevant to the conventional uplink channel state measurement and reporting, but when UE #2 is configured to perform CLI measurement and reporting through a specific report config ID by gNB #2, UE #2 and gNB #2 can identify, without ambiguity, that UE #2 will include an inter-UE CLI report, through the report config ID. This may be a method enabling CLI measurement and reporting without additional signaling overhead.

UE #2 may receive, from gNB #2, configuration for CLI reporting separately from configuration for CSI reporting. The configuration information (CLI-ReportConfig) for CLI reporting, received by UE #2, may include a report config ID, a report config type (periodic, semi-persistent, or aperiodic), and a report quantity (e.g., sri-RSRP or cli-RSSI). UE #2 may receive up to M (e.g., 48) pieces of CLI report configuration information.

When receiving configuration of the report type as “periodic”, UE #2 may receive configuration of a separate slot offset and period for periodic CLI reporting, and may perform periodic CLI reporting through a PUCCH, based on the configured separate slot offset and period. When receiving configuration of the report type as “semi-persistent” and receiving a medium access control (MAC) control element (CE) triggering semi-persistent CLI reporting through a PDSCH, UE #2 may perform semi-persistent CSI/CLI reporting through a PUCCH or a PUSCH according to the configured separate slot offset and period. When receiving configuration of the report type as “aperiodic” and receiving information indicating triggering of aperiodic CSI/CLI reporting in a “CSI request” field of DCI format 0_1 or 0_2 within the PDCCH, UE #2 may transmit an aperiodic CLI report through a PUSCH scheduled in the corresponding DCI format.

FIG. 23 illustrates configuration information for CLI reporting according to an embodiment of the present disclosure.

Referring to FIG. 23, UE #2 may receive configuration of report config ID=1, report config type=aperiodic, and report quantity=sri-RSRP through CLI configuration information (CLI-ReportConfig) for inter-UE CLI measurement and reporting from gNB #2. When receiving, from gNB #2, a PDCCH including DCI format 0_1 or 0_2 and an indication for triggering report config ID=1 in a “CLI request” field within a DCI format, UE #2 may transmit sri-RSRP, i.e., inter-UE CLI reporting information measured from UE #1, through a PUSCH scheduled in the DCI format.

The configuration information for CLI reporting is separately configured only for CLI measurement and reporting of UE #2, and thus additional signal overhead may occur. That is, UE #2 may receive both configuration information for CSI reporting and configuration information for CLI reporting from gNB #2, and may perform each of the CSI reporting and the CLI reporting independently according to each configured information.

c. UL Scheduling

gNB #2 may configure or indicate, for or to UE #2, uplink scheduling information for mitigating inter-UE CLI, based on the inter-UE CLI reporting received from UE #2 through the above-described methods a and b.

UE #2 may receive again configuration and indication of a UL power control parameter set from gNB #2. In other words, gNB #2 may semi-persistently configure (indicate), through RRC signaling, a UL power control parameter set of UE #2 for mitigating inter-UE CLI, based on the inter-UE CLI reporting received from UE #2 through the above-described methods a and b, or dynamically configure the UL power control parameter set via DCI format 0_0, 0_1, 0_2, 2_2, or 2_3.

For example, when gNB #2 determines, based on the inter-UE CLI reporting received from UE #2, that CLI between UE #1 and UE #2 is high, UE #2 may be configured or indicated, through a parameter set indicating lower UL power, to transmit an uplink signal/channel. Accordingly, by reducing UL power of UE #2 corresponding to an aggressor UE, inter-UE CLI for downlink reception of UE #1 corresponding to a victim UE can be mitigated.

In order to improve coverage of an uplink channel, a UE may transmit DMRSs between different PUSCH repetitions or different PUCCH repetitions so as to be used by a base station for joint channel estimation.

Hereinafter, PUCCH repetition reception in a base station by using separate channel estimation is described.

For example, a DMRS of a first PUCCH repetition and a DMRS of a second PUCCH repetition may be transmitted in different symbols. That is, the DMRS of the first PUCCH repetition may be transmitted in a first symbol among the symbols in which a first PUCCH is scheduled, and the DMRS of the second PUCCH repetition may be transmitted in a second symbol among the symbols in which a second PUCCH is scheduled. The base station may perform channel estimation by using the DMRS received in the first symbol in order to perform decoding of the first PUCCH repetition. In addition, the base station may perform channel estimation by using the DMRS received in the second symbol in order to perform decoding of the second PUCCH repetition.

In repetition reception of a PUCCH by a base station by using individual channel estimation, channel estimation is performed using respective DMRSs transmitted from different symbols, and each PUCCH repetition can be decoded using the estimated value. A channel estimation method for improving the individual channel estimation is described.

For example, a DMRS of a first PUCCH repetition and a DMRS of a second PUCCH repetition may be transmitted in different symbols. That is, the DMRS of the first PUCCH repetition may be transmitted in a first symbol among the symbols in which a first PUCCH is scheduled, and the DMRS of the second PUCCH repetition may be transmitted in a second symbol among the symbols in which a second PUCCH is scheduled. For joint channel estimation, the DMRSs transmitted in different PUCCH repetitions need to satisfy phase continuity. For example, the DMRSs transmitted in different PUCCH repetitions need to satisfy at least one of (i) the same beamforming, ii) the same quasi-co-locate (QCL), and iii) the same transmission power. When the condition is satisfied, the base station may perform joint channel estimation by using the DMRS received in the first symbol and the DMRS received in the second symbol in order to decode the first PUCCH repetition and the second PUCCH repetition. In addition, the base station may receive the first PUCCH repetition and the second PUCCH repetition, based on the joint channel estimation value.

The same/similar joint channel estimation is applicable to a PUSCH. A PUSCH to which joint channel estimation is available is described.

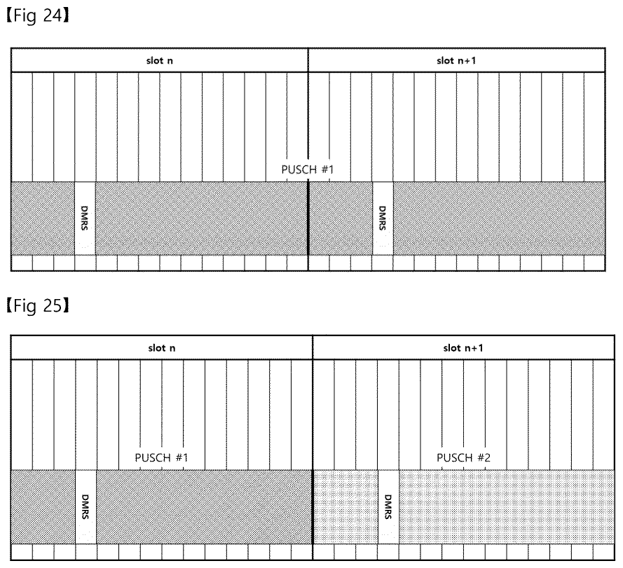

FIG. 24 illustrates a PUSCH scheduling method in which a transport block size is determined with reference to multiple slots according to an embodiment of the present disclosure.
A PUSCH for which joint channel estimation is available may be a PUSCH including one transport block (TB). In this case, a transport block size (TBS) may be determined with reference to multiple slots and the PUSCH may be transmitted (TB processing over multiple slots). For example, referring to FIG. 24, for PUSCH #1, the UE may determine one TBS for two slots including slot n and slot n+1. In this case, a DMRS symbol is transmitted in different slots (slot n and slot n+1), but when the DMRS symbol satisfies a joint channel condition over different slots, joint channel estimation at the bae station may be possible. Even when the TBS is determined with reference to multiple slots, repetition transmission of the PUSCH can be applied.

FIG. 25 illustrates a method of scheduling a PUSCH for which a transport block size is determined with reference to a single slot according to an embodiment of the present disclosure.
A PUSCH for which joint channel estimation is available may correspond to a PUSCH repetition including one TB. Here, for the PUSCH, a TBS is determined with reference to a single slot, and the PUSCH may be repeatedly transmitted in multiple slots (PUSCH repetition transmission type A or PUSCH repetition transmission type B). For example, the UE may transmit PUSCH repetition 1 in slot n and PUSCH repetition 2 in slot n+1. In this case, when DMRS symbols are transmitted in different slots (slot n and slot n+1) but the DMRS symbols satisfy a joint channel estimation condition over different slots, joint channel estimation at the base station may be possible. Here, the PUSCHs may be PUSCHs including different TBs. Here, the PUSCHs may be scheduled or activated by different pieces of DCI. Alternatively, the PUSCHs may be PUSCHs scheduled or activated by a single piece of DCI and including different TBs. For example, referring to FIG. 18, the UE may be indicated to transmit PUSCH #1 in slot n and PUSCH #2 in slot n+1 from the base station. In this case, PUSCH #1 and PUSCH #2 may be scheduled via different pieces of DCI. PUSCH #1 and PUSCH #2 are transmitted in different slots and DMRS symbols thereof are also transmitted in different slots (slot n and slot n+1), but when the DMRS symbols satisfy a joint channel estimation condition in slot n/n+1, joint channel estimation at the base station may be possible.

For joint channel estimation for an uplink channel (e.g., PUCCH or PUSCH), the UE needs to transmit a DMRS to satisfy a joint channel estimation condition. A joint channel estimation condition, i.e., a condition enabling joint channel estimation may be as follows.

1) Same starting PRB index: PRB starting positions of DMRSs between PUCCHs or PUSCHs need to be the same in the frequency domain. 2) Same number of PRBs: The number of PRBs of DMRSs between PUCCHs or PUSCHs need to be the same in the frequency domain. 3) Phase continuity: The DMRSs between PUCCHs or PUSCHs need to maintain the phase continuity (e.g., the same phase). 4) Same beamforming: The DMRSs between PUCCHs or PUSCHs need to satisfy the same beamforming. 5) Same transmit power (or, Power consistency): The UE needs to transmit DMRSs between PUCCHs or PUSCHs at the same transmission power. 6) Same quasi-co-location (QCL): The DMRSs between PUCCHs or PUSCHs need to satisfy the same QCL.

The starting PRB, the number of PRBs, the beamforming, and the QCL may be maintained constantly during uplink channel transmissions, based on higher-layer configuration information or scheduling information received from the base station. The starting PRB may vary in a slot or over slots according to whether frequency hopping is applied. The phase of DMRS may vary in units of slots/symbols, based on a slot/symbol index. The transmission power of the DMRS may vary in units of slots, based on high-layer configuration information and/or a power control command. The starting PRB, the number of PRBs, and the like may be included in the condition required to be satisfied to maintain the phase continuity and power uniformity/consistency. Accordingly, unless described otherwise in the present disclosure, when the UE satisfies a joint channel estimation condition, it may mean that DMRS basically operate in multiple slots to satisfy 3) and 5).

The UE may be configured with a specific time domain window (TDW) for PUSCH or PUCCH transmission from the base station to satisfy the joint channel estimation condition. Here, in the TDW, the above-described (1) PUCCH or PUSCH repetition in multiple slots and (2) a PUSCH including one TB in multiple slots. The UE may determine, based on information received from the base station, the TDW to be applied to PUCCH or PUSCH transmission.

First, the UE may be configured, from the base station, with “enable” for an operation of transmitting a PUSCH or a PUCCH to satisfy the joint channel estimation condition. In addition, the UE may configured with a nominal TDW length from the base station. Here, the nominal TDW length may be applied to slots that are consecutive in the time domain. In addition, the nominal TDW length may not exceed a maximum duration satisfying the joint channel estimation condition according to capability of the UE. The UE may apply the nominal TDW length configured from a slot configured or indicated for PUSCH or PUCCH transmission from the base station. When the number of slots to which a single nominal TDW is applied is less than the number of slots for PUSCH or PUCCH transmission, the UE may determine, as a new nominal TDW, consecutive slots from the most preceding slot after the previous slot in which the nominal TDW ends.

The UE may determine again the determined nominal TDW as one or multiple actual TDWs. That is, one nominal TDW may be divided into one or multiple actual TDWs. The UE may determine, as the same actual TDW, only symbols in which actual PUSCH or PUCCH transmission is performed within a nominal TDW in units of slots. In addition, when a situation in which power consistency and phase continuity are not satisfied occurs, the UE may divide the nominal TDW into different actual TDWs with reference to a time point at which the situation occurs. The situation in which power consistency and phase continuity are not satisfied may be as follow.
A case where a downlink slot or downlink reception or downlink monitoring based on tdd-UL-DL-ConfigurationCommon and tdd-UL-DL-ConfigurationDedicated for unpaired spectrum
A case where the gap between any two consecutive PUSCH transmissions, or the gap between any two consecutive PUCCH transmissions, exceeds 13 symbols for normal cyclic prefix or exceeds 11 symbols for extended cyclic prefix

A case where the gap between any two consecutive PUSCH transmissions, or the gap between any two consecutive PUCCH transmissions, does not exceed 13 symbols but other uplink transmissions are scheduled between the two consecutive PUSCH transmissions or the two consecutive PUCCH transmissions.

For PUSCH transmissions of PUSCH repetition type A, or PUSCH repetition type B or TB processing over multiple slots, a dropping or cancellation of a PUSCH transmission according to clause 9, clause 11.1 and clause 11.2A of [6, TS 38.213]
For PUCCH transmissions of PUCCH repetition, a dropping or cancellation of a PUCCH transmission according to clause 9, clause 9.2.6 and clause 11.1 of [6, TS 38.213]
A case where for any two consecutive PUSCH transmissions of PUSCH repetition type A, or PUSCH repetition type B, two SRS resource sets are configured in srs-ResourceSetToAddModList or srs-ResourceSetToAddModListDCI-0-2 with higher layer parameter usage in SRS-ResourceSet set to “codebook” or “noncodebook”, a different SRS resource set association is used for the two PUSCH transmissions of PUSCH repetition type A, or PUSCH repetition type B, according to Clause 6.1.2.1
A case where for any two consecutive PUCCH transmissions of PUCCH repetition, a PUCCH resource used for repetitions of a PUCCH transmission by a UE includes first and second spatial relations or first and second sets of power control parameters, as described in [10, TS 38.321] and in clause 7.2.1 of [6, TS 38.213], different spatial relations or different power control parameters are used for the two PUCCH transmissions of PUCCH repetition, according to Clause 9.2.6 of [6, TS 38.213]
A case of uplink timing adjustment in response to a timing advance command according to clause 4.2 of [6, TS 38.213], wherein the case of uplink timing adjustment may include i) a case of frequency hopping, ii) a case for reduced capability half-duplex UEs, iii) a case of a dropping or cancellation of a PUSCH or PUCCH transmission according to clause 17.2 of [6, TS 38.213], and iv) a case of an overlapping of the gap between two consecutive PUSCH or two consecutive PUCCH transmissions and any symbol of downlink reception or downlink monitoring

### Spectrum Partitioning

The UE may perform downlink reception or uplink transmission in a resource scheduled from the base station. A resource scheduled for PDSCH reception of a first UE and a resource scheduled for PUSCH for a second UE may include the same symbol in the time domain, but may have different RBs in the frequency domain. A method in which a single base station schedules a specific time domain resource for multiple UEs so as to be used for both downlink reception and uplink transmission may be inefficient in consideration of inter-cell interference, spectrum regulation, and power consumption for PDCCH monitoring of the UE. Hereinafter, a method for solving this inefficient situation is described. A subband in the present disclosure may be configured on a frequency domain resource within a time domain resource (slot or symbol). In this case, the frequency domain resource may be included in a carrier bandwidth of the UE.

The UE may receive, from the base station, configuration of a specific time domain resource (cell-specific flexible slot/symbol) which can be used for both downlink reception and uplink transmission in the form of multiple subbands in the frequency band. The multiple subbands may be subbands having the same or different formats. The format of subband may include a downlink subband, an uplink subband, and a flexible subband. The downlink subband may include one or more downlink RBs, the uplink subband may include one or more uplink RBs, and the flexible subband may include one or more flexible RBs, the downlink RBs may indicate resources available for downlink reception, and the uplink RBs may indicate resources available for uplink transmission. The flexible RBs may indicate resources available for downlink reception and uplink transmission according to the configuration of the base station.

(Method X-1) When the UE receives configuration of multiple subbands, a maximum number of subbands having the same format may be 1. That is, one cell-specific flexible slot/symbol duration may include up to one each of the downlink subband, the uplink subband, or the flexible subband. The cell-specific flexible slot/symbol may include multiple subbands. In this case, the multiple subbands may include one each of the downlink subband, the uplink subband, and the flexible subband. A guard band may be required to minimize the influence due to UL/DL interference between the downlink subband and the uplink subband. The number of subbands having the same format is limited to one in order to configure the downlink subband, uplink subband, and flexible subband by minimizing the number of guard bands, thereby increasing the efficiency of the frequency resource during downlink reception and uplink transmission.

(Method X-2) In addition, when the UE receives configuration of multiple subbands, there may be multiple subbands having the same format. That is, in one cell-specific flexible slot/symbol duration, the number of one or more of the downlink subbands, the uplink subbands, and the flexible subbands may be greater than one. The cell-specific flexible slot/symbol may include multiple subbands. In this case, the multiple subbands may include one downlink subband, two uplink subbands, and two flexible subbands.

The multiple subbands in methods X-1 and X-2 may include non-overlapping RBs.

In methods 1-1 and 1-2, the flexible subband may be configured in consideration of a guard band between the uplink subband and the downlink subband. That is, at least one flexible subband may exist between the uplink subband and the downlink subband. Compared to method X-2, method X-1 may require a smaller number of guard bands. Accordingly, there may be more resources available for downlink reception and uplink transmission. In addition, compared to method 1-2, in method 1-1, more frequency resources are available when a CORESET resource for PDCCH monitoring is configured for the UE, and thus the CORESET may be flexibly configured within one downlink subband (or flexible subband). In addition, compared to method X-2, in method X-1, there may be more frequency domain resources available for uplink transmission. Accordingly, compared to method X-2, method X-1 can be more advantageous in terms of efficiency in using frequency resources. Hereinafter, the methods described below in the present disclosure are based on method X-1, but are not limited thereto. In the present disclosure, an RB in a downlink subband may be referred to as a downlink RB, an RB in an uplink subband may be referred to as an uplink RB, and an RB in a flexible subband may be referred to as a flexible RB.

A method of receiving configuration of multiple subbands in the frequency domain may be applied to not only a cell-specific flexible slot or symbol, but also a cell-specific downlink slot or symbol or a cell-specific uplink slot or symbol. Accordingly, the UE may receive configuration of multiple subbands in the frequency domain for the cell-specific downlink slot or symbol and the cell-specific flexible slot or symbol. Alternatively, the UE may receive configuration of multiple subbands in the frequency domain for the cell-specific uplink slot or symbol and the cell-specific flexible slot or symbol.

The method of receiving configuration of multiple subbands in the frequency domain may be applied to a UE-specific flexible slot or symbol. In addition, the method for receiving configuration of multiple subbands may be applied to a UE-specific downlink slot or symbol.

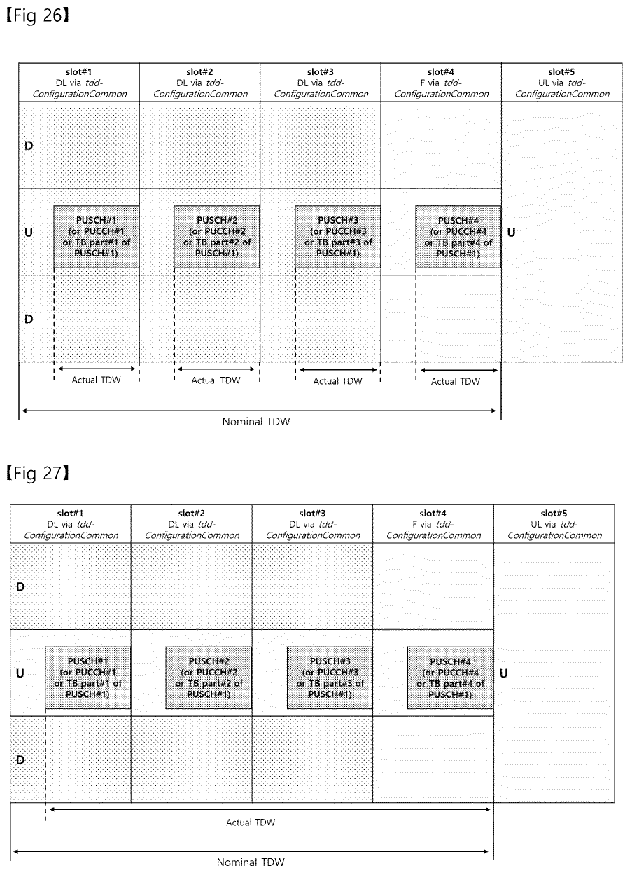

FIGS. 26 to 28 illustrate a method of determining an actual time domain window (TDW) of a UE in a slot operating as a subband according to an embodiment of the present disclosure.

An uplink channel in FIGS. 26 to 28 may correspond to repetition transmission of PUSCH, repetition transmission of PUCCH, and PUSCH transmission for which one TBS is determined with reference to multiple slots (TB processing over multiple slots PUSCH). That is, PUSCH #1 to PUSCH #4 in FIGS. 26 to 28 may correspond to a first repetition transmission of PUSCH to a fourth repetition transmission of PUSCH, PUCCH #1 to PUCCH #4 may correspond to a first repetition transmission of PUCCH to a fourth repetition transmission of PUCCH, and TB part #1 of PUSCH #1 and TB part #4 of PUSCH #1 may correspond to PUSCH transmissions for which one TBS is determined with reference to four slots.

Referring to FIG. 26, the UE may receive, from the base station, configuration or indication of four repetition transmissions of a PUSCH in slot #1 to slot #4 configured and operating as a subband. In addition, the UE may receive, from the base station, configuration of “enable” for the operation of transmitting a PUSCH or PUCCH to satisfy the joint channel estimation condition, and may receive configuration of a nominal TDW length as four slots. In this case, the UE determines four repetition transmissions of PUSCH as one nominal TDW, but receives configuration that slot #1 to slot #3 are downlink slots from the base station via tdd-UL-DL-ConfigurationCommon, and thus power consistency and phase continuity may thus fail to be satisfied. Accordingly, the UE may divide slot #1, slot #2, and slot #3 with different actual TDWs, respectively. This is because even though the UE determines consecutive slot #1 to slot #4 as one nominal TDW, repeatedly transmitted PUSCHs need to be determined as different actual TDWs in the downlink slot operating as a subband, and thus the base station needs to perform individual channel estimation for PUSCH transmission of each slot. Accordingly, it may be difficult to improve uplink coverage through the joint channel estimation.

Downlink slots and flexible slots or symbols which include at least uplink subband and uplink slots or symbols may be consecutively configured in the time axis. In this case, to enhance the performance of uplink transmission through joint channel estimation of the uplink channel, the UE may transmit the uplink channel to satisfy power consistency and phase continuity between slots or symbols for transmission of uplink channels, and may configure transmission of the uplink channel in the multiple slots as an actual TDW in the nominal TDW configured by the base station.

Referring to FIG. 27, uplink channel transmission may be configured or indicated only in a slot including subbands, and when the UE transmits an uplink channel, the UE may determine an actual TDW.

For example, referring to FIG. 27, the UE may receive, from the base station, configuration or indication of four repetition transmissions of a PUSCH in slot #1 to slot #4 configured and operating as subbands. In addition, the UE may receive, from the base station, configuration of “enable” for the operation of transmitting a PUSCH or PUCCH to satisfy the joint channel estimation condition, and may receive configuration of a nominal TDW length as four slots. In this case, when a resource for PUSCH or PUCCH transmission is included in a downlink subband or guard band in a downlink slot configured by the base station via tdd-UL-DL-ConfigurationCommon, the UE may divide the nominal TDW into actual TDWs. In other words, when a resource for PUSCH or PUCCH transmission is included in an uplink subband in the downlink slot configured by the base station via tdd-UL-DL-ConfigurationCommon, the UE may not divide the downlink slot into actual TDWs. Accordingly, the UE may determine four repetition transmissions of PUSCH in slot #1 to slot #4 as one actual TDW, and may perform repetition transmission of PUSCH by satisfying power consistency and phase continuity for four repetition transmission of PUSCH within the actual TDW. Even in the downlink slot, if the downlink slot is a slot for which the UE receives configuration as a subband and which operates as a subband, power consistency and phase continuity between uplink transmissions can be satisfied in the uplink subband. The UE may determine PUSCH or PUCCH transmission in multiple slots as the same actual TDW so as to enhance uplink coverage through the joint channel estimation in the base station.

The PUSCH or PUCCH transmission may be scheduled on a slot configured and operating as a subband and a slot not operating as a subband. In addition, When receiving, from the base station, configuration of “enable” for the operation of transmitting the PUSCH or PUCCH to satisfy the joint channel estimation condition, the UE may determine the configured slots as the same actual TDW.

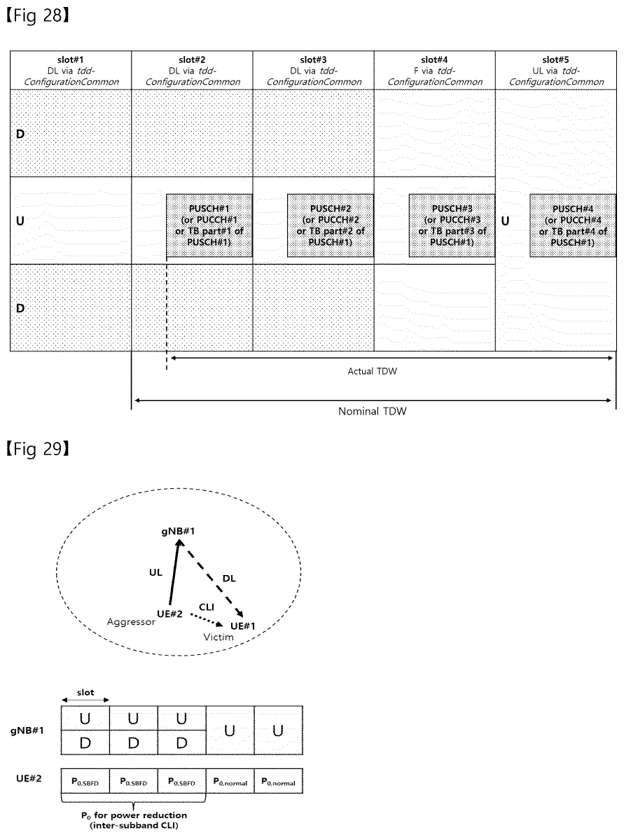

Referring to FIG. 28, uplink channel transmission may be configured or indicated on a slot configured and operating as an uplink subband and a slot not operating as an uplink subband. Specifically, FIG. 28 illustrates a method of determining an actual TDW of the UE when the UE transmits an uplink channel.

Referring to FIG. 28, the UE may be configured or indicated to transmit four repetition transmissions of PUSCH in slot #2 to slot #4 corresponding to slots operating as a subband and slot 5 corresponding to a slot not operating as a subband. In addition, the UE may receive, from the base station, configuration of “enable” for an operation of transmitting a PUSCH or PUCCH to satisfy a joint channel estimation condition, and may receive configuration of a nominal TDW length as four slots. In this case, the UE may determine four repetition transmission of PUSCH in slot #2 to slot #5 as one actual TDW, and may perform repetition transmission of PUSCH to satisfy power consistency and phase continuity for the four repetition transmission of PUSCH in the actual TDW. According to the method described through FIG. 28, when a scheduled resource is available for uplink transmission regardless of whether multiple slots for PUSCH or PUCCH transmission operate as subbands, power consistency and phase continuity between uplink transmissions can be satisfied. Accordingly, the UE may determine PUSCH or PUSCH transmission in multiple slots as the same actual TDW and enhance the uplink coverage through the joint channel estimation in the base station.

FIG. 29 illustrates a method of configuring or indicating uplink power of a UE to mitigate CLI between subbands according to an embodiment of the present disclosure.

Referring to FIG. 29, when UE #1 and UE #2 operating as subbands coexist in the same cell, UE #1 may perform downlink reception from base station #1 in a slot or a symbol operating as a subband, and UE 2 may perform uplink transmission to base station #1 in a slot or a symbol operating as a subband. In this case, when the downlink reception of UE #1 and the uplink transmission of UE #2 are performed in the same slot or symbol, the uplink transmission of UE #2 may cause cross link interference (CLI) with the downlink reception of UE #1. As an embodiment for solving this problem, UE #2 may perform uplink transmission in the slot or symbol operating as a subband at lower uplink power than the slot or symbol not operating as a subband. In this case, UE #2 may receive, from gNB #1, configuration or indication of information indicating that uplink transmission is performed at lower uplink power. In FIG. 29, when the three preceding slots operate as subbands and the two subsequent slots do not operate as subbands among the five slots, UE #2 may receive configuration or indication of uplink power in the three preceding slots as P_{0,SBFD}, and receive configuration of indication of uplink power in the subsequent two slots as P_{0,normal}. Here, P_{0,SBFD} may be smaller than P_{0,normal}.

In the TDD or unpaired spectrum, the UE may receive configuration or indication of a dynamic and flexible slot format. In this case, UEs between neighboring cells may receive configuration or indication of different slot formats. In this case, CLI may occur due to transmission and reception in different slot formats (DL/UL) between neighboring cells.

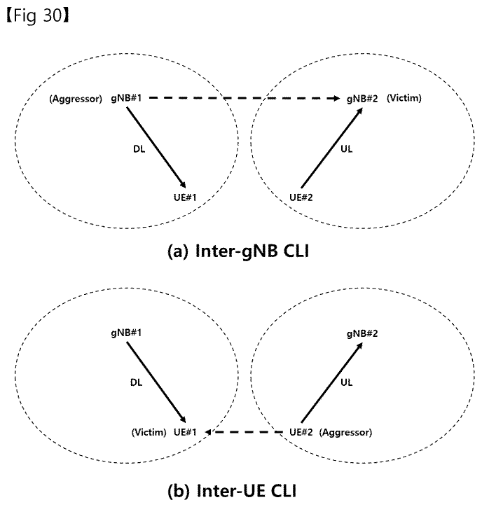

FIG. 30 illustrates inter-gNB CLI and inter-UE CLI according to an embodiment of the present disclosure.

Referring to FIG. 30(a), downlink transmission of gNB #1 (toward UE #1) may cause interference with uplink reception of neighboring gNB #2 (from UE #2), and this may be referred as inter-gNB CLI. Here, gNB #1 causing the interference may be referred to as an aggressor gNB, and gNB #2 receiving the interference may be referred to as a victim gNB. Referring to FIG. 30(b), uplink transmission of UE #2 (toward gNB #2) may cause interference with downlink reception of neighboring UE #1 (from gNB #1), and this may be referred to as inter-UE CLI. Here, UE #2 causing the interference may be referred to as an aggressor UE, and UE #1 receiving the interference may be referred to as a victim UE.

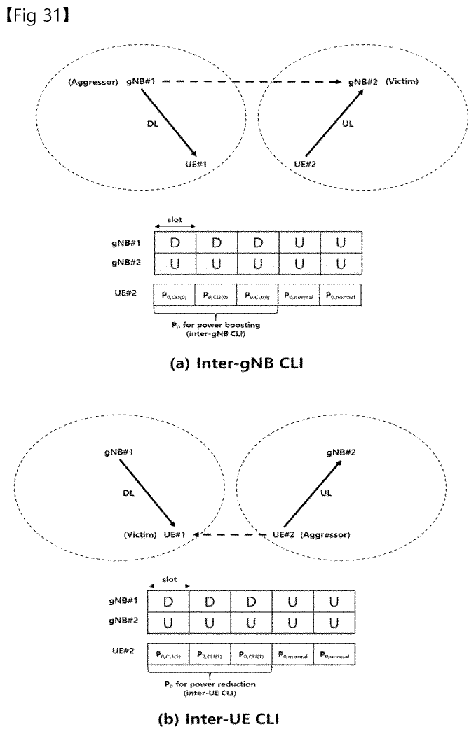

FIG. 31 illustrates a method of configuring or indicating uplink power of a UE to mitigate inter-gNB CLI and inter-UE CLI according to an embodiment of the present disclosure.

Referring to FIG. 31, in the TDD or unpaired spectrum, UE #1 and UE #2 which may receive configuration or indication of a dynamic and flexible slot format may be positioned in neighboring cells, UE #1 may perform downlink reception from gNB #1, and UE #2 may perform uplink transmission to gNB #2.

Referring to FIG. 31(a), when downlink transmission of gNB #1 and uplink reception of gNB #2 are performed in the same slot or symbol, downlink transmission of gNB #1 may cause inter-gNB CLI with uplink reception of gNB #2. As an embodiment for solving this problem, UE #2 performing uplink transmission to gNB #2 may be configured or indicated from gNB #2 to perform uplink transmission at higher power in the slot or symbol in which downlink transmission of gNB #1 and uplink reception of gNB #2 are simultaneously performed, compared to a slot or symbol in which downlink transmission of gNB #1 and uplink reception of gNB #2 are not simultaneously performed. In FIG. 31(a), uplink power of UE #2 in the three preceding slots in which downlink transmission of gNB #1 and uplink reception of gNB #2 are simultaneously performed among five slots may be configured or indicated as P_{0,CLI(0)}, and uplink power of UE #2 in the two subsequent slots in which downlink transmission of gNB #1 and uplink reception of gNB #2 are not simultaneously performed may be configured or indicated as P_{0,normal}. P_{0,CLI(0)} may be greater than P_{0,CLI(0)}.

Referring to FIG. 31(b), when downlink reception of UE #1 and uplink transmission of UE #2 are performed in the same slot or symbol, uplink transmission of UE #2 may cause inter-UE CLI with uplink reception of UE #1. As an embodiment for solving this problem, UE #2 may be configured or indicated from gNB #2 to perform uplink transmission at lower power in a slot or symbol in which downlink reception of UE #1 and uplink transmission of UE #2 are simultaneously performed, compared to a slot or symbol in which downlink reception of UE #1 and uplink transmission of UE #2 are not simultaneously performed. In FIG. 31(b), uplink power of UE #2 in the three preceding slots in which downlink reception of UE #1 and uplink transmission of UE #2 are simultaneously performed may be configured or indicated as P_{0,CLI(0)}, and uplink power of UE #2 in the two subsequent slots in which downlink reception of UE #1 and uplink transmission of UE #2 are not simultaneously performed may be configured or indicated as P_{0,normal}. Here, P_{0,CLI(1)} may be smaller than P_{0,normal}.

For the embodiments described through FIGS. 29 to 31, the UE may be configured with multiple levels of uplink power, and may be indicated to perform uplink transmission by applying one of the multiple levels of uplink power to one slot or symbol. In this case, the multiple levels of uplink power may include the above-described P_{0,normal}, P_{0,SBFD}, P_{0,CLI(0)}, and P_{0,CLI(1)}.

A method in which in a case where a UE transmits a PUSCH or a PUCCH while satisfying a joint channel estimation condition in a slot or symbol operating as a subband, when the UE receives configuration or indication of a dynamic or flexible slot format and transmits a PUSCH or PUCCH while satisfying a joint channel estimation condition in the TDD or unpaired spectrum, the UE determines an actual TDW is described.

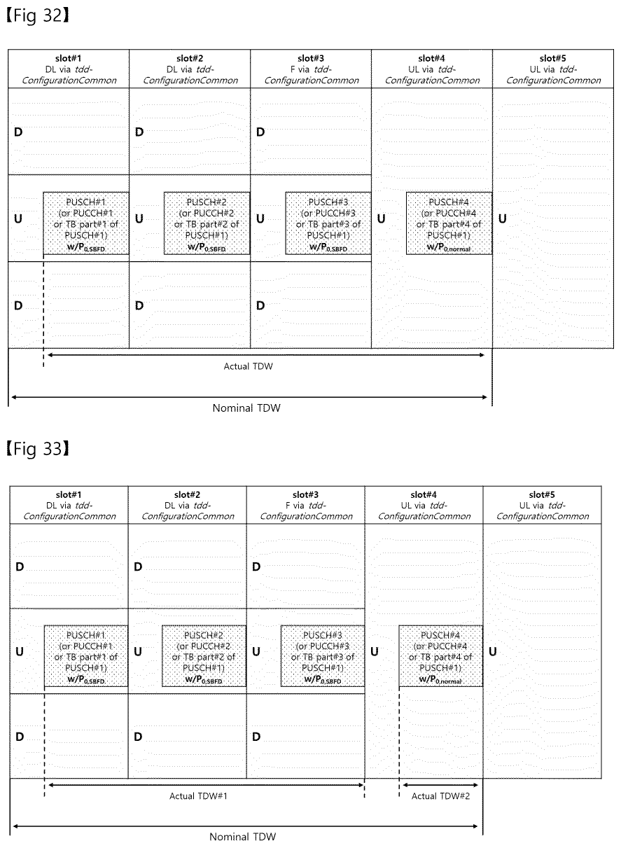

FIGS. 32 and 33 illustrate a method of determining an actual TDW of a UE when operating as a subband according to an embodiment of the present disclosure.

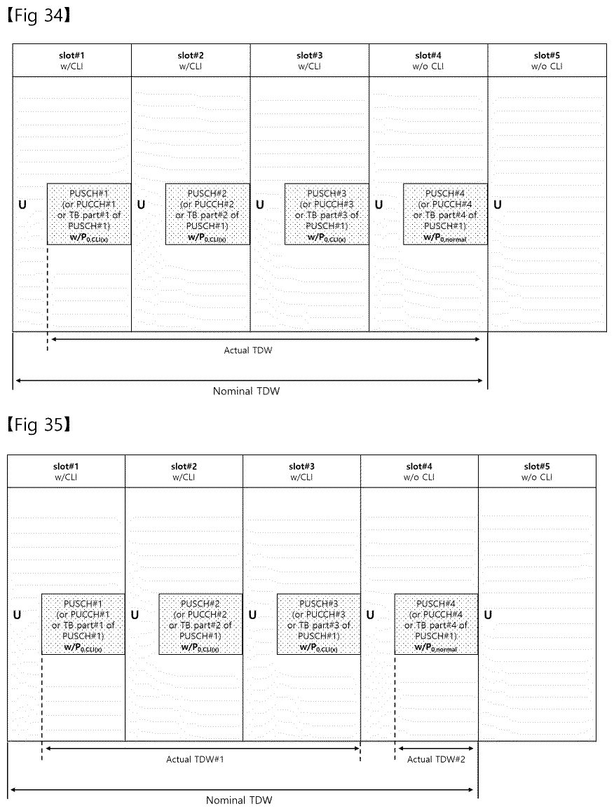

FIGS. 34 and 35 illustrate a problem according to determining an actual TDW by a UE when CLI occurs according to an embodiment of the present disclosure.

Referring to FIGS. 32 to 35, a UE may receive, from a base station, configuration or indication of four repetition transmission of a PUSCH in slot #1 to slot #4 configured and operating as a subband. In addition, the UE may receive, from the base station, configuration of “enable” for an operation of transmitting a PUSCH or PUCCH to satisfy a joint channel estimation condition, and receive configuration of a nominal TDW length as four slots. In this case, the UE may determine one nominal TDW and actual TDWs for four repetition transmission of a PUSCH to perform repetition transmission of the PUSCH so as to satisfy power consistency and phase continuity.

Referring to FIG. 32, the UE may receive indication of PUSCH transmission power in slot #1 to slot #3 operating as a subband as P_{0,SBFD}, and may receive indication of PUSCH transmission power in slot #4 not operating as a subband as P_{0,normal}. P_{0,SBFD} and P_{0,normal} may be configured or indicated as different values, and thus it may be difficult for the UE to maintain power consistency for repetition transmission of PUSCH in slot #1 to slot #3 and repetition transmission of PUSCH in slot #4. As an embodiment for solving this problem, the UE may determine, as a case where power consistency and phase continuity fails to be satisfied, a case where uplink power configured or indicated for a slot or symbol operating as a subband and uplink power configured or indicated for a slot or symbol not operating as a subband are different from each other. Referring to FIG. 33, the UE may determine actual TDW #1 for repetition transmission of PUSCH in slot #1 to slot #3 which operates as subbands and to which PUSCH transmission power is indicated as P_{0,SBFD}, and determine actual TDW #2 for repetition transmission of PUSCH in slot #4 which does not operate as a subband and to which PUSCH transmission power is indicated as P_{0,normal}. The descriptions in FIGS. 32 and 33 are made for repetition transmission of PUSCH, but uplink transmission may be repetition transmission of PUSCH, repetition transmission of PUCCH, and PUSCH transmission for which one TB size (TBS) is determined with reference to multiple slots (TB processing over multiple slots PUSCH). According to this method, when the UE receives configuration of indication of different levels of uplink transmission power for the slot or symbol operating as a subband and the slot or symbol not operating as a subband, the UE may determine the same actual TDW only for uplink channels in the slot or symbol, for which the same uplink transmission power is configured or indicated, thereby enhancing uplink coverage through joint channel estimation in the base station.

Referring to FIG. 34, the UE may determine, as one nominal TDW and actual TDWs, four repetition transmission of PUSCH, and repeatedly transmit the PUSCH to satisfy power consistency and phase continuity. In this case, the UE may receive indication of PUSCH transmission power in slot #1 to slot #3 in which CLI may occur as P_{0,CLI(x)}, and may receive indication of PUSCH transmission power in slot #4 in which CLI does not occur as P_{0,normal}. P_{0,CLI(x)} and P_{0,normal} may be configured or indicated by different values, and thus it is difficult for the UE to maintain power consistency for repetition transmission of PUSCH in slot #1 to slot #3 and repetition transmission of PUSCH in slot #4. Here, P_{0,CLI(x)} may be one of the above-described values P_{0,CLI(0)} and P_{0,CLI(1)}. That is, P_{0,CLI(x)} may be P_{0,CLI(0)} configured or indicated to be higher power than P_{0,normal} in order to mitigate inter-gNB CLI, or may be P_{0,CLI(1)} configured or indicated to be lower power than P_{0,normal} in order to mitigate inter-UE CLI.

As an embodiment for solving this problem, the UE may determine, as a case where power consistency and phase continuity fail to be satisfied, a case where uplink power configured or indicated for a slot or symbol in which CLI occurs and uplink power configured or indicated for a slot or symbol in which CLI does not occur are different from each other. Referring to FIG. 35, the UE may determine, as actual TDW #1, repetition transmission of PUSCH in slot #1 to slot #3 in which CLI occurs and for which PUSCH transmission power is indicated as P_{0,CLI(x)}, and determine, as actual TDW #2, repetition transmission of PUSCH in slot #4 in which CLI does not occur and for which PUSCH transmission power is indicated as P_{0,normal}. The descriptions in FIGS. 34 and 35 are made for repetition transmission of PUSCH, but uplink transmission may be repetition transmission of PUSCH, repetition transmission of PUCCH, and PUSCH transmission for which one TB size (TBS) is determined with reference to multiple slots (TB processing over multiple slots PUSCH). According to this method, when the UE receives configuration of indication of different levels of uplink transmission power for the slot or symbol in which CLI occurs and the slot or symbol in which CLI does not occur, the UE may determine the same actual TDW only for uplink channels in the slot or symbol, for which the same uplink transmission power is configured or indicated, thereby enhancing uplink coverage through joint channel estimation in the base station.

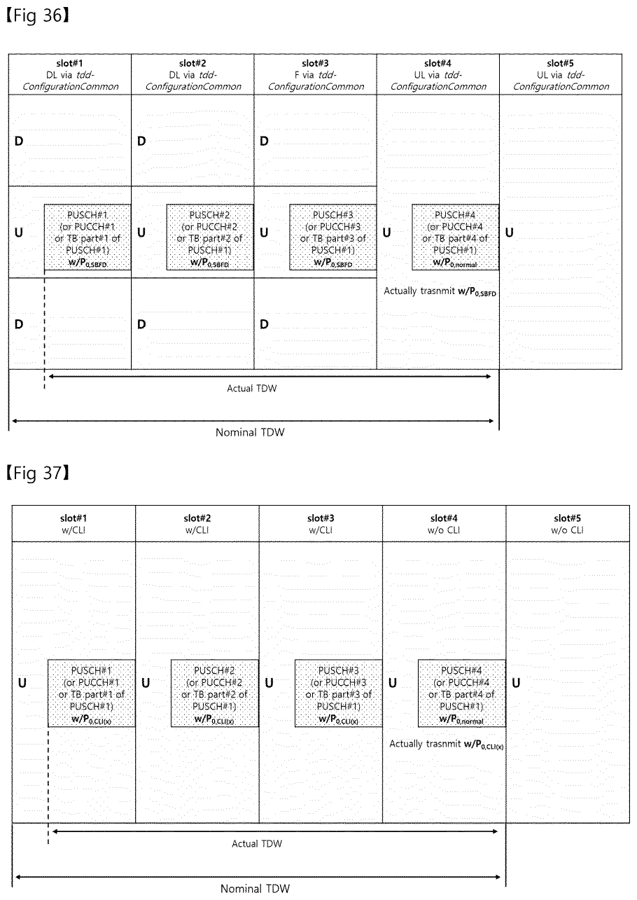

FIGS. 36 and 37 illustrate a method of determining an actual TDW and uplink transmission power by a UE according to an embodiment of the present disclosure.

The UE may determine the same transmission power for uplink channels transmitted in a slot or symbol operating as a subband and a slot or symbol not operating as a subband. The UE may receive, from the base station, configuration of “enable” for an operation of transmitting a PUSCH or a PUCCH to satisfy joint channel estimation. In this case, when uplink transmission power configured or indicated from the base station for the slot or symbol operating as a subband and uplink transmission power configured or indicated for the base station for the slot or symbol not operating as a subband are different from each other, the UE may determine the same uplink transmission power for the slot or symbol operating as a subband and the slot or symbol not operating as a subband. Accordingly, the UE may determine, as the same actual TDW, uplink transmission between the slot or symbol operating as a subband and the slot or symbol not operating as a subband, thereby enhancing uplink coverage through joint channel estimation in the base station. Here, uplink transmission may include repetition transmission of PUSCH, repetition transmission of PUCCH, and PUSCH transmission for which one TB size (TBS) is determined with reference to multiple slots (TB processing over multiple slots PUSCH). A method of determining the same uplink transmission power by the UE is as follows.

(Method 1) The UE may apply the same uplink transmission power to uplink transmission power configured or indicated for the slot or symbol operating as a subband. In other words, the UE may apply the uplink transmission power configured or indicated for the slot or symbol operating as a subband to the slot or symbol not operating as a subband. In the slot or symbol operating as a subband, the UE may be configured or indicated from the base station to perform transmission at lower uplink transmission power in order to mitigate CLI between neighboring subbands. Accordingly, the UE may determine lower uplink transmission power as the same uplink transmission power for the slot or symbol operating as a subband and the slot or symbol not operating as a subband so as to mitigate CLI, and the base station may perform joint channel estimation. Referring to FIG. 36, the UE may receive configuration or indication of uplink transmission power for repetition transmission #1 of PUSCH to repetition transmission #3 of PUSCH in slot #1 to slot #3 operating as subbands as P_{0,SBFD}, and may receive configuration or indication of uplink transmission power for repetition transmission #4 of PUSCH in slot #4 not operating as a subband as P_{0,normal}. When the UE receives configuration of “enable” for an operation of repeatedly transmitting PUSCH to satisfy a joint channel estimation condition, the UE may determine uplink transmission power of repetition transmission #4 of PUSCH in slot #4 as P_{0,SBFD} according to method 1, determine the same actual TDW for repetition transmission #1 of PUSCH to repetition transmission #4 of PUSCH in slot #1 to slot #4, and repeatedly transmit the PUSCH so as to satisfy power consistency and phase continuity. The description in FIG. 36 is made for repetition transmission of PUSCH, but uplink transmission may be repetition transmission of PUSCH, repetition transmission of PUCCH, and PUSCH transmission for which one TB size (TBS) is determined with reference to multiple slots (TB processing over multiple slots PUSCH). According to this method, even though the levels of uplink transmission power, configured for or indicated to the UE by the base station for the slot or symbol operating as a subband and the slot or symbol not operating as subband, are different, when the UE is configured to transmit a PUSCH or PUCCH to satisfy the joint channel estimation condition, the UE may determine the same uplink transmission power, thereby enhancing uplink coverage through joint channel estimation.

(Method 2) The UE may apply the same uplink transmission power to uplink transmission power configured or indicated for the slot or symbol not operating as a subband. In other words, the UE may apply the uplink transmission power configured or indicated for the slot or symbol not operating as a subband to the slot or symbol operating as a subband. The UE may receive configuration or indication of lower uplink transmission power P_{0,SBFD} in the slot or symbol operating as a subband in consideration of CLI between neighboring subbands. In this case, when the UE is configured to transmit the PUSCH or PUCCH to satisfy the joint channel estimation condition, the UE may prioritize uplink transmission over CLI mitigation, and may thus determine that uplink transmission power P_{0,normal} configured or indicated for the slot or symbol not operating as a subband is also applied to the slot or symbol operating as a subband, thereby enhancing uplink coverage through joint channel estimation.

(Method 3) The UE may use, as the same uplink transmission power, uplink transmission power separately configured or indicated from the base station. In other words, when the UE receives configuration of “enable” for the operation of transmitting the PUSCH or PUCCH to satisfy the joint channel estimation condition, the UE may apply the uplink transmission power separately configured or indicated from the base station, rather than uplink transmission power P_{0,SBFD} configured or indicated for the slot or symbol operating as a subband or uplink transmission power P_{0,normal} configured or indicated for the slot or symbol not operating as a subband, and transmit the PUSCH or PUCCH to satisfy the joint channel estimation condition. The separate uplink transmission power may have a value smaller than P_{0,normal}. Alternatively, the separate uplink transmission power may have a value greater than P_{0,SBFD}.

The UE may be configured or indicated to perform four repetition transmission of PUSCH in slot #1 to slot #4 for which a dynamic and flexible slot format is configured from the base station and which operate based thereon. In addition, the UE may receive, from the base station, configuration of “enable” for the operation of transmitting the PUSCH or PUCCH to satisfy the joint channel estimation condition, and may receive configuration of a nominal TDW length as four slots. In this case, the UE may determine four repetition transmissions of PUSCH as one nominal TDW and actual TDWs and perform repetition transmission of the PUSCH to satisfy power consistency and phase continuity. In this case, the UE may receive indication of PUSCH transmission power in slot #1 to slot #3 in which CLI may occur as P_{0,CLI(x)}, and may receive indication of PUSCH transmission power in slot #4 in which CLI does not occur as P_{0,normal}. P_{0,CLI(x)} and P_{0,normal} may be different values, and thus there may be a problem that it is difficult for the UE to maintain power consistency for repetition transmission of PUSCH in slot #1 to slot #3 and repetition transmission of PUSCH in slot #4. P_{0,CLI(x)} may have one of the above-described values P_{0,CLI(0)} and P_{0,CLI(1)}. That is, P_{0,CLI(x)} may be P_{0,CLI(0)} configured or indicated to be higher power than P_{0,normal} in order to mitigate inter-gNB CLI, or may be P_{0,CLI(1)} configured or indicated to be lower power than P_{0,normal} in order to mitigate inter-UE CLI. As an embodiment for solving this problem, the UE may determine, as a case where power consistency and phase continuity fail to be satisfied, a case where uplink power configured or indicated for a slot or symbol in which CLI occurs and uplink power configured or indicated for a slot or symbol in which CLI does not occur are different from each other. The UE may determine, as actual TDW #1, repetition transmission of PUSCH in slot #1 to slot #3 in which CLI occurs and for which PUSCH transmission power is indicated as P_{0,CLI(x)}, and determine, as actual TDW #2, repetition transmission of PUSCH in slot #4 in which CLI does not occur and for which PUSCH transmission power is indicated as P_{0,normal}. Uplink transmission may be repetition transmission of PUSCH, repetition transmission of PUCCH, and PUSCH transmission for which one TB size (TBS) is determined with reference to multiple slots (TB processing over multiple slots PUSCH). According to this method, when the UE receives configuration of indication of different levels of uplink transmission power for the slot or symbol in which CLI occurs and the slot or symbol in which CLI does not occur, the UE may determine the same actual TDW only for uplink channels in the slot or symbol, for which the same uplink transmission power is configured or indicated, thereby enhancing uplink coverage through joint channel estimation in the base station.

The UE may determine the same uplink transmission power for the slot or symbol in which CLI may occur and the slot or symbol in which CLI does not occur. The UE may receive, from the base station, configuration of“enable” for the operation of transmitting the PUSCH or PUCCH to satisfy the joint channel estimation condition. In this case, when uplink transmission power configured or indicated from the base station for the slot or symbol in which CLI may occur and uplink transmission power configured or indicated for the base station for the slot or symbol in which CLI does not occur are different from each other, the UE may determine the same uplink transmission power for the slot or symbol in which CLI may occur and the slot or symbol in which CLI does not occur. Accordingly, the UE may determine the same actual TDW for the uplink transmission between the slot or symbol in which CLI may occur and the slot or symbol in which CLI does not occur, thereby enhancing uplink coverage through joint channel estimation in the base station. Here, uplink transmission may include repetition transmission of PUSCH, repetition transmission of PUCCH, and PUSCH transmission for which one TB size (TBS) is determined with reference to multiple slots (TB processing over multiple slots PUSCH). A method of determining the same uplink transmission power by the UE is as follows.

(Method a) The UE may apply the same uplink transmission power to uplink transmission power configured or indicated for the slot or symbol in which CLI may occur. In other words, the UE may apply the uplink transmission power configured or indicated for the slot or symbol in which CLI may occur to the slot or symbol in which CLI does not occur. The UE may be configured or indicated from the base station to perform transmission at higher uplink transmission power in the slot or symbol in which CLI may occur so as to mitigate inter-gNB CLI. Alternatively, the UE may be configured or indicated from the base station to perform transmission at lower uplink transmission power so as to mitigate inter-UE CLI. Accordingly, the UE may determine the same uplink transmission power to the slot or symbol in which CLI may occur and the slot or symbol in which CLI does not occur, thereby mitigating CLI and allowing the base station to perform joint channel estimation. Referring to FIG. 37, the UE may receive configuration or indication of uplink transmission power for repetition transmission #1 of PUSCH to repetition transmission #3 of PUSCH in slot #1 to slot #3 in which CLI may occur as P_{0,CLI(x)}, and may receive configuration or indication of uplink transmission power for repetition transmission #4 of PUSCH in slot #4 in which CLI does not occur as P_{0,normal}. When the UE receives configuration of “enable” for an operation of repeatedly transmitting PUSCH to satisfy a joint channel estimation condition, the UE may determine uplink transmission power of repetition transmission #4 of PUSCH in slot #4 as P_{0,CLI(x)} according to method a, determine the same actual TDW for repetition transmission #1 of PUSCH to repetition transmission #4 of PUSCH in slot #1 to slot #4, and repeatedly transmit the PUSCH so as to satisfy power consistency and phase continuity. Here, P_{0,CLI(x)} may have one of the above-described values P_{0,CLI(0)} and P_{0,CLI(1)}. That is, P_{0,CLI(0)} configured or indicated to be higher power than P_{0,normal} in order to mitigate inter-gNB CLI, or P_{0,CLI(1)} configured or indicated to be lower power than P_{0,normal} in order to mitigate inter-UE CLI, may be determined as power for uplink transmission. Uplink transmission may be repetition transmission of PUSCH, repetition transmission of PUCCH, and PUSCH transmission for which one TB size (TBS) is determined with reference to multiple slots (TB processing over multiple slots PUSCH). According to this method, even though the levels of uplink transmission power, configured for or indicated to the UE by the base station for the slot or symbol in which CLI may occur and the slot or symbol in which CLI does not occur, may be different, when the UE is configured to transmit a PUSCH or PUCCH to satisfy the joint channel estimation condition, the UE may determine the same uplink transmission power, thereby enhancing uplink coverage through joint channel estimation.

(Method b) The UE may apply the same uplink transmission power to uplink transmission power configured or indicated for the slot or symbol in which CLI does not occur. In other words, the UE may apply the uplink transmission power configured or indicated for the slot or symbol in which CLI does not occur to the slot or symbol in which CLI may occur. The UE may receive configuration or indication of higher uplink transmission power P_{0,CLI(0)} in the slot or symbol in which CLI may occur in consideration of inter-gNB CLI, or may receive configuration or indication of lower uplink transmission power P_{0,CLI(1)} in consideration of inter-gNB CLI. In this case, when the UE is configured to transmit the PUSCH or PUCCH to satisfy the joint channel estimation condition, the UE may prioritize uplink transmission over CLI mitigation, and may thus also apply uplink transmission power P_{0,normal} configured or indicated for the slot or symbol in which CLI does not occur to the slot or symbol operating in which CLI may occur, thereby enhancing uplink coverage through joint channel estimation.

(Method c) The may UE determine, as the same uplink transmission power, uplink transmission power separately configured or indicated from the base station. In other words, when the UE receives configuration of “enable” for the operation of transmitting the PUSCH or PUCCH to satisfy the joint channel estimation condition, the UE may apply the uplink transmission power separately configured or indicated from the base station, rather than uplink transmission power P_{0,CLI(x)} configured or indicated for the slot or symbol in which CLI may occur or uplink transmission power P_{0,normal} configured or indicated for the slot or symbol in which CLI does not occur, and transmit the PUSCH or PUCCH to satisfy the joint channel estimation condition. Accordingly, uplink coverage can be enhanced through joint channel estimation. The separate uplink transmission power may have a value smaller than P_{0,normal}, have a value smaller than P_{0,CLI(0)}, or may have a value greater than P_{0,CLI(1)}.

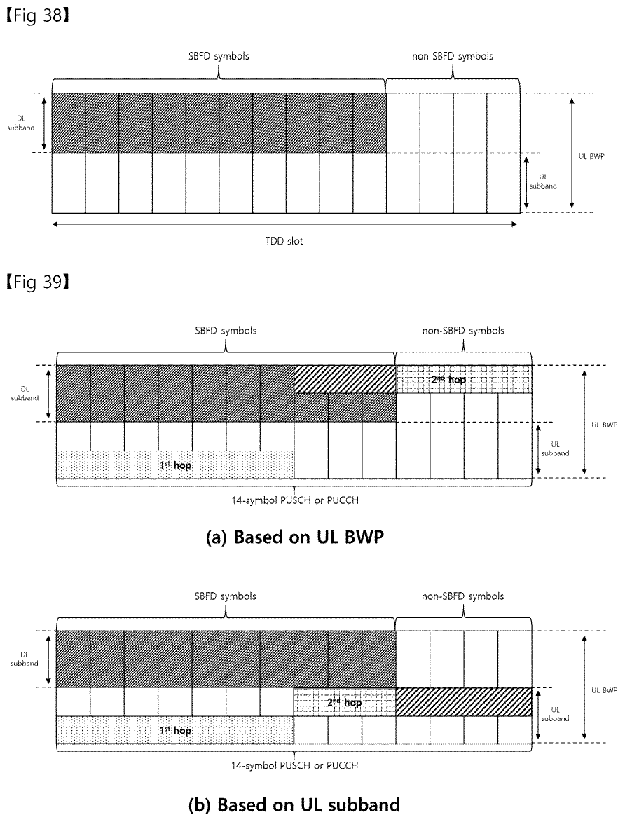

FIG. 38 to 44 illustrate a method of performing frequency hopping in a resource configured or indicated as a subband according to an embodiment of the present disclosure.

Hereinafter, a case where a UE is configured or indicated to transmit a PUSCH or a PUCCH through intra-slot frequency hopping in a slot or symbol configured or indicated to operate as a subband is described.

Referring to FIG. 38, the UE may receive configuration or indication that the preceding symbols operate as subbands among 14 symbols in one slot. In this case, the remaining four subsequent symbols may not operate as subbands, and may have a symbol type (downlink, uplink, or flexible) according to the conventional TDD configuration. In the present disclosure, the symbol operating as a subband is referred to as a subband non-overlapping full duplex (SBFD) symbol and the symbol not operating as a subband is referred to as a non-SBFD symbol. That is, the UE in FIG. 36 may receive configuration or indication of 10 SBFD symbols and four non-SBFD symbols. Here, the SBFD symbol may include a cell-specific downlink symbol and a cell-specific flexible symbol, and the non-SBFD symbol may include a cell-specific uplink symbol.

Referring to FIG. 39(a), the UE may determine a frequency position of a second hop with reference to a UL BWP size. Here, the UL BWP size may include the number of PRBs constituting an initial UL BWP or active UL BWP activated for the UE. For 14 symbols in which the UE is configured or indicated to perform PUSCH or PUCCH transmission, the three preceding SBFD symbols among seven symbols constituting the second hop may be included in a DL subband. The UE may perform downlink reception only and may not be able perform uplink transmission in the DL subband.

Referring to FIG. 39(b), the UE may determine a frequency position of a second hop with reference to a UL subband size. Here, the UL subband size may include the number of PRBs constituting a UL subband configured or indicated for the UE. For 14 symbols in which the UE is configured or indicated to perform PUSCH or PUCCH transmission, the four subsequent non-SBFD symbols among seven symbols constituting the second hop may experience reduction in frequency diversity gain compared to the conventional method of determining the frequency position with reference to the UL BWP size. To solve this problem, when the UE is configured or indicated to transmit a PUSCH or PUCCH through intra-slot frequency hopping in a slot or symbol configured or indicated to operate as a subband, the UE may determine the same symbol type (SBFD symbol or non-SBFD symbol) as a single frequency hop. Referring to FIG. 38, for 14 symbols configured or indicated for PUSCH or PUCCH transmission, the UE may determine the ten preceding SBFD symbols as a first hop, and the four subsequent non-SBFD symbols as a second hop. The frequency position of each frequency hop may be determined with reference to the UL subband size in the case of SBFD symbol, and may be determined with reference to the UL BWP size in the case of non-SBFD symbol. According to this method, when PUSCH transmission or PUCCH transmission is scheduled over the SBFD symbols and non-SBFD symbols in one slot, frequency hopping is performed only in the UL subband for the SBFD symbols, and frequency hopping is performed only in the UL BWP for the non-SBFD symbols, whereby frequency diversity gain can be achieved.

Hereinafter, problems which may occur when the same symbol type (SBFD symbol or non-SBFD symbol) is determined as one frequency hop according to the above-described method in a case where the UE is configured or indicated to perform PUSCH or PUCCH transmission through intra-slot frequency hopping in the slot or symbol configured or indicated to operate as a subband are described.

The UE may be configured or indicated to transmit PUCCH format 1 through intra-slot frequency hopping in a slot or symbol configured or indicated to operate as a subband. Table 4 shows the number of UCI symbols determined when the UE transmits PUCCH format 1, and Table 5 shows the number of DMRSs determined when the UE transmits PUCCH format 1.

TABLE 4

| | N_{SF, m′}^{PUCCH, 1} | |
|---|---|---|
| PUCCH length, | No intra-slot hopping | Intra-slot hopping |

| N_{symb}^{PUCCH, 1} | m′ = 0 | m′ = 0 | m′ = 1 |
|---|---|---|---|
| 4 | 2 | 1 | 1 |
| 5 | 2 | 1 | 1 |
| 6 | 3 | 1 | 2 |
| 7 | 3 | 1 | 2 |
| 8 | 4 | 2 | 2 |
| 9 | 4 | 2 | 2 |
| 10 | 5 | 2 | 3 |
| 11 | 5 | 2 | 3 |
| 12 | 6 | 3 | 3 |
| 13 | 6 | 3 | 3 |
| 14 | 7 | 3 | 4 |

TABLE 5

| | N_{SF, m′}^{PUCCH, 1} | |
|---|---|---|
| PUCCH length, | No intra-slot hopping | Intra-slot hopping |

| N_{symb}^{PUCCH, 1} | m′ = 0 | m′ = 0 | m′ = 1 |
|---|---|---|---|
| 4 | 2 | 1 | 1 |
| 5 | 3 | 1 | 2 |
| 6 | 3 | 2 | 1 |
| 7 | 4 | 2 | 2 |
| 8 | 4 | 2 | 2 |
| 9 | 5 | 2 | 3 |
| 10 | 5 | 3 | 2 |
| 11 | 6 | 3 | 3 |
| 12 | 6 | 3 | 3 |
| 13 | 7 | 3 | 4 |
| 14 | 7 | 4 | 3 |

Here, N^{PUCCH,1}_{symb} may indicate the number of symbols configured or indicated for the UE by the base station for transmission of PUCCH format 1, m′=0 may indicate the number of UCI symbols or the number of DMRS symbols of the first hop, m′=1 may indicate the number of PUCCHs (UCI) or DMRS symbols of the second hop, and N^{PUCCH,1}_{SF,m′} may indicate a spread factor for determining an orthogonal cover code (OCC) applied for multiplexing of UEs in case of transmission of PUCCH format 1. Here, N^{PUCCH,1}_{SF,m′} may be the same as the number of UCI symbols or the number of DMRS symbols of the corresponding frequency hop. Accordingly, when the UE is configured or indicated from the base station to transmit a PUCCH in PUCCH format 1, the UE may determine the number of UCI symbols and the number of DMRS symbols for PUCCH transmission through Tables 4 and 5. For example, when the UE receives configuration or indication of N^{PUCCH,1}_{symb}=12 from the base station, the UE may determine the number of symbols of the first hop as 6 (the number of UCI symbols is 3 and the number of DMRS symbols is 3), and the number of symbols of the second hop as 6 (the number of UCI symbols is 3 and the number of DMRS symbols is 3).

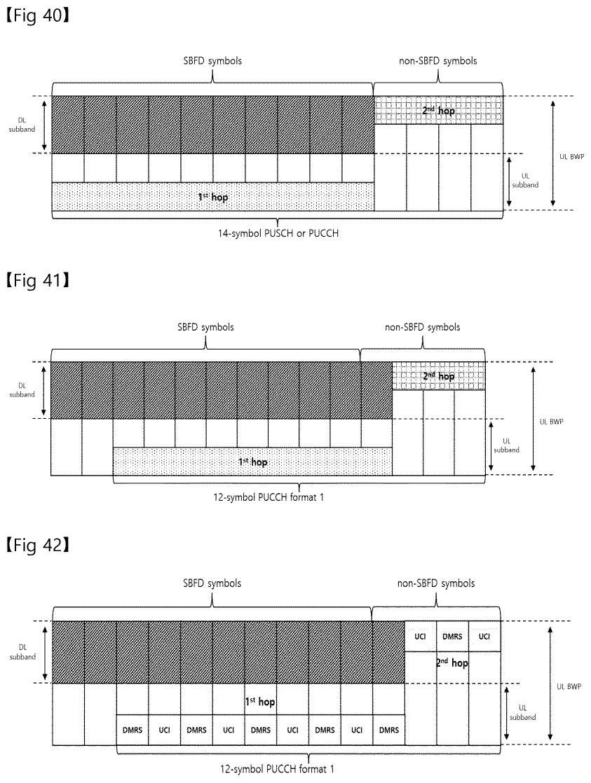

When the UE is configured or indicated to transmit PUCCH format 1 through intra-slot frequency hopping in the slot or symbol configured or indicated to operate as a subband, the UE may fail to determine the number of symbols of the first hop and the number of symbols of the second hop through Tables 9 and 10. For example, referring to FIG. 39, when the UE receives configuration or indication of N^{PUCCH,1}_{symb}=12 in the slot or symbol configured or indicated to operate as a subband, the UE may set the number of symbols (m′=0) of the first hop to 9, and the number of symbols (m′=1) of the second hop to 3, but a problem that the UE cannot determine the number of UCI symbols and the number of DMRSs for each frequency hop through Tables 4 and 5 may occur. In order to solve the problem, referring to FIG. 40, when the UE is configured or indicated to transmit PUCCH format 1 through intra-slot frequency hopping in the slot or symbol configured or indicated to operate as a subband, the UE may determine the same symbol type as one frequency hop. In this case, the number of UCI symbols and the number of DMRS symbols of each frequency hop may be determined as follows. The number of UCI symbols of the first hop may be determined as floor(N_{symb,SBFD}^{PUCCH,1}/2), the number of DMRS symbols of the first hop may be determined as N_{symb,SBFD}^{PUCCH,1}−floor(N_{symb,SBFD}^{PUCCH,1}/2), the number of UCI symbols of the second hop may be determined as N_{symb,non-SBFD}^{PUCCH,1}−floor(N_{symb,non-SBFD}^{PUCCH,1}/2), and the number of DMRS symbols of the second hop may be determined as floor(N_{symb,non-SBFD}^{PUCCH,1}/2). N^{PUCCH,1}_{symb,SBFD} may indicate the number of symbols of PUCCH format 1 transmitted in the SBFD symbols among N^{PUCCH,1}_{symb}, and N^{PUCCH,1}_{symb,non-SBFD} may indicate the number of symbols of PUCCH format 1 transmitted in the non-SBFD symbols among N^{PUCCH,1}_{symb}. The UE may determine to configure the first hop with SBFD symbols only and configure the second hop with non-SBFD symbols. In the structure of PUCCH format 1, DMRS symbols first positioned and UCI symbols follow in the time domain, and thus the UE may determine the number of UCI symbols and the number of DMRS symbols to be different for each other in each frequency hop as in the above-described method. The UE in FIG. 40 may determine the nine preceding SBFD symbols as the first hop and the three subsequent non-SBFD symbols as the second hop among 12 symbols configured or indicated for transmission of PUCCH format 1. The number of UCI symbols and the number of DMRS symbols in each frequency hop may be determined as follows. The number of UCI symbols of the first hop may be determined as floor(9/2)=4, the number of DMRS symbols of the first hop may be determined as 9-floor(9/2)=5, the number of UCI symbols of the second hop may be determined as 3-floor(3/2)=2, and the number of DMRS symbols of the second hop may be determined as floor(3/2)=1. According to this method, when the UE is configured or indicated to transmit PUCCH format 1 through intra-slot frequency hopping in the slot or symbol configured or indicated to operate as a subband, the UE may determine the number of UCI symbols and the number of DMRS symbols by using the above-described expression above, without defining a new table considering both the number N^{PUCCH,1}_{symb} of symbols configured or indicated for PUCCH transmission and configuration of symbols in the TDD slot in order to determine the number of UCI symbols and the number of DMRS symbols. In the present disclosure, floor(x) is a floor function, and floor(x) refers to the largest integer among the integers that are smaller than or equal to x.

Hereinafter, a method of determining the position of a DMRS symbol when the UE transmits PUSCH or PUCCH format 3 or PUCCH format 4 through intra-slot frequency hopping in the slot or symbol configured or indicated to operate as a subband is described.

In Tables 6 and 7, l_{d} indicates the number of symbols used for PUSCH transmission per frequency hop, l₀ indicates the position of a first DMRS symbol among the symbols in which the UE is scheduled for PUSCH transmission, and dmrs-AdditionalPosition is information related to additional DMRS symbol configuration for PUSCH transmission. The UE may determine the DMRS symbol position 1 of each frequency hop, based on l_{d}, l₀, dmrs-AdditionalPosition according to Tables 6 and 7.

Table 6 shows the position of a DMRS symbol determined when the UE transmits a PUSCH by performing intra-slot frequency hopping.

TABLE 6

| | DM-RS positions l̅ | | | | | | | | | | | |
|---|---|---|---|---|---|---|---|---|---|---|---|---|
| | PUSCH mapping type A | | | | | | | | PUSCH mapping type B | | | |
| | l₀ = 2 | | | | l₀ = 3 | | | | l₀ = 0 | | | |
| | dmrs-AdditionalPosition | | | | dmrs-AdditionalPosition | | | | dmrs-AdditionalPosition | | | |
| | pos0 | | pos1 | | pos0 | | pos1 | | pos0 | | pos1 | |
| l_{d} in | 1^{st} | 2^{nd} | 1^{st} | 2^{nd} | 1^{st} | 2^{nd} | 1^{st} | 2^{nd} | 1^{st} | 2^{nd} | 1^{st} | 2^{nd} |
| symbols | hop | hop | hop | hop | hop | hop | hop | hop | hop | hop | hop | hop |
| ≤3 | — | — | — | — | — | — | — | — | 0 | 0 | 0 | 0 |
| 4 | 2 | 0 | 2 | 0 | 3 | 0 | 3 | 0 | 0 | 0 | 0 | 0 |
| 5, 6 | 2 | 0 | 2 | 0, 4 | 3 | 0 | 3 | 0, 4 | 0 | 0 | 0, 4 | 0, 4 |
| 7 | 2 | 0 | 2, 6 | 0, 4 | 3 | 0 | 3 | 0, 4 | 0 | 0 | 0, 4 | 0, 4 |

When determining the same symbol type (SBFD symbol or non-SBFD symbol) as one frequency hop according to the above-described embodiment in a case where the UE transmits the PUSCH through intra-slot frequency hopping in the slot or symbol configured or indicated to operate as a subband, the number of symbols of one frequency hop cannot exceed 7, and in this case, the UE cannot determine the position of the DMRS symbol through Table 6. Hereinafter, a method of determining the position of a DMRS symbol by using Table 7 when the number of symbols of one frequency hop exceeds 7 is described.

TABLE 7

| | DM-RS positions i | | | | | | | | | | | |
|---|---|---|---|---|---|---|---|---|---|---|---|---|
| | PUSCH mapping type A | | | | | | | | PUSCH mapping type B | | | |
| | l₀ = 2 | | | | l₀ = 3 | | | | l₀ = 0 | | | |
| | dmrs-AdditionalPosition | | | | dmrs-AdditionalPosition | | | | dmrs-AdditionalPosition | | | |
| | pos0 | | pos1 | | pos0 | | pos1 | | pos0 | | pos1 | |
| l_{d} in | 1^{st} | 2^{nd} | 1^{st} | 2^{nd} | 1^{st} | 2^{nd} | 1^{st} | 2^{nd} | 1^{st} | 2^{nd} | 1^{st} | 2^{nd} |
| symbols | hop | hop | hop | hop | hop | hop | hop | hop | hop | hop | hop | hop |
| ≤3 | — | — | — | — | — | — | — | — | 0 | 0 | 0 | 0 |
| 4 | 2 | 0 | 2 | 0 | 3 | 0 | 3 | 0 | 0 | 0 | 0 | 0 |
| 5, 6 | 2 | 0 | 2 | 0, 4 | 3 | 0 | 3 | 0, 4 | 0 | 0 | 0, 4 | 0, 4 |
| 7 | 2 | 0 | 2, 6 | 0, 4 | 3 | 0 | 3 | 0, 4 | 0 | 0 | 0, 4 | 0, 4 |
| 8 | 2 | 0 | 2, 7 | 0, 6 | 3 | 0 | 3, 7 | 0, 6 | 0 | 0 | 0, 6 | 0, 6 |
| 9 | 2 | 0 | 2, 7 | 0, 6 | 3 | 0 | 3, 7 | 0, 6 | 0 | 0 | 0, 6 | 0, 6 |
| 10 | 2 | 0 | 2, 9 | 0, 8 | 3 | 0 | 3, 9 | 0, 8 | 0 | 0 | 0, 8 | 0, 8 |
| 11 | 2 | 0 | 2, 9 | 0, 8 | 3 | 0 | 3, 9 | 0, 8 | 0 | 0 | 0, 8 | 0, 8 |
| 12 | 2 | 0 | 2, 9 | 0, 9 | 3 | 0 | 3, 9 | 0, 9 | 0 | 0 | 0, 9 | 0, 9 |

Compared to Table 6, in Table 7, the position of a DMRS symbol for a case where the number l_{d} of Symbols used for PUSCH transmission per frequency hop is 8, 9, 10, 11, and 12 is added. This method is a method of determining the position of a DMRS symbol by including a case where a maximum number of symbols of one frequency hop, which can be considered during intra-slot frequency hopping, may exceed 7 when the slot operates as subband while a maximum number of symbols of one frequency hop during intra-slot frequency hopping is 7 in the conventional situation where a subband operation is not considered. Here, l_{d}=13 is not included because when the number of symbols of one frequency hop is 13, the number of symbols of the other frequency hop is 1, and thus it is not possible to transmit both data and the DMRS in the corresponding frequency hop.

Table 8 shows the position of a DMRS symbol determined when the UE transmits PUCCH format 3 or PUCCH format 4 by performing intra-slot frequency hopping.

TABLE 8

| | DM-RS position l within PUCCH span | | | |
|---|---|---|---|---|
| PUCCH | No additional DM-RS | | Additional DM-RS | |
| length | No hopping | Hopping | No hopping | Hopping |
| 4 | 1 | 0, 2 | 1 | 0, 2 |

| | | |
|---|---|---|
| 5 | 0, 3 | 0, 3 |
| 6 | 1, 4 | 1, 4 |
| 7 | 1, 4 | 1, 4 |
| 8 | 1, 5 | 1, 5 |
| 9 | 1, 6 | 1, 6 |
| 10 | 2, 7 | 1, 3, 6, 8 |
| 11 | 2, 7 | 1, 3, 6, 9 |
| 12 | 2, 8 | 1, 4, 7, 10 |
| 13 | 2, 9 | 1, 4, 7, 11 |
| 14 | 3, 10 | 1, 5, 8, 12 |

A PUCCH length in Tables 8 and 9 indicates the number of symbols of PUCCH format 3 or PUCCH format 4 configured or indicated for the UE for PUCCH transmission. The UE may determine DMRS symbol position 1 according to the PUCCH length, whether intra-slot frequency hopping is configured, and whether an additional DMRS is configured.

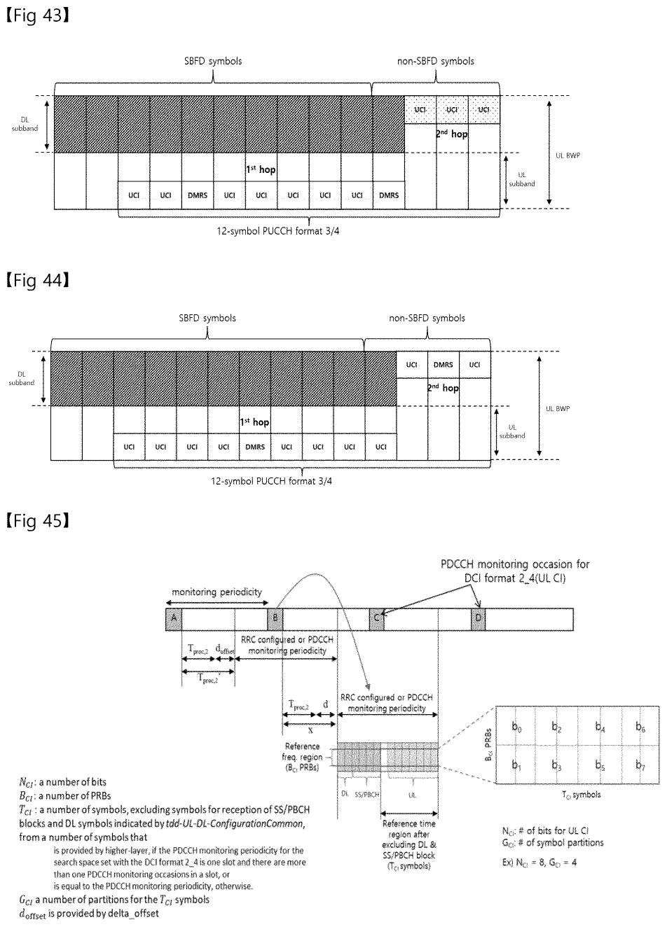

Referring to FIG. 43, when the UE receives configuration or indication of PUCCH length=12 in the slot or symbol configured or indicated to operate as a subband and receives configuration that there is no additional DMRS, the UE may determine the number of symbols of the first hop as 9, and the number of symbols of the second hop as 3. In this case, according to Table 8, the UE may determine the positions of the DMRS symbols as the second symbol and the eighth symbol, and may thus determine that there is no DMRS symbol in the second hop. During frequency hopping for PUCCH transmission, respective frequency hops need to be transmitted in different frequency resources, and thus one hope needs to include at least on DMRS symbol for channel estimation. Referring to FIG. 44 and Table 9, a method for solving the problem that no DMRS symbol is included is described.

TABLE 9

| | DM-RS positions l | | | |
|---|---|---|---|---|
| PUCCH length | No additional DM-RS | | Additional DM-RS | |
| per hop | 1^{st} hop | 2^{nd} hop | 1^{st} hop | 2^{nd} hop |
| 2 | 0 | 0 | 0 | 0 |
| 3 | 1 | 1 | 1 | 1 |
| 4 | 1 | 1 | 1 | 1 |
| 5 | 2 | 2 | 1, 3 | 1, 3 |
| 6 | 2 | 2 | 1, 4 | 1, 4 |
| 7 | 3 | 3 | 1, 5 | 1, 5 |
| 8 | 3 | 3 | 1, 6 | 1, 6 |
| 9 | 4 | 4 | 1, 7 | 1, 7 |
| 10 | 4 | 4 | 1, 8 | 1, 8 |
| 11 | 5 | 5 | 1, 9 | 1, 9 |
| 12 | 5 | 5 | 1, 10 | 1, 10 |

Compared to Table 8, referring to FIG. 9, the position of a DMRS symbol may be determined based on the number of symbols of each frequency hop (PUCCH length per hop) of the number of PUCCHs (PUCCH length) scheduled for the UE. Referring to FIG. 42, when the UE receives configuration or indication of PUCCH length=12 in the slot or symbol configured or indicated to operate as a subband and receives configuration that there is no additional DMRS, the UE may determine the number of symbols of the first hop (PUCCH length per hop) as 9, and the number of symbols of the second hop (PUCCH length per hop) as 3. According to Table 9, the UE may determine the DMRS symbol position of the first hop as 4, and the DMRS symbol position of the second hop as 1. According to this method, when the UE is configured or indicated to operate as a subband, the number of symbols of the first hop and the second hop for PUCCH transmission may be configured in various manners. Accordingly, while there is a case of determining that there is no DMRS symbol in one frequency hop in the conventional method, one or more DMRS symbols may exist in one frequency hop in a proposed method. Here, PUCCH length per hop=13 is not included because when the number of symbols of one frequency hop is 13, the number of symbols of the other frequency hop is 1, and thus it is not possible to transmit both data and the DMRS in the corresponding frequency hop.

### UL Cancellation Indication (CI) on SBFD Operation

In an NR system, a base station may schedule time-frequency resources, scheduled for uplink signal/channel transmission of one UE, for uplink signal/channel transmission of another UE. In addition, the base station may schedule time-frequency resources, scheduled for uplink signal/channel transmission of one UE, for other type of uplink signal/channel transmission from the corresponding UE. When time-frequency resources scheduled for a specific use are scheduled for another use, uplink signal/channel transmission in the previous scheduled time-frequency resources may be cancelled. When uplink signal/channel transmission of one UE is cancelled for uplink signal/channel transmission of another UE or other type of uplink signal/channel transmission, the base station may transmit an uplink cancellation indication (UL CI) to the UE. The uplink signal/channel cancelled through UL CI may include a sounding reference signal (SRS) or a physical uplink shared channel (PUSCH).

FIG. 45 to 49 illustrate an uplink cancellation indication according to an embodiment of the present indicator.

FIG. 45 illustrates a method of receiving a UL CI for cancellation of an uplink signal/channel by a UE. Referring to FIG. 45, the UE may detect a PDCCH in a monitoring occasion in a monitoring periodicity of a PDCCH, and may cancel transmission of scheduled the uplink signal/channel, based on the UL CI included in the detected PDCCH.

Specifically, the UE may detect a PDCCH in monitoring occasion A, B, C, and D in each monitoring periodicity. In this case, the monitoring periodicity may be configured by higher layer (e.g., RRC configuration information). When DCI of the detected PDCCH is DCI having a specific format (e.g., DCI format 2_4) including a UL CI, the UE may cancel, based on the UL CI included in the DCI, uplink signal/channel transmission for all or some of resources for which uplink signal/channel transmission is scheduled.

In this case, a time-frequency resource region in which uplink signal/channel transmission can be cancelled by the UL CI may be referred to as a reference resource region, and the reference resource region may include “Y” symbols on the time axis and at least one physical resource block (PRB) on the frequency axis. The number “Y” of symbols in the reference resource region may be configured by higher-layer signaling (e.g., RRC configuration information), or determined based on the monitoring periodicity of the PDCCH. In this case, the reference resource region may be a region remaining after excluding a part of resource region from a pre-configured number of symbols or monitoring periodicity.

Specifically, a resource region that can be cancelled by the UL CI may include T_{CI} symbols on the time axis and B_{CI} PRBs on the frequency axis, and the T_{CI} symbols may be symbols remaining after excluding a specific resource region from a pre-configured number of symbols or monitoring periodicity. The specific resource region may include a symbol configured for reception of a synchronization signal (SS)/physical broadcast channel (PBCH) block of the UE. The specific resource region may include a symbol configured for the UE as a downlink symbol through tdd-UL-DL-ConfigurationCommon. In other words, the specific resource region may include a symbol configured for the UE as an uplink symbol through tdd-UL-DL-ConfigurationCommon or a flexible symbol not configured for SS/PBCH block reception among flexible symbols.

The reference resource region or T_{CI} symbols may be positions “X” (T_{proc,2′}) symbols after a symbol in which a PDCCH including DCI format 2_4 including the UL CI is detected, and a value of “X” may be determined based on a PUSCH processing time (T_{proc,2}) and offset value. That is, the UE may determine an index of a first symbol of the reference resource region, based on the PUSCH processing time and offset value after a last symbol in which the PDCCH including the UL CI is detected.

B_{CI} indicating the number of PRBs on the frequency axis in the reference resource region may be determined by a resource indication value (RIV) included in the RRC configuration information. The RIV may indicate an index of a start PRB and the number of consecutive PRBs in the reference resource region on the frequency axis, and the UE may determine, based on the RIV value, B_{CI} indicating the number of PRBs in the reference resource region on the frequency axis.

The UL CI may indicate a resource region in which transmission of an uplink signal/channel is actually cancelled in the reference resource region through a bitmap scheme. That is, the reference resource region may be divided into multiple resource groups according to the number of bits of the bitmap of UL CI, and for each resource group, whether to perform actual cancellation may be indicated according to a corresponding bit value.

Referring to FIG. 45, when the number N_{CI} of bits of the bitmap of UL CI is “8”, the reference resource region may be divided into eight groups including b₀ to b₇ (four groups (G_{CI}) on the time axis and two groups on the frequency axis), and the eight bits correspond to b₀ to b₇, respectively, and indicate whether to cancel uplink signal/channel transmission. When the bit value of the bitmap is “0”, the bit value may indicate that uplink signal/channel transmission is not to be cancelled, and when the bit value is “1”, the bit value may indicate that uplink signal/channel transmission is to be cancelled.

DCI format 2_4 including the UL CI may be transmitted through a group common (GC)-PDCCH scrambled with CI-RNTI configured by a higher layer. Accordingly, when multiple UEs in a cell receive the UL CI through detection of the GC-PDCCH scrambled with the CI-RNTI configured with the same value, the multiple UEs may be indicated to cancel uplink signal/channel transmission in the same time-frequency resource.

Hereinafter, a UE operation when a UE supporting an SBFD operation receives a UL CI and is configured and indicated to cancel an uplink signal (e.g., SRS) or an uplink channel (e.g., PUSCH) is described.

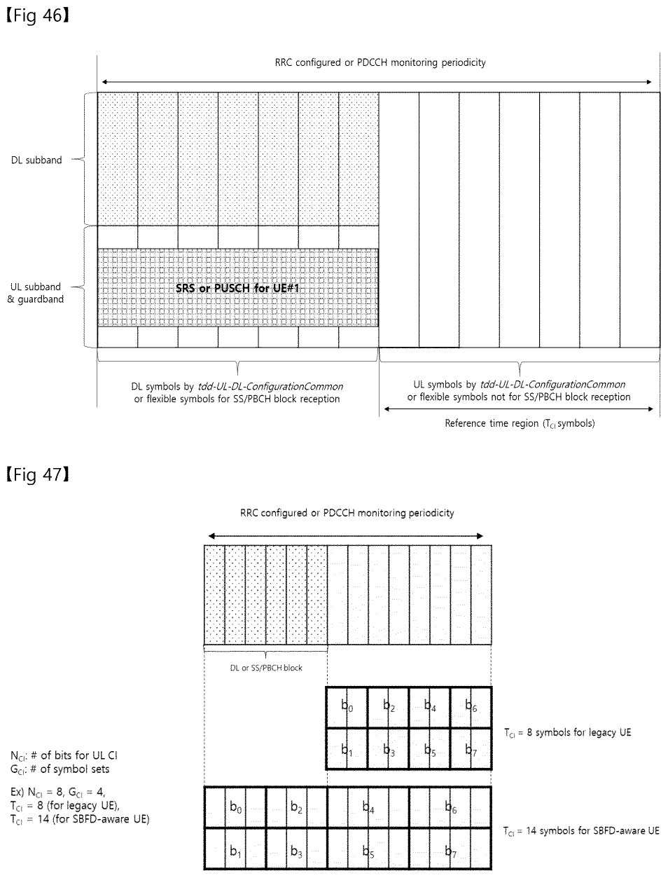

Referring to FIG. 46, UE #1 supporting an SBFD operation may receive configuration or indication of an uplink subband in a flexible symbol in which reception of an SS/PBCH block is configured or a cell-specific downlink symbol. UE #1 may be configured or indicated from the base station to transmit an uplink signal/channel (e.g., SRS or PUSCH) in an uplink subband. Thereafter, the base station may indicate, through the UL CI, to cancel the uplink signal/channel transmission of UE #1 for all or a part of the time-frequency resource region to use the same for DL reception of another UE or UL transmission of another UE. However, the reference resource region (T_{CI} symbols) on the time axis, which can be cancelled by the UL CI, excludes the cell-specific downlink symbol or the flexible symbol in which SS/PBCH block reception is configured, and thus there is a problem that UE #1 cannot be indicated to cancel SRS or PUSCH transmission in the uplink subband through the reception of the UL CI. As an embodiment of the present invention for solving the problem, a UE supporting an SBFD operation may include a cell-specific downlink symbol or a flexible symbol in which an SS/PBCH block reception is configured in a reference resource region (T_{CI} symbols) on the time axis. In other words, when determining a reference resource region (T_{CI} symbols) on the time axis for the UL CI, the UE supporting the SBFD operation may not exclude the cell-specific downlink symbol or the flexible symbol in which the SS/PBCH block reception is configured. The UE may include the cell-specific downlink symbol or the flexible symbol in which the SS/PBCH block reception is configured in the reference resource region (T_{CI} symbols) on the time axis, and may be indicated to cancel the uplink signal/channel in the corresponding reference resource region through the bitmap in the UL CI indicated from the base station. Hereinafter, a specific signaling method for UL CI reception of a UE supporting an SBFD operation is described.

### (First Method)

Referring to FIG. 47, a legacy UE may determine, as a reference resource region (T_{CI} symbols) on the time axis, eight symbols remaining after excluding a cell-specific downlink symbol or a symbol in which SS/PBCH block reception is configured. When the bitmap size (N_{CI}) of the UL CI is configured as 8 bits, the bitmap for eight symbols may be divided into eight groups (four groups (G_{CI}) on the time axis and two groups on the frequency axis) including b₀ to b₇, and the eight bits correspond to b₀ to b₇, respectively, and may indicate whether to cancel uplink signal/channel transmission. When the bit value of the bitmap is “0”, the bit value may not indicate cancellation of uplink signal/channel transmission, and when the bit value is “1”, the bit value may indicate cancellation of uplink signal/channel transmission. The legacy UE may receive DCI format 2_4 including the UL CI from the base station and cancel the uplink signal/channel transmission. DCI format 2_4 including the UL CI may be transmitted through a group common (GC)-PDCCH scrambled with CI-RNTI configured by a higher layer. Accordingly, when multiple legacy UEs in a cell receive the UL CI through detection of the GC-PDCCH scrambled with the CI-RNTI configured with the same value, the multiple legacy UEs may be indicated to cancel uplink signal/channel transmission in the same time-frequency resource.

A UE supporting an SBFD operation (an SBFD-ware UE) may determine, as a reference resource region (T_{CI} symbols) on the time axis, 14 symbols including a cell-specific downlink symbol. When the bitmap size (N_{CI}) of the UL CI is configured as 8 bits, the bitmap for 14 symbols may be divided into eight groups (four groups (G_{CI}) on the time axis and two groups on the frequency axis) including b₀ to b₇, and the eight bits correspond to b₀ to b₇, respectively, and may indicate whether to cancel uplink signal/channel transmission. When the bit value of the bitmap is “0”, the bit value may not indicate cancellation of uplink signal/channel transmission, and when the bit value is “1”, the bit value may indicate cancellation of uplink signal/channel transmission. The UE supporting an SBFD operation may receive DCI format 2_X including the UL CI from the base station and cancel the uplink signal/channel transmission. DCI format 2_X including the UL CI may be transmitted through a group common (GC)-PDCCH scrambled with new CI-RNTI configured by a higher layer. Accordingly, when multiple UEs supporting an SBFD operation in a cell receive the UL CI through detection of the GC-PDCCH scrambled with the new CI-RNTI configured with the same value, the multiple UEs supporting an SBFD operation may be indicated to cancel uplink signal/channel transmission in the same time-frequency resource.

### (Second Method)

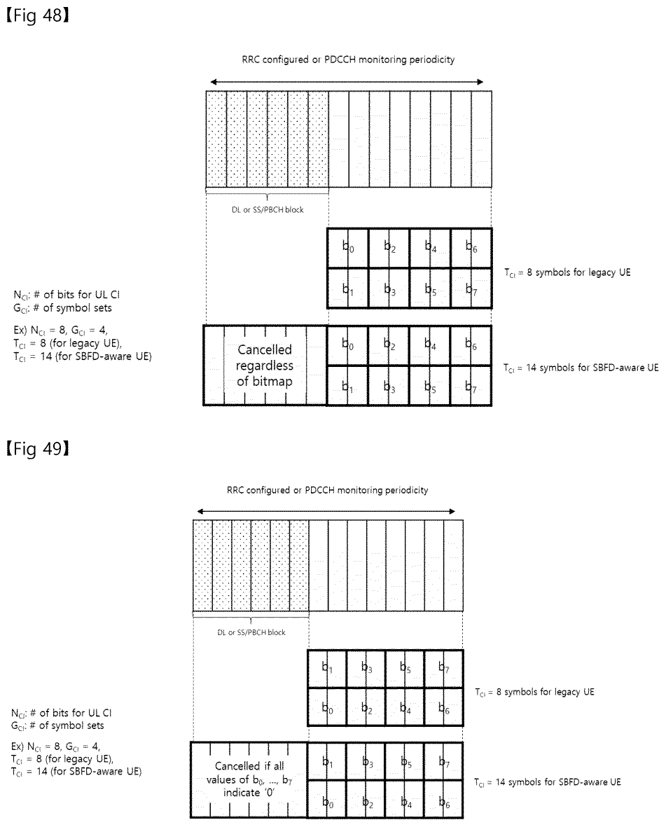

Referring to FIG. 48, a legacy UE may determine, as a reference resource region (T_{CI} symbols) on the time axis, eight symbols remaining after excluding a cell-specific downlink symbol or a symbol in which SS/PBCH block reception is configured. When the bitmap size (N_{CI}) of the UL CI is configured as 8 bits, the bitmap for eight symbols may be divided into eight groups (four groups (G_{CI}) on the time axis and two groups on the frequency axis) including b₀ to b₇, and the eight bits correspond to b₀ to b₇, respectively, and may indicate whether to cancel uplink signal/channel transmission. When the bit value of the bitmap is “0”, the bit value may not indicate cancellation of uplink signal/channel transmission, and when the bit value is “1”, the bit value may indicate cancellation of uplink signal/channel transmission. The legacy UE may receive DCI format 2_4 including the UL CI from the base station and cancel the uplink signal/channel transmission. DCI format 2_4 including the UL CI may be transmitted through a group common (GC)-PDCCH scrambled with CI-RNTI configured by a higher layer. Accordingly, when multiple UEs in a cell receive the UL CI through detection of the GC-PDCCH scrambled with the CI-RNTI configured with the same value, the multiple UEs may be indicated to cancel uplink signal/channel transmission in the same time-frequency resource.

A UE supporting an SBFD operation (an SBFD-ware UE) may determine, as a reference resource region (T_{CI} symbols) on the time axis, 14 symbols including a cell-specific downlink symbol. When the bitmap size (N_{CI}) of the UL CI is configured as 8 bits, the bitmap for eight symbols remaining after excluding a cell-specific downlink symbol or a flexible symbol in which the SS/PBCH block reception is configured may be divided into eight groups (four groups (G_{CI}) on the time axis and two groups on the frequency axis) including b₀ to b₇, and the eight bits correspond to b₀ to b₇, respectively, and may indicate whether to cancel uplink signal/channel transmission. When the bit value of the bitmap is “0”, the bit value may not indicate cancellation of uplink signal/channel transmission, and when the bit value is “1”, the bit value may indicate cancellation of uplink signal/channel transmission. In this case, for the time-frequency resource not indicated by the bitmap in the reference resource region, uplink signal/channel transmission can be always cancelled without the indication through the bitmap. The UE supporting an SBFD operation may receive DCI format 2_4 including the UL CI from the base station and cancel the uplink signal/channel transmission. DCI format 2_4 including the UL CI may be transmitted through a group common (GC)-PDCCH scrambled with CI-RNTI configured by a higher layer. Accordingly, when multiple UEs in a cell receive the UL CI through detection of the GC-PDCCH scrambled with the CI-RNTI configured with the same value, the multiple UEs may be indicated to cancel uplink signal/channel transmission in the same time-frequency resource. Compared to the first method, the second method is a method enabling indication via one common signaling without a separate signaling for the UL CI of the legacy UE and the UE operating an SBFD operation.

### (Third Method)

Referring to FIG. 49, a legacy UE may determine, as a reference resource region (T_{CI} symbols) on the time axis, eight symbols remaining after excluding a cell-specific downlink symbol or a symbol in which SS/PBCH block reception is configured. When the bitmap size (N_{CI}) of the UL CI is configured as 8 bits, the bitmap for eight symbols may be divided into eight groups (four groups (G_{CI}) on the time axis and two groups on the frequency axis) including b₀ to b₇. The eight bits correspond to b₀ to b₇, respectively, and may indicate whether to cancel uplink signal/channel transmission. When the bit value of the bitmap is “0”, the bit value may not indicate cancellation of uplink signal/channel transmission, and when the bit value is “1”, the bit value may indicate cancellation of uplink signal/channel transmission. The legacy UE may receive DCI format 2_4 including the UL CI from the base station and cancel the uplink signal/channel transmission. DCI format 2_4 including the UL CI may be transmitted through a group common (GC)-PDCCH scrambled with CI-RNTI configured by a higher layer. Accordingly, when multiple UEs in a cell receive the UL CI through detection of the GC-PDCCH scrambled with the CI-RNTI configured with the same value, the multiple UEs may be indicated to cancel uplink signal/channel transmission in the same time-frequency resource.

A UE supporting an SBFD operation (an SBFD-ware UE) may determine, as a reference resource region (T_{CI} symbols) on the time axis, 14 symbols including a cell-specific downlink symbol and a flexible symbol in which SS/PBCH block reception is configured. When the bitmap size (N_{CI}) of the UL CI is configured as 8 bits, the bitmap for eight symbols remaining after excluding a cell-specific downlink symbol or a flexible symbol in which the SS/PBCH block reception is configured may be divided into eight groups (four groups (G_{CI}) on the time axis and two groups on the frequency axis) including b₀ to b₇. The eight bits correspond to b₀ to b₇, respectively, and may indicate whether to cancel uplink signal/channel transmission in the corresponding time-frequency resource. When the bit value of the bitmap is “0”, the bit value may not indicate cancellation of uplink signal/channel transmission, and when the bit value is “1”, the bit value may indicate cancellation of uplink signal/channel transmission. When all bit values of the bitmap for the time-frequency resource (seven symbols including the cell-specific downlink symbol or the flexible symbol in which SS/PBCH block reception is configured and a PRB) not included in the bitmap (b₀ to b₇) in the reference resource region are indicated as “0” (e.g., 00000000), the UE may determine that indication of cancellation of the uplink signal/channel transmission in the time-frequency resource not included in the bitmap is received. When all bit values of the bitmap are indicated as “0”, it does not indicate cancellation of uplink signal/channel transmission in the reference resource region, and thus there is no need to perform signaling of the UL CI to the UE, and accordingly, the base station may not transmit the PDCCH including the UL CI to the UE. Nevertheless, according to the third method, transmitting the PDCCH including the UL CI to the UE and indicating all bit values of the bitmap of the UL CI as “0” may indicate cancellation of the uplink signal/channel transmission of the UE for the time-frequency resource (seven symbols including the cell-specific downlink symbol or the flexible symbol in which SS/PBCH block reception is configured and a PRB) not included in the bitmap in the reference resource region. When at least one of the bit values of the bitmap is indicated as “1” (e.g., 10000000), the UE may determine that indication of cancellation of the uplink signal/channel transmission in the time-frequency resource included in the bitmap is received. In other words, when at least one of the bit values of the bitmap is indicated as “1”, the UE may not be indicated through the UL CI to cancel the transmission of the uplink signal/channel transmission in the time-frequency resource not included in the bitmap. The UE supporting an SBFD operation may receive DCI format 2_4 including the UL CI from the base station and cancel the uplink signal/channel transmission. DCI format 2_4 including the UL CI may be transmitted through a group common (GC)-PDCCH scrambled with CI-RNTI configured by a higher layer. Accordingly, when multiple UEs in a cell receive the UL CI through detection of the GC-PDCCH scrambled with the CI-RNTI configured with the same value, the multiple UEs may be indicated to cancel uplink signal/channel transmission in the same time-frequency resource.

Hereinafter, a method in which a UE supporting an SBFD operation includes or does not include a flexible symbol in which reception of an SS/PBCH block is configured in a reference resource region according to the type of the SS/PBCH block is proposed. Methods described below can be combined with the above-described methods and applied.

Cell-specific SS/PBCH block having serving cell physical cell ID (PCI)

A UE supporting an SBFD operation may not determine, as a reference resource region (T_{CI} symbols) for a UL CI, a symbol in which reception of a cell-specific SS/PBCH block having a serving cell PCI is configured. The cell-specific SS/PBCH block having the serving cell PCI may be configured for the UE as information of ssb-PositionsInBurst. The cell-specific SS/PBCH block having the serving cell PCI is a symbol configured to be prioritized to be received by UEs in a cell for initial cell access, system information acquisition, etc., and uplink signal/channel transmission may not be scheduled. Accordingly, the UE supporting an SBFD operation may determine to exclude the corresponding symbol from the reference resource region (T_{CI} symbols) for the UL CI.

UE-specific SS/PBCH block for SSB-based measurement timing configuration (SMTC)

A UE supporting an SBFD operation may determine, as a reference resource region (T_{CI} symbols) for a UL CI, a symbol in which reception of a UE-specific SS/PBCH block within an SMTC window to measure the state of a downlink channel received from a serving cell and/or neighboring cells is configured. The UE-specific SS/PBCH block configured to be received within the SMTC window may be configured for the UE as information of ssb-To-Measure. When the UE supporting an SBFD operation receives scheduling of an uplink signal/channel from the base station in the symbol in which reception of the UE-specific SS/PBCH block in the SMTC window is configured, the UE may prioritize transmission of the corresponding uplink signal/channel. Accordingly, the UE supporting the SBFD operation may determine to include, in the reference resource region (T_{CI} symbols) for the UL CI, the symbol in which reception of the UE-specific SS/PBCH block in the SMTC window is configured.

UE-specific SS/PBCH block having activated additional PCI

A UE supporting an SBFD operation may not determine, as a reference resource region (T_{CI} symbols) for a UL CI, a symbol in which reception of a UE-specific SS/PBCH block having an additional PCI associated with an activated TCI state among SS/PBCH blocks received from multiple TRPs is configured. Here, the additional PCI may include a PCI other than the serving cell PCI. The UE-specific SS/PBCH block having the additional PCI associated with the activated TCI state may be configured for the UE as information of ssb-PositionsInBurst. The UE supporting an SBFD operation may prioritize the reception of the SS/PBCH block having the PCI associated with the TCI state activated for the UE among the SS/PBCH blocks configured for reception o PDCCHs or PDSCHs transmitted from multiple TRPs of neighboring cells, and may not receive scheduling of the transmission of the uplink signal/channel in the corresponding symbol. Accordingly, the UE supporting an SBFD operation may determine to exclude the corresponding symbol from the reference resource region (T_{CI} symbols) for the UL CI.

UE-specific SS/PBCH block having non-activated additional PCI

A UE supporting an SBFD operation may determine, as a reference resource region (T_{CI} symbols) for a UL CI, a symbol in which reception of a UE-specific SS/PBCH block having an additional PCI associated with a non-activated TCI state among SS/PBCH blocks received from multiple TRPs. Here, the additional PCI may include a PCI other than the serving cell PCI. The UE-specific SS/PBCH block having the additional PCI associated with the non-activated TCI state may be configured for the UE as information of ssb-PositionsInBurst. When the UE supporting an SBFD operation receives scheduling of an uplink signal/channel from the base station in the symbol in which the SS/PBCH block having the additional PCI other than the PCI associated with the TCI state activated for the UE among the SS/PBCH blocks configured for reception of PDCCHs or PDSCHs transmitted from multiple TRPs of neighboring cells is configured, the UE may prioritize transmission of the uplink signal/channel. Accordingly, the UE supporting an SBFD operation may determine to include the corresponding symbol in the reference resource region (T_{CI} symbols) for the UL CI.

UE-specific SS/PBCH block for L1 beam measurement/reporting

A UE supporting an SBFD operation may not determine, as a reference resource region (T_{CI} symbols) for a UL CI, a symbol in which reception of a UE-specific SS/PBCH block is configured to measure L1-reference signal received power (RSRP) or L1-signal-to-noise and interference ratio (SINR) and report the same to the base station for link recovery, beam management, etc. The UE-specific SS/PBCH block configured to measure the L1-RSRP or L1-SINR and report the same to the base station may be configured for the UE as information of ssb-PositionsInBurst. The UE supporting an SBFD operation may prioritize the SS/PBCH block reception configured to measure L1-RSRP or L1-SINR and report the same to the base station for link recovery and beam management, and may not receive scheduling of the uplink signal/channel transmission in the corresponding symbol. Accordingly, the UE supporting an SBFD operation may determine to exclude the corresponding symbol from the reference resource region (T_{CI} symbols) for the UL CI.

### Timing Alignment in SBFD Operation

In an NR system, in order to perform transmission and reception in consideration of a propagation delay between a UE and a base station, or secure a UL-to-DL switching gap, the UE may need to adjust an uplink transmission timing, and to this end, the UE may receive configuration of a timing advance offset value from the base station.

The UE may determine a value of N_{TA,offset} to secure the UL-to-DL switching gap. The UE may receive n-TimingAdvanceOffset corresponding to information from a higher layer (e.g., RRC configuration information) and receive configuration of the value of N_{TA,offset} from the base station. Here, n-TimingAdvanceOffset may indicate a value included in SIB1 and commonly configured for the UEs in the cell. When n-TimingAdvanceOfset is not configured for the UE, the UE may determine the value of N_{TA,offset} through Table 10 below.

TABLE 10

| Frequency range and band of cell | N_{TA offset} |
|---|---|
| used for uplink transmission | (Unit: Tc) |
| FR1 FDD or TDD band with neither | 25600 (Note 1) |
| E-UTRA-NR nor NB-IoT-NR | |
| coexistence case | |
| FR1 FDD band with E-UTRA-NR | 0 (Note 1) |
| and/or NB-IoT-NR coexistence case | |
| FR1 TDD band with E-UTRA-NR | 39936 (Note 1) |
| and/or NB-IoT-NR coexistence case | |
| FR2 | 13792 |

Note 1:
The UE identifies N_{TA offset} based on the information n-TimingAdvanceOffset as specified in TS 38.331 [2]. If UE is not provided with the information n-TimingAdvanceOffset, the default value of N_{TA offset} is set as 25600 for FR1 band. In case of multiple UL carriers in the same TAG, UE expects that the same value of n-TimingAdvanceOffset is provided for all the UL carriers according to clause 4.2 in TS 38.213 [3] and the value 39936 of N_{TA offset} can also be provided for a FDD serving cell.
Note 2:
Void

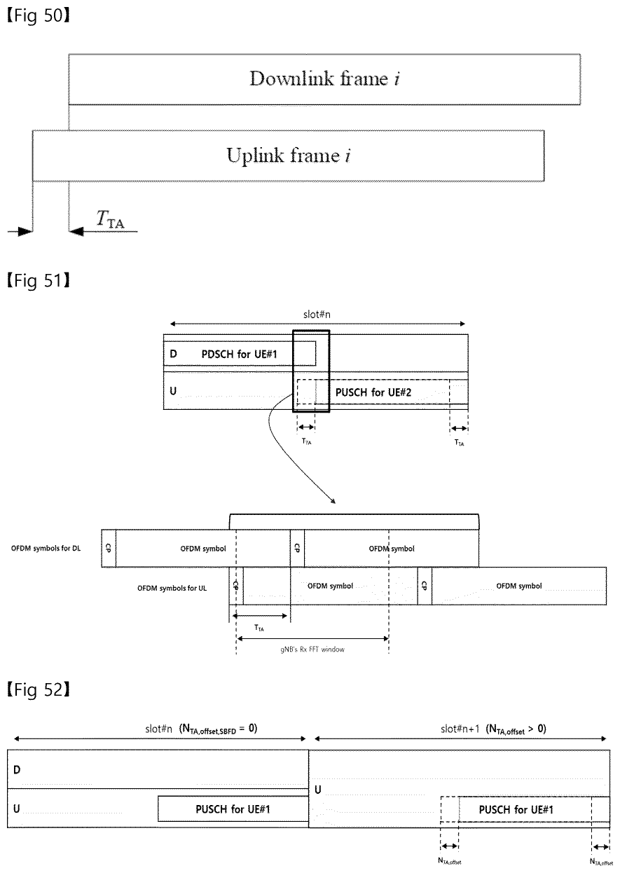

FIGS. 50 to 55 illustrate timing adjustment according to an embodiment of the present disclosure.

A UE may determine a value of N_{TA} to perform transmission and reception in consideration of a propagation delay between the UE and a base station. The UE may receive a random access response message or a medium access control (MAC) control element (CE) from the base station to determine the value of N_{TA}, and may determine the value of N_{TA}, based on information included in the random access response message or MAC CE. Here, the MAC CE may be UE-specifically included in a PDSCH and received by the UE.

The UE may determine, based on the determined values of N_{TA,offset} and N_{TA}, an uplink transmission timing as a value of T_{TA}=(N_{TA,offset}+N_{TA})T_{c}. Here, T_{c} is a sampling time of the UE in the NR system and may be T_{c}=1/(Δfₘₐₓ*N_{f}). Here, Δfₘₐₓ=480*103 Hz, and N_{f}=4096. Referring to FIG. 50, the UE may perform uplink transmission in uplink frame i in a resource preceding downlink frame i by a T_{TA} in the time domain.

The present disclosure describes a method in which a UE supporting an SBFD operation adjusts an uplink timing.

Referring to FIG. 51, UE #1 supporting an SBFD operation may be configured or indicated from the base station to receive a PDSCH in a downlink subband in slot #n. UE #2 supporting an SBFD operation may be configured or indicated from the base station to transmit a PUSCH in an uplink subband in slot #n. UE #2 may adjust an uplink timing and transmit the PUSCH in a resource preceding by a T_{TA} in the time domain. In this case, PDSCH transmission and PUSCH reception in the base station partially overlap each other in the time domain, a cyclic prefix (CP) of a downlink symbol and a CP of an uplink symbol are not aligned in a period in which a downlink symbol boundary and an uplink symbol boundary are not aligned in a reception fast Fourier transform (FFT) window of the base station, and thus it is difficult to maintain orthogonality. It may be difficult to cancel or mitigate base station self-interference occurring when the base station simultaneously perform the downlink transmission and the uplink reception in the overlapping period. Among N_{TA,offset} and N_{TA} determined for uplink timing adjustment by the UE, N_{TA} may be a value determined to align transmission and reception timings in consideration of the propagation delay between the UE and the base station. Accordingly, while the downlink symbol boundary and the uplink symbol boundary are aligned at a reception time point of the base station, N_{TA,offset} is a value commonly configured for UEs in the cell or determined without configuration, and there is a problem that the downlink symbol boundary and the uplink symbol boundary are not aligned at the reception time point of the base station.

According to an embodiment of the present invention for solving this problem, a UE supporting an SBFD operation may determine a separate offset value N_{TA,offset,SBFD} for a slot or symbol operating as an SBFD. The separate offset value N_{TA,offset,SBFD} may be a value determined by receiving n-TimingAdvanceOffset-r18 corresponding to information from a higher layer (e.g., RRC configuration information) by the UE. Here, n-TimingAdvanceOffset-r18 may be a value included in SIB1 and commonly configured for UEs supporting the SBFD operation in the cell. In other words, the UE may receiving configuration of the offset value N_{TA,offset,SBFD} for the slot or symbol operating as an SBFD. The UE may receive configuration of N_{TA,offset,SBFD} always as 0 from the base station. The UE may determine a separate offset value N_{TA,offset} for a slot or symbol not operating as an SBFD. N_{TA,offset} may be a value determined by receiving information (n-TimingAdvanceOffset) transmitted from a higher layer (e.g., RRC configuration information) by the UE. Here, n-TimingAdvanceOfset may be a value included in SIB1 and commonly configured for UEs in the cell. In other words, the UE may receive configuration of offset value N_{TA,offset} for the slot or symbol not operating as an SBFD from the base station. N_{TA,offset} may be a value among 0, 25600, and 39936. When the UE does not receive configuration of N_{TA,offset} from the base station, the UE may determine N_{TA,offset} for the slot or symbol not operating as an SBFD according to Table 15 above. Referring to FIG. 52, UE #1 supporting an SBFD operation may be configured or indicated from the base station to transmit a PUSCH in slot #n to slot #n+1. UE #1 may receive configuration of offset value N_{TA,offset,SBFD} as 0 from the base station, and may determine N_{TA,offset,SBFD} as 0 in slot #n operating as an SBFD. UE #1 may receive configuration of offset value N_{TA,offset} as a value greater than 0 from the base station, and may determine N_{TA,offset} as a value greater than 0 in slot #n+1 not operating as an SBFD. Alternatively, when UE #1 does not receive configuration of offset value N_{TA,offset} from the base station, UE #1 may determine offset value N_{TA,offset} as a value greater than 0 in slot #n+1 not operating as an SBFD according to Table 10. The above-described problem is a problem caused when the base station simultaneously perform downlink transmission and uplink reception in the slot or symbol operating as an SBFD and N_{TA,offset} is greater than 0, and thus the sperate offset N_{TA,offset,SBFD} configured from the base station may be configured always as 0 in the symbol or symbol operating as an SBFD, base station self-interference may be cancelled or mitigated, and N_{TA,offset} may be determined in the existing method in the slot or symbol not operating as an SBFD, whereby the UL-to-DL switching gap of the UE can be secured.

According to another embodiment, a UE supporting an SBFD operation may determine a separate offset value N_{TA,offset,SBFD} for a slot or symbol operating as an SBFD, and may determine the separate offset value N_{TA,offset,SBFD} as always 0 without a separate configuration from the base station. That is, the UE may always determine N_{TA,offset,SBFD}=0 for the slot or symbol operating as an SBFD. The UE may determine a separate offset value N_{TA,offset} for a slot or symbol not operating as an SBFD. The separate offset value N_{TA,offset} may be a value determined by receiving n-TimingAdvanceOfset corresponding to information from a higher layer (e.g., RRC configuration information) by the UE. Here, n-TimingAdvanceOffset may be a value included in SIB1 and commonly configured for UEs in the cell. In other words, the UE may receive configuration of offset value N_{TA,offset} for the slot or symbol not operating as an SBFD from the base station. The UE may receive configuration of N_{TA,offset} as a value among 0, 25600, and 39936 from the base station. When the UE does not receive configuration of N_{TA,offset} from the base station, the UE may determine N_{TA,offset} for the slot or symbol not operating as an SBFD according to Table 10 above. Referring to FIG. 52, UE #1 supporting an SBFD operation may be configured or indicated from the base station to transmit a PUSCH in slot #n to slot #n+1. UE #1 may not separately receive configuration of offset value N_{TA,offset,SBFD} from the base station for the slot or symbol operating as an SBFD, and may always determine N_{TA,offset,SBFD}=0. Accordingly, the UE may determine N_{TA,offset,SBFD}=0 in slot #4 operating as an SBFD. UE #1 may receive configuration of offset value N_{TA,offset}>0 from the base station, and may thus determine N_{TA,offset}>0 in slot #n+1 not operating as an SBFD. Alternatively, when UE #1 does not receive configuration of offset value N_{TA,offset} from the base station in slot #n+1 not operating as an SBFD, UE #1 may determine N_{TA,offset}>0 according to Table 10. The above-described problem is a problem caused when the base station simultaneously perform downlink transmission and uplink reception in the slot or symbol operating as an SBFD and N_{TA,offset} is greater than 0, and thus the sperate offset N_{TA,offset,SBFD} may be configured always as 0 in the symbol or symbol operating as an SBFD without separate configuration from the bae station, base station self-interference may be cancelled or mitigated, and N_{TA,offset} may be determined in the existing method in the slot or symbol not operating as an SBFD, whereby the UL-to-DL switching gap of the UE can be secured.

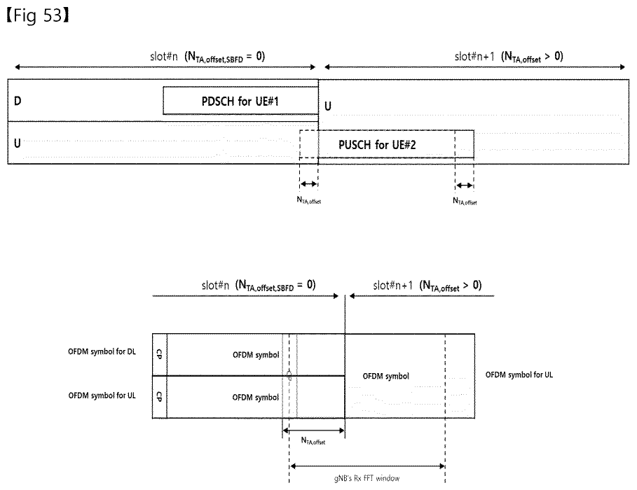

Referring to FIG. 53, there may be a case where UE #2 determines a value of N_{TA,offset} as a value greater than 0 in a first symbol in slot #n+1 not operating as an SBFD and transmits a PUSCH, and UE #1 receives a PDSCH in a last symbol in slot #n operating as an SBFD. In this case, a downlink symbol boundary and an uplink symbol boundary are not still aligned at a reception time point of the base station, and thus it may be difficult to cancel or mitigate base station self-interference. Hereinafter, a method for solving this problem is described.

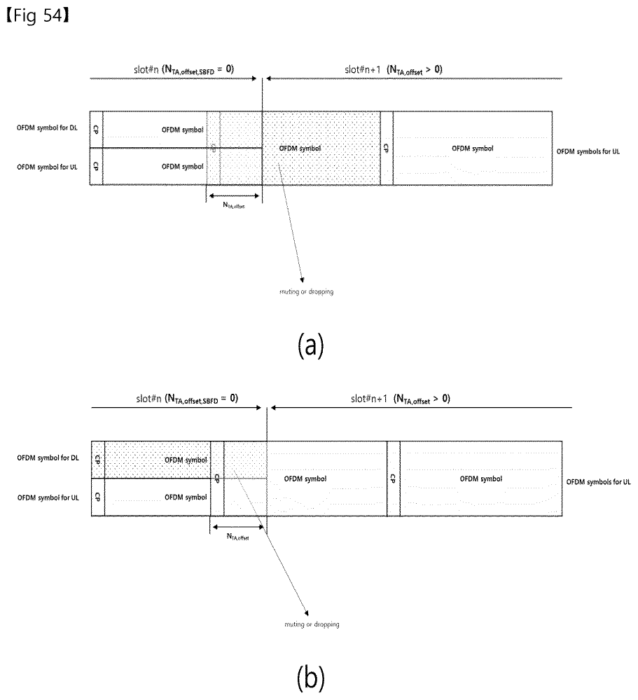

(Method i-1) Referring to FIG. 54(a), a UE may not perform uplink transmission in a first uplink symbol in slot #n+1 not operating as an SBFD (muting or dropping). The UE may not use the uplink symbol for uplink transmission in a period in which a downlink symbol boundary and an uplink symbol boundary are not aligned within a reception FFT window of the base station, and thus base station self-interference due to simultaneously performing downlink transmission and uplink reception of the base station may be cancelled or mitigated.

In a case of slot #n operating as an SBFD and slot #n+1 not operating as an SBFD, when the base station configures or schedules a PUSCH in slot #n+1, the first uplink symbol may not be configured or may not be scheduled for PUSCH transmission. The UE may cause the uplink symbol not to be configured or not to be indicated by scheduled for uplink transmission in a period in which the downlink symbol boundary and the uplink symbol boundary are not aligned within the reception FFT window of the base station. Accordingly, base station self-interference due to simultaneously performing downlink transmission and uplink reception of the base station may be cancelled or mitigated.

(Method i-2) Referring to FIG. 54(b), a UE may not perform downlink reception in a last downlink symbol in slot #n operating as an SBFD (muting or dropping). The UE may not use the downlink symbol for downlink reception in a period in which a downlink symbol boundary and an uplink symbol boundary are not aligned within a reception RRF window of the base station. Accordingly, base station self-interference due to simultaneously performing downlink transmission and uplink reception of the base station may be cancelled or mitigated.

In a case where slot #n operating as an SBFD and slot #n+1 not operating as an SBFD, when the base station configures or schedules a PDSCH for the UE in slot #n, the base station may not configure or may not schedule the last downlink symbol for the PDSCH transmission. The UE may cause the downlink symbol not to be configured or not to be indicated by scheduled for downlink transmission in a period in which the downlink symbol boundary and the uplink symbol boundary are not aligned within the reception FFT window of the base station. Accordingly, base station self-interference due to simultaneously performing downlink transmission and uplink reception of the base station may be cancelled or mitigated.

According to the above-described methods i-1 and i-2, in order to cancel or mitigate base station self-interference, at least one symbol in a slot should not be used for uplink transmission or downlink transmission. Accordingly, there may be a problem of deterioration of the uplink or downlink performance. Hereinafter, a method for solving this problem is described.

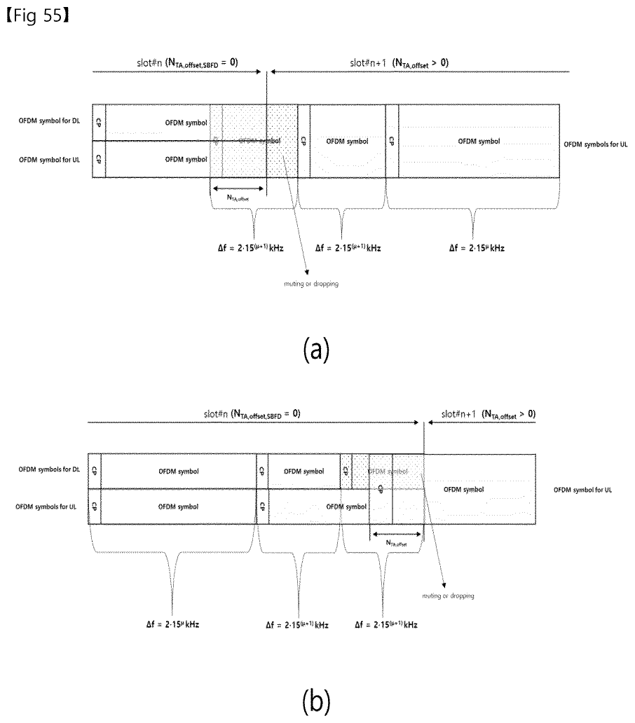

(Method ii-1) Referring to FIG. 55(a), a UE may generate two uplink symbols having a subcarrier spacing (i.e., 2·15(μ+1) kHz) twice as large as an uplink subcarrier spacing configured for the UE for a first uplink symbol in slot #n+1 not operating as an SBFD, and may not perform uplink transmission in the first uplink symbol among the two uplink symbols generated while having a subcarrier spacing (2·15(μ+1) kHz) (muting or dropping). In this case, the uplink subcarrier spacing configured for the UE may be Δf=2·15(μ+1) kHz. The UE may generate an uplink symbol having a subcarrier spacing twice as large as an uplink subcarrier spacing configured for the UE in a period in which a downlink symbol boundary and an uplink symbol boundary are not aligned within a reception FFT window of the base station, and may generate two uplink symbols compared to the uplink symbol having the subcarrier spacing (Δf=2·15(μ+1) kHz) configured for the UE. The UE may not use only one preceding uplink symbol in which the downlink symbol and the symbol boundary are not aligned among the two generated uplink symbols, and thus more time domain resources can be used for uplink transmission compared to the above-described i-1.

(Method ii-2) Referring to FIG. 55(b), the UE may generate two downlink symbols having a subcarrier spacing (i.e., 2·15(μ+1) kHz) twice as large as a downlink subcarrier spacing configured for the UE for the 14^{th} (last) downlink symbol in slot #n operating as an SBFD. In addition, the UE may not perform downlink reception in the second downlink symbol among the two generated downlink symbols having the subcarrier spacing (2·15(μ+1) kHz) (muting or dropping). Here, the downlink subcarrier spacing configured for the UE may be 2·15 μkHz. When the UE generates a downlink symbol having a subcarrier spacing twice as large as an uplink subcarrier spacing configured for the UE in a period in which the downlink symbol boundary and the uplink symbol boundary are not aligned within the reception FFT window of the base station, two downlink symbols are generated compared to the downlink symbol having the subcarrier spacing (Δf=2·15(μ+1) kHz) configured for the UE. The UE may not use only one subsequent downlink symbol in which the uplink symbol and the symbol boundary are not aligned among the two generated downlink symbols, and thus more time domain resources can be used for downlink transmission compared to the above-described ii-2.

The terms “configuration”, “setting”, and “indication in the present disclosure may be used to indicate the same meaning, That is, the terms “is configured”, “is set”, and “is indicated” may have the same meaning, and likewise, the terms “receives configuration”, “receives setting”, and “receives indication” may have the same meaning.

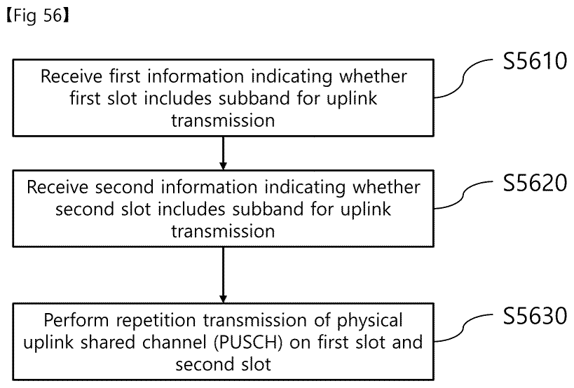

FIG. 56 is a flowchart illustrating a method of performing repetition transmission of a PUSCH according to an embodiment of the present disclosure.

Referring to FIG. 56, a UE may receive first information indicating whether a first slot includes a subband for uplink transmission (S5610).

The UE may receive second information indicating whether a second slot includes the subband for uplink transmission (S5620).

The UE may perform repetition transmission of a physical uplink shared channel (PUSCH) on the first slot and the second slot (S5630).

The first slot may include the subband for uplink transmission, and the second slot may not include the subband for uplink transmission.

When first transmission power for the repetition transmission of the PUSCH transmitted on the first slot and second transmission power for the repetition transmission of the PUSCH transmitted on the second slot are differently configured from a base station, the repetition transmission of the PUSCH transmitted on the first slot and the repetition transmission of the PUSCH transmitted on the second slot may be transmitted using common transmission power. The common transmission power may be one of the first transmission power and the second transmission power.

The first transmission power may be less than the second transmission power.

The common transmission power may be the first transmission power.

The repetition transmission of the PUSCH transmitted on the first slot may include a first demodulation reference signal (DMRS), the repetition transmission of the PUSCH transmitted on the second slot may include a second DMRS, and the first DMRS and the second DMRS may be transmitted to be bundled and decoded.

The first DMRS and the second DMRS may be transmitted while phase continuity is maintained therebetween.

The UE for performing the method described through FIG. 56 may be the UE described in FIG. 11. Specifically, the UE may be configured to include a communication module configured to transmit or receive a wireless signal, and a processor configured to control the communication module. In this case, the processor of the UE may perform the method described in the present disclosure.

The method and system of the present disclosure are described in relation to specific embodiments, but configuration elements, a part of or the entirety of operations of the present disclosure may be implemented using a computer system having a general-purpose hardware architecture.

The foregoing descriptions of the present disclosure are for illustration purposes, and those skilled in the art, to which the present disclosure belongs, will be able to understand that modification to other specific forms can be easily achieved without changing the technical spirit or essential features of the present disclosure. Therefore, it should be understood that the embodiments described above are illustrative and are not restrictive in all respects. For example, each element described as one type may be implemented in a distributed manner, and similarly, elements described as being distributed may also be implemented in a combined form.

The scope of the present disclosure is indicated by claims to be described hereinafter rather than the detailed description, and all changes or modifications derived from the meaning and scope of the claims and their equivalent concepts should be interpreted as being included in the scope of the present disclosure.

The scope of the present disclosure is indicated by claims to be described hereinafter rather than the detailed description, and all changes or modifications derived from the meaning and scope of the claims and their equivalent concepts should be interpreted as being included in the scope of the present disclosure.

1. A terminal in a wireless communication system, the terminal comprising:
a transceiver; and
a processor configured to control the transceiver,
wherein the processor is configured to:
receive first information indicating whether a first slot comprises a subband for uplink transmission;
receive second information indicating whether a second slot comprises the subband for uplink transmission; and
perform repetition transmission of a physical uplink shared channel (PUSCH) on the first slot and the second slot, and
wherein the first slot comprises the subband for uplink transmission, and the second slot does not comprise the subband for uplink transmission.

2. The terminal of claim 1, wherein, if first transmission power for the repetition transmission of the PUSCH transmitted on the first slot and second transmission power for the repetition transmission of the PUSCH transmitted on the second slot are differently configured from a base station, the repetition transmission of the PUSCH transmitted on the first slot and the repetition transmission of the PUSCH transmitted on the second slot are transmitted using common transmission power, and
wherein the common transmission power is one of the first transmission power and the second transmission power.

3. The terminal of claim 2, wherein the first transmission power is less than the second transmission power.

4. The terminal of claim 3, wherein the common transmission power is the first transmission power.

5. The terminal of claim 2, wherein the repetition transmission of the PUSCH transmitted on the first slot comprises a first demodulation reference signal (DMRS),
wherein the repetition transmission of the PUSCH transmitted on the second slot comprises a second DMRS, and
wherein the first DMRS and the second DMRS are transmitted to be bundled and decoded.

6. The terminal of claim 5, wherein the first DMRS and the second DMRS are transmitted while maintaining phase continuity therebetween.

7. A method performed by a terminal in a wireless communication system, the method comprising:
receiving first information indicating whether a first slot comprises a subband for uplink transmission;
receiving second information indicating whether a second slot comprises the subband for uplink transmission; and
performing repetition transmission of a physical uplink shared channel (PUSCH) on the first slot and the second slot,
wherein the first slot comprises the subband for uplink transmission, and the second slot does not comprise the subband for uplink transmission.

8. The method of claim 7, wherein, if first transmission power for the repetition transmission of the PUSCH transmitted on the first slot and second transmission power for the repetition transmission of the PUSCH transmitted on the second slot are differently configured from a base station, the repetition transmission of the PUSCH transmitted on the first slot and the repetition transmission of the PUSCH transmitted on the second slot are transmitted using common transmission power, and
wherein the common transmission power is one of the first transmission power and the second transmission power.

9. The method of claim 8, wherein the first transmission power is less than the second transmission power.

10. The method of claim 9, wherein the common transmission power is the first transmission power.

11. The method of claim 8, wherein the repetition transmission of the PUSCH transmitted on the first slot comprises a first demodulation reference signal (DMRS),
wherein the repetition transmission of the PUSCH transmitted on the second slot comprises a second DMRS, and
wherein the first DMRS and the second DMRS are transmitted to be bundled and decoded.

12. The method of claim 11, wherein the first DMRS and the second DMRS are transmitted while maintaining phase continuity therebetween.

13. A base station in a wireless communication system, the base station comprising:
a transceiver; and
a processor configured to control the transceiver,
wherein the processor is configured to:
transmit first information indicating whether a first slot comprises a subband for uplink transmission;
transmit second information indicating whether a second slot comprises the subband for uplink transmission; and
receive repetition transmission of a physical uplink shared channel (PUSCH) on the first slot and the second slot, and
wherein the first slot comprises the subband for uplink transmission, and the second slot does not comprise the subband for uplink transmission.

14. The base station of claim 13, wherein, if first transmission power for the repetition transmission of the PUSCH transmitted on the first slot and second transmission power for the repetition transmission of the PUSCH transmitted on the second slot are differently configured from the base station, the repetition transmission of the PUSCH transmitted on the first slot and the repetition transmission of the PUSCH transmitted on the second slot are transmitted using common transmission power, and
wherein the common transmission power is one of the first transmission power and the second transmission power.

15. The base station of claim 14, wherein the first transmission power is less than the second transmission power.

16. The base station of claim 15, wherein the common transmission power is the first transmission power.

17. The base station of claim 14, wherein the repetition transmission of the PUSCH transmitted on the first slot comprises a first demodulation reference signal (DMRS),
wherein the repetition transmission of the PUSCH transmitted on the second slot comprises a second DMRS, and
wherein the first DMRS and the second DMRS are transmitted to be bundled and decoded.

18. The base station of claim 17, wherein the first DMRS and the second DMRS are transmitted while maintaining phase continuity therebetween.

19. A method performed by a base station in a wireless communication system, the method comprising:
transmitting first information indicating whether a first slot comprises a subband for uplink transmission;
transmitting second information indicating whether a second slot comprises the subband for uplink transmission; and
receiving repetition transmission of a physical uplink shared channel (PUSCH) on the first slot and the second slot,
wherein the first slot comprises the subband for uplink transmission, and the second slot does not comprise the subband for uplink transmission.

20. The method of claim 19, wherein, if first transmission power for the repetition transmission of the PUSCH transmitted on the first slot and second transmission power for the repetition transmission of the PUSCH transmitted on the second slot are differently configured from the base station, the repetition transmission of the PUSCH transmitted on the first slot and the repetition transmission of the PUSCH transmitted on the second slot are transmitted using common transmission power, and
wherein the common transmission power is one of the first transmission power and the second transmission power.
